(19) United States
(12) Patent Application Publication
(10) Pub. No.: US 2025/0271361 A1
(43) Pub. Date: Aug. 28, 2025

(54) SUPERCONTINUUM INTRINSIC FLUORESCENCE IMAGING

(71) Applicant: The Board of Trustees of the University of Illinois, Urbana, IL (US)

(72) Inventors: Haohua Tu, Savoy, IL (US); Geng Wang, Urbana, IL (US); Janet Elise Sorrells, Urbana, IL (US); Rishyashring Raman Iyer, Urbana, IL (US); Jindou Shi, Urbana, IL (US)

(21) Appl. No.: 19/036,969

(22) Filed: Jan. 24, 2025

Related U.S. Application Data
(60) Provisional application No. 63/625,966, filed on Jan. 27, 2024.

(51) Int. Cl. G01N 21/64

(52) U.S. Cl. CPC G01N 21/6458; G01N 21/6402; G01N 21/6486; G01N 2201/08

(57) ABSTRACT

Imaging strategies remain underdeveloped to maximize information for fluorescence microscopy while minimizing the harm to fragile living systems. The systems and methods set forth herein leverage fluorescence from untreated unlabeled live samples before nonlinear photodamage onset. The imaging modalities are applicable to a wide range of microscopy implementations, and enable a facility-type microscope to freely explore vital molecular biology across life sciences.

### CROSS-REFERENCE TO RELATED APPLICATIONS

This application claims priority to and the benefit of U.S. Provisional Application No. 63/625,966, filed Jan. 27, 2024, the entire contents of which are herein incorporated by reference for all purposes.

### STATEMENT OF FEDERALLY SPONSORED RESEARCH

N/A.

### BACKGROUND

Imaging strategies to maximize information for fluorescence microscopy while minimizing the harm to fragile living systems remain underdeveloped. Example implementations of the present disclose include a “supercontinuum” fluorescence from untreated unlabeled live samples before the onset of nonlinear photodamage. Supercontinuum intrinsic fluorescence provides a wealth of molecular information from living systems to enable omics-like cell phenotyping and tissue histology.

### SUMMARY OF THE DISCLOSURE

According to an aspect of the present disclosure, a multiphoton microscopy system is provided. The system comprises a laser light source configured to generate an excitation light having a first wavelength range including an excitation wavelength of a biological sample; an optical system configured to direct the excitation light to the biological sample and configured to receive an emission light emitted by the biological sample in response to the excitation light; and a detection module configured to receive the emission light from the optical system and configured to: separate the emission light into at least a first detection light including a second wavelength range, a second detection light including a third wavelength range, a third detection light including a fourth wavelength range, a fourth detection light including a fifth wavelength range, and a fifth detection light including a sixth wavelength range, and direct the first detection light to a first detector, the second detection light to a second detector, the third detection light to a third detector, the fourth detection light to a fourth detector, and the fifth detection light to a fifth detector.

According to another aspect of the present disclosure, a detection module for a microscopy system is provided. The detection module comprises an optical input configured to receive an emission light, wherein the emission light corresponds to illumination emitted by a biological sample in response to irradiation with an excitation light; a first beam splitter configured to separate a first detection light from the emission light; a first detector configured to receive the first detection light from the first beam splitter; a second beam splitter configured to separate a second detection light from the emission light; a second detector configured to receive the second detection light from the second beam splitter; a third beam splitter configured to separate a third detection light from the emission light; a third detector configured to receive the third detection light from the third beam splitter; a fourth beam splitter configured to separate a fourth detection light from the emission light; a fourth detector configured to receive the fourth detection light from the fourth beam splitter; a fifth beam splitter configured to separate a fifth detection light from the emission light; and a fifth detector configured to receive the fifth detection light from the fifth beam splitter.

According to another aspect of the present disclosure, a multiphoton microscopy method is provided. The method comprises illuminating a biological sample with an excitation length having a first wavelength range including an excitation wavelength of the biological sample; receiving an emission light emitted by the biological sample in response to the excitation light, wherein the emission light includes a supercontinuum; separating the emission light into at least a second wavelength range, a third wavelength range, a fourth wavelength range, a fifth wavelength range, and a sixth wavelength range; and simultaneously detecting the second wavelength range of the emission light by a first detector, the third wavelength range of the emission light by a second detector, the fourth wavelength range of the emission light by a third detector, the fifth wavelength range of the emission light by a fourth detector, and the sixth wavelength range of the emission light by a fifth detector.

### BRIEF DESCRIPTION OF THE DRAWINGS

FIG. 1 shows an example schematic of an optical system according to various aspects of the present disclosure.

FIG. 2 shows a visualization of live cells and extracellular matrix according to various aspects of the present disclosure.

FIG. 3 shows an example of the observed quantitative imaging according to various aspects of the present disclosure.

FIG. 4 illustrates example applications of various aspects of the present disclosure.

FIG. 5 illustrates the label-free imaging of various plants and microbes according to various aspects of the present disclosure.

FIG. 6 illustrates general aging concepts according to various aspects of the present disclosure.

FIG. 7 illustrates an example comparison between optical imaging modalities according to various aspects of the present disclosure.

FIG. 8 illustrates example images according to various aspects of the present disclosure.

FIG. 9 illustrates example images according to various aspects of the present disclosure.

FIG. 10 illustrates example images according to various aspects of the present disclosure.

FIG. 11 illustrates intrinsic fluorophores according to various aspects of the present disclosure.

FIG. 12 illustrates example multiparametric imaging characteristics according to various aspects of the present disclosure.

FIG. 13 illustrates segmentation for profiling according to various aspects of the present disclosure.

FIG. 14 illustrates example images according to various aspects of the present disclosure.

FIG. 15 illustrates example images according to various aspects of the present disclosure.

FIG. 16 illustrates example images according to various aspects of the present disclosure.

FIG. 17 illustrates example images according to various aspects of the present disclosure.

FIG. 18 illustrates example quantitative relations according to various aspects of the present disclosure.

FIG. 19 illustrates metabolic oxidation characteristics according to various aspects of the present disclosure.

FIG. 20 illustrates example images according to various aspects of the present disclosure.

FIG. 21 illustrates example images according to various aspects of the present disclosure.

FIG. 22 illustrates example images according to various aspects of the present disclosure.

FIG. 23 illustrates a biogenetic relationship according to various aspects of the present disclosure.

FIG. 24 illustrates a biogenetic relationship according to various aspects of the present disclosure.

FIG. 25 illustrates oxidative stress characteristics according to various aspects of the present disclosure.

FIG. 26 illustrates antioxidative responses according to various aspects of the present disclosure.

FIG. 27 illustrates example images according to various aspects of the present disclosure.

FIG. 28 illustrates example images according to various aspects of the present disclosure.

FIG. 29 illustrates example photo-stress characteristics according to various aspects of the present disclosure.

FIG. 30 illustrates example images according to various aspects of the present disclosure.

FIG. 31 illustrates example imaging assays according to various aspects of the present disclosure.

FIG. 32 illustrates example images according to various aspects of the present disclosure.

FIG. 33 illustrates example video denoising model images according to various aspects of the present disclosure.

FIG. 34 illustrates example video denoising model images according to various aspects of the present disclosure.

FIG. 35 illustrates example images according to various aspects of the present disclosure.

FIG. 36 illustrates an example imaging system according to various aspects of the present disclosure.

FIG. 37 illustrates an example microscopy system according to various aspects of the present disclosure.

FIG. 38 illustrates an example microscopy method according to various aspects of the present disclosure.

### DETAILED DESCRIPTION

Described here are systems and methods for imaging that provide improved information from fluorescence microscopy with reduced phototoxicity and photodamage. The imaging modalities set forth herein may be used in a wide variety of implementations across the life sciences, including but not limited to achieving high-content cell phenotyping and tissue histology, identifying embryo polarization, quantifying aging-related stress across cell types and species, providing insights into embryogenesis before and after implantation, sensing drug cytotoxicity in real-time, scanning brain areas for targeted patching, leveraging machine learning to track small moving organisms, inducing two-photon phototropism of leaf chloroplasts under two-photon photosynthesis, and interrogating the intestinal microbiome.

The present technology will now be described more fully with reference to the accompanying drawings, in which some, but not all, embodiments are shown. Indeed, the technology may be embodied in many different forms and should not be construed as limited to the embodiments set forth herein; rather, these embodiments are provided so that this disclosure will satisfy applicable legal requirements.

Likewise, many modifications and other embodiments of the technology described herein will come to mind to one of skill in the art to which the invention pertains having the benefit of the teachings presented in the following descriptions and the associated drawings. Therefore, it is to be understood that the disclosure is not to be limited to the specific embodiments disclosed and that modifications and other embodiments are intended to be included within the scope of the disclosure. Although specific terms are employed herein, they are used in a generic and descriptive sense only and not for purposes of limitation. Unless defined otherwise, all technical and scientific terms used herein have the same meaning as commonly understood by one of skill in the art to which the technology pertains.

Throughout the specification and claims, terms may have meanings suggested or implied in context beyond an explicitly stated meaning. Likewise, the phrases “in one embodiment,” “in one example, “in one aspect,” or “in one implementation” as used herein do not necessarily refer to the same embodiment, example, aspect, or implementation; and the phrases “in another embodiment,” “in another example,” “in another aspect,” or “in another implementation” as used herein do not necessarily refer to a different embodiment, example, aspect, or implementation. It is intended, for example, that the claimed subject matter includes combinations of exemplary embodiments, examples, aspects, or implementations in whole or in part.

In general, terminology may be understood at least in part from usage in context. For example, terms such as “and,” “or,” or “and/or” as used herein may include a variety of meanings that may depend at least in part upon the context in which such terms are used. For example, the use of “or” to associate a list, such as “A, B, or C” is intended to mean “A, B, and C,” here used in the inclusive sense, as well as “A, B, or C,” here used in the exclusive sense. IN addition, the phrase “one or more” or “at least one” as used herein, depending at least in part upon context, may be used to describe any feature, structure, or characteristic in a singular sense or may be used to describe combinations of features, structures, or characteristics in a plural sense. Similarly, terms such as “a,” “an,” or “the,” again, may be understood to convey a singular usage or to convey a plural usage, depending at least in part upon context. In addition, the term “based on” or “determined by” may be understood as not necessarily intended to convey an exclusive set of factors and may, instead, allow for the existence of additional factors not necessarily expressly described, again, depending at least in part on context. Unless defined otherwise, all technical and scientific terms used herein have the same meaning as commonly understood by one of skill in the art to which the invention pertains.

Focusing picosecond-femtosecond optical pulses on a nonlinear medium can generate a supercontinuum signal highly informative of the medium itself. This raises the possibility of comprehensive (spectroscopic) optical biopsy or other applications of femtosecond biophotonics if the transparent bulk gases/solids are replaced with live biological samples as the nonlinear media. However, the generated supercontinuum signals of plasma luminescence from picosecond irradiation and white-light filamentation from loose femtosecond focusing have been accompanied by optical breakdown (photodamage), which has been used for precision surgery and micromachining via tight femtosecond focusing. A lowered irradiance on the biological samples, intended for high resolution label-free multiphoton imaging, suppresses this supercontinuum generation around the near-infrared incident band but often induces new molecules (photodamage) that emit supercontinuum-like (blue-to-red) fluorescence; that is, “white” flashes. Thus, hitherto observed biological supercontinuum signals have been associated with various photodamages detrimental to sample health and artifact-free image analysis. Living samples can generally tolerate irradiance up to one-half of water optical breakdown before nonlinear photodamage onset, if successive illumination pulses are spatially separated by ˜1 diffraction-limited resolution. By utilizing the systems and methods set forth herein, within this window of illumination, supercontinuum (340-740 nm) fluorescence can be safely generated by a 1110-nm excitation to provide rich biological information via a mechanism of simultaneous two-, three-, and four-photon absorptions of intrinsic fluorophores.

The techniques set forth herein build on simultaneous label-free autofluorescence-multiharmonic (SLAM) microscopy capable of imaging cellular flavin adenine dinucleotide (FAD) and reduced nicotinamide adenine dinucleotide (NADH) via two- and three-photon excited intrinsic fluorescence (2PIF and 3PIF), respectively, by a single-shot of filtered supercontinuum excitation. Given the same excitation band, the technique will be described herein beginning with an analysis of whether tryptophan could be simultaneously visualized via four-photon excited intrinsic fluorescence (4PIF), and whether two-photon excited long-wavelength intrinsic fluorescence (2PLIF) to the red of 2PIF could yield independent contrast from porphyrin- and/or lipofuscin-like biomolecules. The envisioned 4-color intrinsic fluorescence would thus benefit from the photon order super-multiplexed imaging and photon-order multicolor imaging, but in a label-free manner. Due to plausible weak intrinsic fluorescence in the short-wavelength end, the laser source was reengineered to balance various multiphoton processes without inducing nonlinear photodamage. The resulting “supercontinuum” intrinsic fluorescence imaging (SCIFI) naturally included fluorescence lifetime imaging microscopy (FLIM) and two additional colors of epi-detected second- and third-harmonic generation microscopy (SHG and THG) as “free” capabilities to yield a 6-color simultaneously acquired (co-registered) signal.

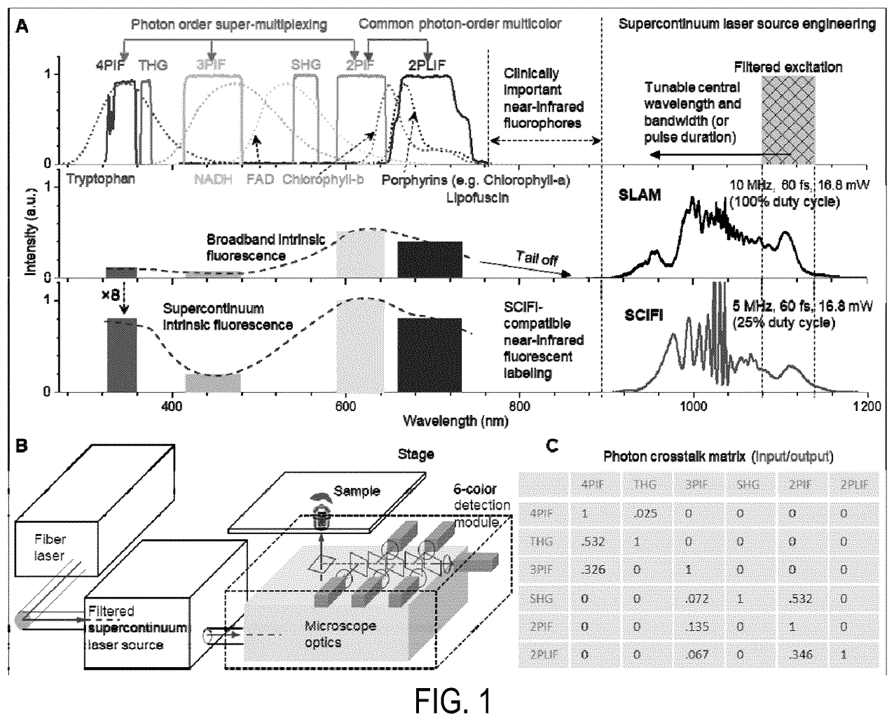

FIG. 1 illustrates the SCIFI modality conceptually and schematically. Graph (A) of FIG. 1 illustrates that reported excitation in SLAM microscopy generates broadband intrinsic fluorescence from bandpass filter-separated cellular fluorophores (colored curves) that are weak at the short-wavelength end, whereas excitation in SCIFI with a reengineered supercontinuum source generates supercontinuum intrinsic fluorescence that is strong at the short-wavelength end, with 4× (or 2×) increase 4PIF/tryptophan (or 3PIF/NADH) relative to 2PIF/FAD due to 2× lower pulse repetition rate. In some implementations, near-infrared fluorescence labeling extends the signal at the long wavelength end. Schematic (B) of FIG. 1 is a schematic of an inverted laser-scanning microscope with an automated stage and 6-color detection module. Table (C) of FIG. 1 is a photon crosstalk matrix of 6 detection colors from fluorophore solution-based calibration.

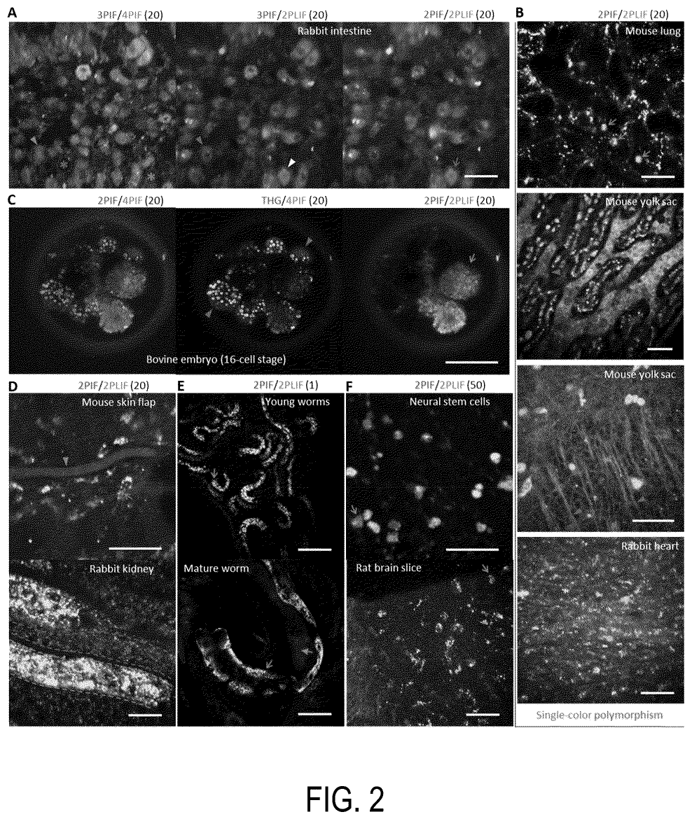

To qualitatively investigate SCIFI, 4 stromal cell phenotypes in a niche of rabbit intestinal mucus were distinguished using 4PIF, 3PIF, and 2PLIF. FIG. 2 presents a visualization of live cells and extracellular matrix. The upper right corner of each image indicates detection color(s) and number of frame averaging. The scale bar represents 50 μm. Image set (A) shows diverse stromal cells in a niche of rabbit small intestine with distinct color profiles including 4PIF and 2PLIF (stars, arrowheads, arrow). Image set (B) shows the capability of 2PLIF to reveal stromal cells in mouse lung, emergent endothelial layer in yolk sac of one E11 mouse embryo, fiber-like structures in a vasculogenic field of E11 mouse embryo surface, and plausible atherosclerotic plaque in rabbit heart. Image set (C) shows the capability of 4PIF to reveal two distinct cell/blastomere phenotypes (stars), two blastomeres with apical polarity cap and the trophectoderm fate (arrowheads) in contrast to another blastomere with the inner cell mass fate (arrow) in a 16-cell-stage bovine embryo. Image set (D) shows blood (arrowhead) versus stromal cells (arrow) in mouse skin flap and epithelial cells in rabbit kidney with two metabolic states (stars). Image set (E) shows cells in the soma (arrows) or germline part (star) of young/mature C. elegans. Image set (F) shows cultured neural stem cells versus neurons in an area of rat brain slice near suprachiasmatic nucleus (arrows).

The 2PLIF contrast across nucleus and cytoplasm, rather than 2PIF, allowed clear separation of two closely related cell phenotypes (FIG. 2, image set (A), middle). Similarly, independent 2PLIF contrasts were obtained in other samples to highlight specific cells (FIG. 2, image set (B), arrow) and extracellular components (arrowheads). In view of this, investigations were performed to determine whether these 2PLIF contrasts can be attributed to porphyrin(s) or other intrinsic fluorophores suggestive of the embryogenesis-mimicking tumorigenesis and high-risk heart attack. A pre-implantation in vitro fertilized bovine embryo near the 16-cell stage was also investigated, coincident with the first lineage segregation into either the trophectoderm toward extraembryonic tissue or the inner cell mass toward the embryo proper. The observed 13 blastomeres were cleanly divided into 3 2PIF-visible versus 9 4PIF-visible blastomeres (FIG. 2, image set (C), left). As opposed to the largely even cytoplasmic distribution of differential 4PIF contrast over THG in the 4PIF-visible blastomeres near the 2-cell stage, the corresponding uneven distribution near the 16-cell stage echoed the emergence of symmetry-breaking apical polarity cap at the 8-cell stage (FIG. 2, image set (C), middle). These observations indicate the trophectoderm fate/lineage (4PIF-visible) and the inner cell mass fate/lineage (2PIF-visible) blastomeres near the 16-cell stage and the potential for clinically permissible label-free detection of embryo polarization without deep learning. It should be noted that the apical polarity cap is only detectable by 4PIF (or tryptophan).

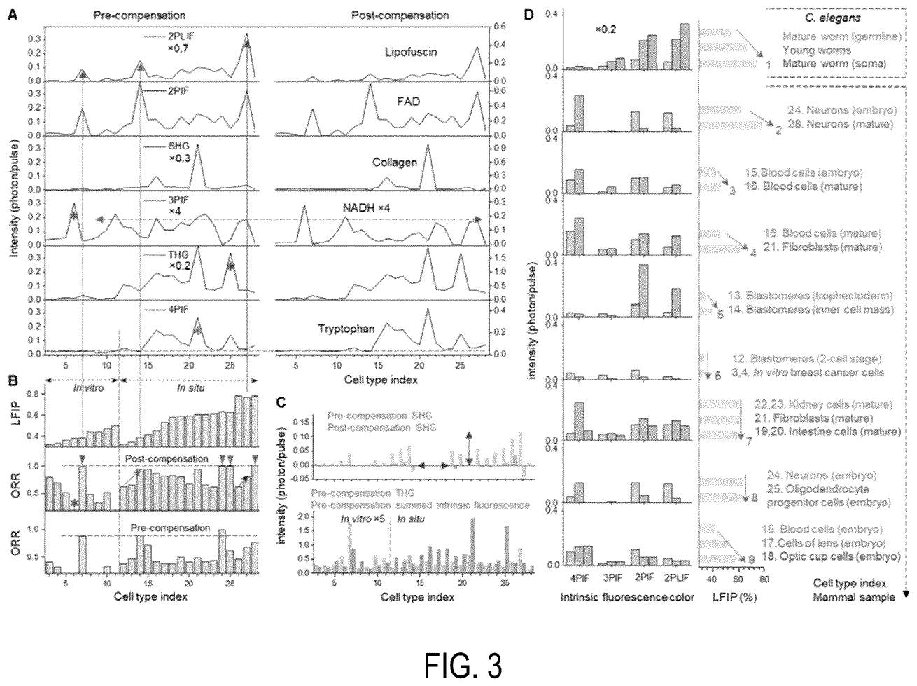

To demonstrate quantitative imaging, diverse samples with segmented cells either in vitro or in situ (ex vivo or in vivo) were scanned at a similar depth of 10-20 μm. In contrast to the intestinal cells and other rare cells with distinct whole-cell 2PLIF (green contrast from porphyrin-like biomolecules) against 2PIF, most observable cell types have overlapping 2PIF and 2PLIF contrasts from orangish to greenish yellow in the form of punctuated intracellular granules and correlated 2PIF-2PLIF signal strengths across samples, consistent with localized FAD and lipofuscin respectively in mitochondria and lysosomes according to their emission spectra. FIG. 3 illustrates the observed quantitative imaging across cell types and samples. In FIG. 3, graph set (A) shows observed SCIFI 6-color profiles for 28 cell types from segmented individual cells in different fields-of-view of different samples. The signals may be scaled for clarity before (left) and after crosstalk compensation (right). Graph set (B) of FIG. 3 shows quantified dimensionless LFI (top) and ORR before (middle) and after the crosstalk compensation (bottom) for the 28 cell types. FIG. 3, graph set (C) shows SHG clearance before and after the crosstalk compensation for most of the 28 cell types free of interference from collagen (top), and comparison of THG and summed intrinsic fluorescence intensities for in vitro versus in situ cell types before the compensation (bottom). FIG. 3, graph set (D) shows the correlation of observed LFI with cell aging or proliferation in diverse cell types (right) despite their highly irregular profiles of 4-color intrinsic fluorescence (left).

Assuming a tryptophan-NADH-FAD-lipofuscin model of animal cells with solution-based calibration by a photon crosstalk matrix, the dimensionless extent of cellular lipofuscin was quantified by the ratio of crosstalk-compensated 2PLIF over pre-compensated 2PLIF; that is, lipofuscin fluorescence independence extent (LFI). This tetra-fluorophore cell model and related compensation was validated by the selective clearance of SHG signal in cells free of extracellular collagen but not in those known to mingle with the collagen.

Taking this interference into account, the fibroblasts cells in a collagen-rich microenvironment of mouse skin flap were uniquely identified by their peaked 4PIF across all observed cell types. Similarly, the oligodendrocyte progenitor cells in a developing mouse brain (as discussed in more detail below below) and in vitro hamster kidney cells treated with staurosporine (STS) were uniquely identified by their peaked THG and 3PIF (NADH), respectively. The latter is a label-free biomarker of apoptosis that may be extended to in situ situations. Among the three cell types with peaked 2PIF/2PLIF, the high LFI uniquely identified the epithelial cells in rabbit kidney.

High 4PIF intensities comparable to those of 2PIF/2PLIF were obtained across representative mammal cells, justifying the term of “supercontinuum intrinsic fluorescence” despite ˜4-time weaker 3PIF in between. The dynamic range of all colors were high (5×10⁻⁴ to 2 photons/pulse) so that specially calibrated analog photodetection was developed to attain a photon-resolved quantification beyond photon-counting, which is typically limited to a low throughput of <0.1 photon/pulse.

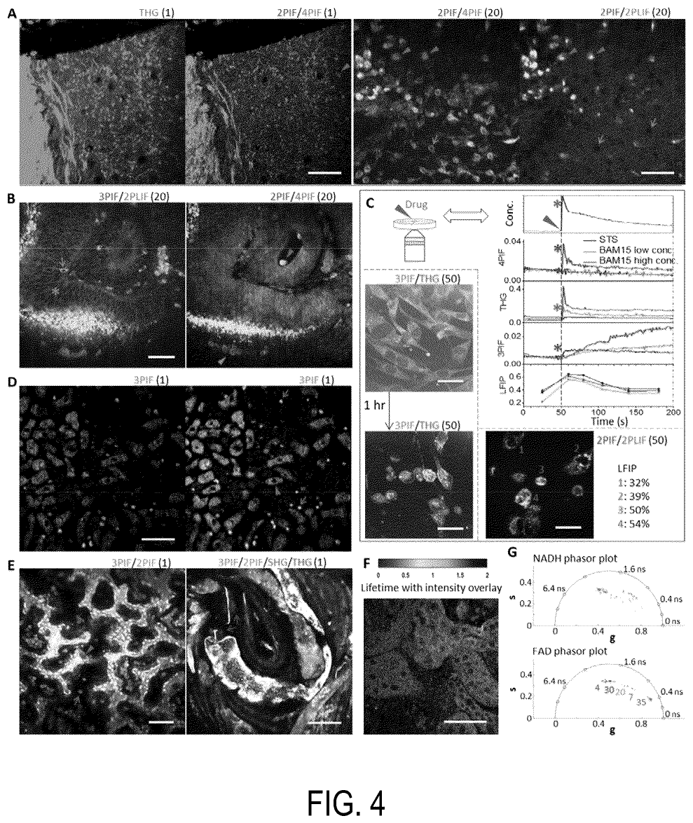

To illustrate LFI from the perspective of aging, young and mature worms of C. elegans were compared, and it was observed that the LFI of the former lies between that of the soma and germline part of the latter. Additionally, the mature brain of a rat and the developing brain of a mouse embryo were compared. FIG. 4 illustrates the results of the comparison and other applications of the present disclosure in biology and medicine. In FIG. 4, the scale bar represents 50 μm. Image set (A) of FIG. 4 shows real-time (0.33 s per frame) 2PIF/4PIF imaging of brain slice (suprachiasmatic nucleus) of a 4-week-old rat. This image set reveals 2PIF-visible neurons (arrows) not obvious in THG imaging where the somata appear as dark shadows (arrowheads) in a continuous phase of myelin, and would thus enable more versatile targeted patching (left), while the related intrinsic fluorescence imaging of the ex vivo brain of an E15 mouse embryo reveals neurons (arrowheads) and oligodendrocyte progenitor cells (arrows) in a different state of continuous versus dispersive phases (right). Image set (B) shows the developing ocular lens of an E11 mouse embryo and hosting optic-cup lined with similar fiber-like cells (stars) that contain rare cells (arrows and arrowheads).

FIG. 4, image set (C) presents single-cell pharmacological imaging of cultured hamster kidney cells, and reveals temporal responses to externally introduced AP3, BAM15, and STS (colored curves) with in situ monitored concentration (magenta star) detectable by AP3 fluorescence (top), endpoint imaging of the cells before and after adding STS in different fields of view shows apoptosis-induced morphological change (bottom left) absent from AP3 exposure, and single-cell LFI analysis that differentiates low-stress amoeba-shaped adipose-derived stem cells (1 and 2) from high-stress spherically shaped counterparts (3 and 4) (bottom right). Image set (D) of FIG. 4 shows a time-lapse increase of 3PIF in rabbit intestinal cells (arrowheads) and microbes (arrows) as indicator for photodamage. Image set (E) shows that UDVD denoising of real-time low-signal-to-noise raw video reveals 3PIF-visible cells of plausible endothelial origin (arrowhead) and a flowing blood cell (magenta arrow) in yolk sac from an E11 mouse embryo (left), and SHG-visible pharynx bulbs (red arrows) of a freely moving C. elegans (right). FIG. 4, image (F) presents a FLIM analysis of epithelial cells in mouse kidney and reveals an unusual lobe (arrow) with long 4PIF lifetime. Graphs (G) are FLIM phasor plots of 3PIF/NADH (top and 2PIF/FAD (bottom) that show the better performance of the latter to discriminate numerous individual cells with related cell type indices.

In a myelination-induced “phase change” during brain development detectable by SCIFI (FIG. 4, image set (A), 2PIF/4PIF images), migratory oligodendrocyte progenitor cells were easily discriminated against neurons (right). Observed LFI of the neurons in the mature brain was higher than that in the developing brain (FIG. 3, image set (D), Arrow 2). Moreover, the observed LFI of the red blood cells in skin flap of a mature (8-week-old) mouse (FIG. 2, image set (D), arrowhead) was higher than that in the developing eye of a mouse embryo (FIG. 4, image set (B), cyan arrowhead; FIG. 3, image set (D), Arrow 3). These observations strongly suggest a link between LFI and cell aging via a dimensionless extent of lipofuscin, which would avoid the poor specificity of lipofuscin fluorescence intensity across different samples.

An increased LFI from the blood cells in the skin flap to the surrounding less proliferate fibroblasts was observed. Also, an increased LFI was observed from the 16-cell stage bovine blastomeres with the trophectoderm fate to those with the inner cell mass fate. Moreover, the lowest LFI (33%) was approached by bovine blastomeres near the 2-cell stage and an immortal cell line of breast cancer. These observations appear to correlate low LFI with high proliferation potential after different differentiated cell types experience different extents of aging-like stress to lose proliferation potential. Specifically, the epithelial (intestine/kidney) cells in the same 8-week-old mouse experienced a similar stress as the fibroblasts to attain a comparable LFI, whereas the neurons and oligodendrocyte progenitor cells in the mouse embryo experienced an accelerated stress to reach this LFI earlier. The increased LFI from the fiber-like cells lining the ocular lens of the developing eye to those lining the hosting optic cup supported the paracrine signaling from a preexisting optic cup to a lately developed more proliferate lens, leading to a converged metabolism (6-color profile) and morphology of these cells despite the different origins of the optic cup and lens.

In contrast to the other colors, the crosstalk compensation significantly modified the weak 3PIF and thus enabled accurate metabolism-based quantification of optical redox ratio (ORR). It was observed that rabbit kidney cells in proximal versus distal tubules with different ORRs were observed to exhibit a largely converged LFI (77-78%) or proliferation. This effect is in sharp contrast to the Warburg effect that enhances cell proliferation by a shifted metabolism. As another example, the blastomeres with the inner cell mass fate near the 16-cell stage (ORR 0.95) emerged from the blastomeres near the 2-cell stage that approximated the blastomeres with the trophectoderm fate near the 16-cell stage (ORR 0.66), despite the similar LFI among the three (34-39%). With similarly strong FAD signal, the mutated neural stem cells in this analysis and reported epithelial cancer stem cells might mimic the high-ORR blastomeres for immortality and tumorigenesis, respectively. On the other hand, near unity ORR was approached by in vitro neural stem cells, the neurons and oligodendrocyte progenitor cells in the mouse embryo, and the neurons in a mature rat, despite their rather different LFI across 38-78%. This high ORR discriminated the in vitro neural stem cells from the bovine blastomeres with the inner cell mass fate to highlight the unique metabolism of brain cells, which would be missed without the crosstalk compensation.

Taken together, the observed LFI in this experimental analysis and the ORR are different dimensionless cellular biomarkers complementary with each other. They comprehensively discriminated rare cells from their neighboring cells in the developing eye not possible using comparative histology and phase-contrast microscopy.

Next, the interaction between in vitro hamster kidney cells with a drug or imaging agent were evaluated. First, the treatment by STS induced apoptosis via a modified cell morphology, which was detected by an SCIFI endpoint (or snapshot) assay involving different fields. In comparison to the treatment-free control, these apoptotic cells retained a low LFI despite a reduced ORR, suggesting the independence between LFI and apoptosis. Second, a treatment by the weight-loss drug BAM15 likely generated an aging-like stress with increased LFI (44% versus 32%/control), even though the 6-color profiles of treated and untreated cells were largely comparable. Third, using a membrane dye designed for SHG imaging with low fluorescence background (AP3), the corresponding endpoint assay validated the SHG imaging of cell membrane but detected a significant increase of 2PIF/2PLIF signals, which was confirmed using the breast cancer cells and called for a detailed examination.

To overcome this limitation, the time-lapse or kinetic assay was employed to track cellular changes in the same field of view. The high sensitivity of SCIFI detected the unexpectedly strong AP3 fluorescence via 2PLF/2PLIF from the empty spaces among the cells, enabling in situ monitoring of concentration profile. Thus, the increased 2PIF/2PLIF signals in the endpoint and kinetic assays can be attributed to the surprising ability of AP3 to fluorescently label the cytoplasm. At a high concentration, 4PIF “sensed” cytotoxicity in real-time plausibly due to the inhibited Forster resonance energy transfer by AP3, which was confirmed by BAM15. The maximal concentration of this transient exposure was thus limited to avoid the resulting cytotoxicity, allowing the cells to instead “sense” BAM15 undergoing endocytosis via THG-visible nanovesicles. In contrast, these cells responded to apoptosis-inducing staurosporine (STS) via 3PIF/NADH but not THG, suggesting a non-nanovesicle entry for STS. Regardless of the mode of toxic action, potential drugs (or SCIFI-compatible labeling fluorophores in FIG. 1, image set (A)) attain efficacy (or effectiveness) below a concentration threshold to avoid any SCIFI detectable cytotoxicity.

The real-time assay of LFI also revealed an agile cellular recovery from the transient exposure to STS or BAM15 not observable from 2PIF/2PLIF intensities. The recovery preceded the plausible morphological change of STS-induced apoptosis observed from the endpoint assay. This effect would be challenging to detect from the endpoint assay in comparative examples due to the inaccurately quantified LFI of hamster kidney cells with intrinsically low 2PLIF, highlighting an advantage of the kinetic assay. On the other hand, the LFI-based endpoint assay may serve as a general label-free assay for stress test of custom-cultured cells independent of the NADH apoptosis biomarker or other cell death assays. This endpoint assay produced low and relatively constant 4PIF (0.015-0.027 photon/pulse) for 4 different in vitro cell types without or with drug treatments, which may be used as a biomarker to discriminate in situ against in vitro cell types. To improve drug discovery, realistic 3D disease models such as organoids should approximate the pertinent in situ cell types in 4PIF/THG and summed intrinsic fluorescence intensities, which are typically ˜4-time higher than those of in vitro cell types.

These performance-enhancing capabilities come at a minimal cost. First, using broadband “hyper-fluorescence” as an intrinsic indicator of photodamage, collected strong 4PIF and 3PIF were collected without compromising sample health. However, 10% increased power beyond the typical imaging condition induced uniform hyper-fluorescence to the in situ cells of rabbit small intestine, but not the intracellular “hot spots” inside in vitro cells.

Second, three self-supervised deep learning models were compared in “blind-spot” video denoising free of ground truth data. The overall high performance of UDVD denoising under both fast and slow sample motion may mitigate the low signal-to-noise ratio intrinsic to fast “gentle” imaging. In a real-time fashion, UDVD may enable intraoperative assessment in surgical oncology. Also, the stripe self-correction of mosaicking-assisted image acquisition helps reveal a novel large-scale structure of rat suprachiasmatic nucleus while 2PIF/4PIF visualization can improve targeted patching in 3D over THG triage.

Third, the built-in FLIM further quantified fluorescence for intestinal cell phenotyping and distinguished individual cells of different cell types by 2PIF/FAD. It is to be noted that SHG has the highest sensitivity to detect extracellular collagen fibers and extrinsic food starch particles, whereas the anticipated collagen fluorescence across 4PIF-3PIF spectral range is universally negligible. Also, THG complements intrinsic fluorescence to identify intracellular vesicles and possibly extravasated red blood cells in ex vivo rabbit kidney. The THG intensity in ˜10-nm bandwidth is comparable to summed intrinsic fluorescence intensity of 4PIF, 3PIF, 2PIF, and 2PLIF, and may be the most sensitive imaging for photodamage-prone samples at an attenuated illumination. The apparent correlation in signal strength from the THG-4PIF or 2PIF-2PLIF pair does not prevent independent information from the two colors.

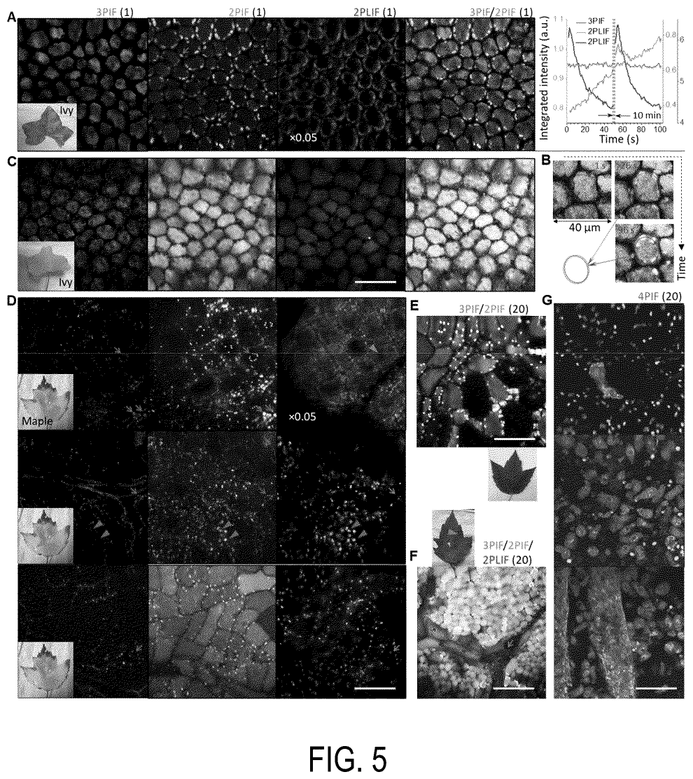

Subsequently, the utility of SCIFI beyond the animal kingdom was tested. From a detached autumn common (evergreen) ivy leaf, the 2PIF-revealed chloroplasts likely by chlorophyll-b fluorescence are cleanly separated from 3PIF-revealed vacuoles of palisade mesophyll cells by stilbene and from 2PLIF-revealed photosystem II (PSII) structures by intense and thus 20×-attenuated chlorophyll-a fluorescence. FIG. 5 illustrates the label-free imaging of various plants and microbes, in which the scale bar represents 50 km.

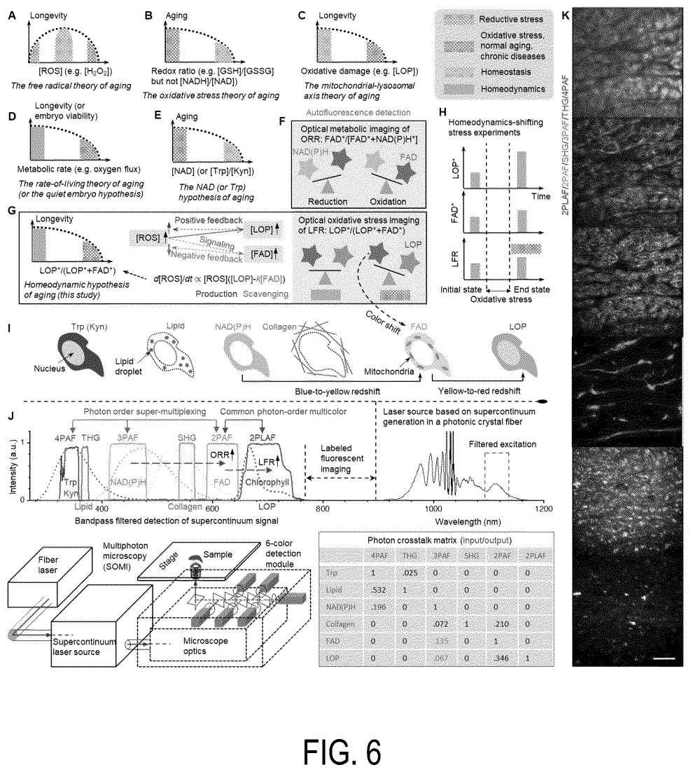

In FIG. 5, image set (A) shows green autumn ivy leaf with 3PIF-visible vacuoles, 2PIF-visible chloroplasts (arrows), and ×0.05-scaled 2PLIF-visible PSII structures undergoing recurrent Kautsky effect (red curves) with increased chloroplast visibility (yellow curves) but constant vacuole visibility (cyan curves). FIG. 5, image set (B) shows coordinated movement of chloroplasts toward each other in one mesophyll cell during imaging (from a green oval to a smaller red oval that links the chloroplasts). FIG. 5, image set (C) shows yellow/diseased autumn ivy leaf with 3PIF-visible vacuoles and chloroplasts (arrows), 2PIF-visible vacuoles, unattenuated 2PLIF-visible vacuoles without observable PSII structures, and composite 3PIF/2PIF architecture opposite to that of its green counterpart. Image set (D) of FIG. 5 shows autumnally variegated green-yellow-red maple leaf showing 3PIF- and 2PIF-visible chloroplasts (magenta arrows) invisible among ×0.05-scaled 2PLIF-visible PSII structures (cyan arrowhead) but visible in unattenuated 2PLIF (cyan arrows) without observable PSII structures. The yellow part of this leaf has 2PIF-visible but 3PIF-invisible chloroplasts (magenta arrowheads) specific to a green spring maple leaf. Image set (E) of FIG. 5 shows green spring maple leaf showing composite 3PIF/2PIF architecture like that of the green autumn ivy leaf. FIG. 6, image (F) shows autumnally variegated green-red maple leaf with 3PIF-visible only (magenta arrows) and 2PLIF-visible only chloroplasts (cyan arrows) in the red part. Image set (G) of FIG. 5 shows depth-resolved detection of microbes (arrow) and/or stromal cells (arrowhead) from mucus (top) to epithelium (bottom) in rabbit small intestine.

The PSII structures at the peripherals of the vacuoles are identified by the Kautsky effect. This observation defies the conventional wisdom of spatially restricted chlorophyll-a to chloroplasts and extends conventional visible/single-photon photosynthesis to near-infrared/two-photon photosynthesis, which resembles the observation of human two-photon vision and emerges as an alternative to study the ultrafast phenomena of ambient photosynthesis using exotic optical source and detection. Meanwhile, a two-photon counterpart of chloroplast phototropism may lead to unusual chloroplast movement and emergence. Without the interference of this effect in one cycle of the Kautsky effect, the chloroplasts exhibit increasing 2PIF, a subtle accompanying effect that has been masked by the intense but decreasing chlorophyll-a fluorescence from standard measurements. This dynamic effect from chloroplasts also occurs at up to 50% weaker illumination powers with a refractory period within 10-20 min and a dark acclimation time of >60 min, and thus reflects the physiological “vitality” of the chloroplasts rather than a photodamage effect. As to static analysis, a yellow/diseased ivy leaf can be differentiated by 3 SCIFI visibility markers related to the chloroplasts, vacuoles, and PSII structures. To correlate this pathological coloration in ivy leaves with the autumnal coloration in maple leaves, these markers were employed to differentiate major leaf phenotypes, including those from an autumnally variegated green-yellow-red maple leaf that enables direct comparison of different colored sectors in the same leaf.

The leaf phenotyping attributes the difference between green autumn ivy versus maple leaves to a seasonal change of the latter rather than a difference between evergreen versus deciduous species. Prominent PSII structures mask the 2PLIF visibility of chloroplasts and extend well beyond them. Maple leaf autumnal red/yellow coloration is marked by disappeared PSII structures with 20×-attenuated chlorophyll-a fluorescence, which exposes the otherwise masked 2PLIF-visible chloroplasts. The related autumnal red coloration emerges expectedly from de novo production of anthocyanin that enables vacuole visibility via 2PIF, resembling the altered vacuole visibility in the diseased yellow ivy leaf. However, the corresponding 3PIF- and 2PLIF-visible chloroplasts may develop into one type of “non-vital” 3PIF-visible only chloroplasts present also in the yellow ivy leaf and another type of 2PLIF-visible only chloroplasts to be recycled before leaf fall. In contrast, maple autumnal yellow coloration emerges without the altered vacuole visibility in the ivy pathological yellow coloration, but with spring 2PIF-visible but 3PIF-invisible chloroplasts absent from a green autumn maple leaf. Taken together, a yellow autumn leaf may use additional energy to compensate the lost “vitality” in 3PIF-visible autumn chloroplasts by reproducing the “vital” spring chloroplasts, paralleling the de novo production of anthocyanin in a red autumn leaf. The underlying hypothesis suggests that autumnal yellow and red phenotypes emerge independently from autumnal green phenotype; that is, no yellow state mediates between autumnal green and red states.

In addition to plants and animals as described above, SCIFI was applied to prokaryotic cells with relevance in the food industry. The microbes in rabbit intestinal mucus exhibited abnormally high LFI, which was attributed to the strong 2PLIF from a chlorophyll-a-rich diet rather than an aging-like stress. To evaluate the possible diet origin of the abnormally strong 4PIF from these microbes, diverse vegetation was examined identified strong or independent 4PIF was identified only in rare cases, such as the leaf stalk of Mimosa pudica and the wall of ginger oleoresin cells. Thus, the strong bacterial 4PIF arises more likely from intrinsically abundant tryptophan than diet, whereas the advantage of imaging over comparative non-imaging spectroscopy may empower food quality assessment. The strong 4PIF signal allows real-time depth-resolved in situ detection of intestinal microbes potentially valuable in gut biopsy or intravital imaging, while combined 4PIF and THG uniquely reflects the evolution from the prokaryotic cells of intestinal microbes to the eukaryotic cells of C. elegans and then to the eukaryotic cells of mammals. The absence of the microbes near intestinal epithelium and their abundance in cell-free mucus were intermediated by a moderate presence with spatially separated stromal/immune cells, suggesting the existence of a layered immunological barrier in mucus to explain the intrigue observation why most crypts were not colonized by bacteria. The microbes share the same photodamage dynamics as their host cells, and can therefore be discriminated against non-living particles with no hyper-fluorescence.

The analysis described above show that the intense chlorophyll-a fluorescence in plants and microbes implicates context-aware near-infrared fluorescently labeled imaging of animal samples that removes the restriction to label-free imaging and thus bridges preclinical/labeled and clinical/label-free studies. This imaging can be further empowered by replacing the dichroic/filter-based detection with an optical fiber-coupled spectroscopic detection to expand the label-free molecular imaging beyond a few preselected targets. With a similar capital expense as comparative multiphoton microscopy but a potentially lower operating expense, SCIFI gains some advanced capabilities largely free of cost and versatile adaptations free of restriction. In particular, the stabilized supercontinuum source and subsequent optical fiber-coupled delivery not only simplifies routine maintenance by the laser-microscope alignment decoupling, but also enables tunable or multi-band excitation and simultaneous non-imaging applications such as optogenetics by harnessing unused (unfiltered) portions of the supercontinuum. With available tools to democratize the imaging and further modification of illumination condition, SCIFI heralds “free view” of living systems, especially those close to everyday life.

In one example implementation, the methodologies set forth above may be used to visualize single-cell oxidative stress against metabolic oxidation. Cellular oxidative stress versus normal metabolic oxidation may be used for understanding development, aging, and chronic diseases. Comparative fluorescence microscopy does not guarantee the authenticity of subcellularly resolved oxidative stress free from perturbative photo-stress. In this example, a supercontinuum (340-740 nm) signal is produced from living systems before photo-stress onset. This approach increases the simultaneously observable metabolites for real-time label-free imaging and identifies two specific autofluorescence redshifts to differentiate unperturbed oxidative stress from co-existing metabolic oxidation. These intrinsic molecular metrics are employed to test a homeodynamic hypothesis of aging across diverse stressors, timescales, species, cell types, and tissue contexts.

Introducing aerobic respiration into anaerobic metabolism helped animals emerge and thrive evolutionarily. Paradoxically, the gain in biogenetics also produces oxidative stress, which not only hinders embryonic development but also induces aging and related chronic diseases, e.g., diabetes, heart disease, neurodegeneration, and cancer. The latter inspired the free radical theory of aging, which has been limited by selections of diverse free radicals or reactive oxygen species (ROS) and redox couples to correlate the observed oxidative effects to aging, e.g., the reduced/oxidized glutathione ratio of [GSH]/[GSSG]. A similar lack of widely applicable specificity is encountered when accumulative oxidative stress is measured by diverse oxidative damages, including the lipofuscin-like oxidation product (LOP) in the mitochondrial-lysosomal axis theory of aging. Table 1 compares various theories of aging. This limitation persists when the focus is shifted from metabolite concentrations (homeostatic view) to diverse metabolic rates (homeodynamic view) in the rate-of-living theory, which was generalized to embryonic development via the quiet embryo hypothesis. Table 2 summarizes these two views of oxidative stress. The formulation of nicotinamide adenine dinucleotide (NAD) or tryptophan (Trp) hypothesis of aging has avoided this limitation by highly specific measurement on [NAD](or tryptophan/kynurenine ratio [Trp]/[Kyn]), but the link between this readout and oxidative stress becomes indirect. Thus, there exists an unmet need in the integrated field of development, aging, and chronic diseases to probe subcellular redox biology, with widely applicable specificity to oxidative stress against the physiological noises from normal metabolism, redox signaling, bioenergetics, and biosynthesis.

TABLE 1

| | | | Mitochondrial- | |
|---|---|---|---|---|
| | | Oxidative stress | lysosomal axis | Rate-of-living |
| | Free radical theory | theory | theory | theory |
| Focus on aging | Concentrations of | Redox couples | Oxidative damages | Metabolic rates |
| biomarkers | ROS | | | |
| Representative | H₂O₂, superoxide | [GSH]/[GSSG], | Lipofuscin, lipid | Oxygen |
| | | | | consumption rate, |
| biomarkers | radical anion, | [Cys]/[CySS], | peroxidation, | extracellular |
| | | | | acidification rate, |
| | singlet oxygen, | [NADH]/[NAD], | protein aggregation, | mitochondrial |
| | nitrogen dioxide | [NADPH]/[NADP], | nucleic acid | respiration, |
| | radical, carbonate | [FADH₂]/[FAD], | damage, etc. | glycolysis, etc. |
| | radical anion, | ETC. | | |
| | hypochlorous acid, | | | |
| | etc. | | | |
| View of oxidative | Homeostasis | Homeostasis | Intermediate | Homeodynamics |
| stress | | | between | (and hormesis) |
| | | | homeostasis and | |
| | | | homeodynamics | |
| Key spatial content | Mitochondria | Both intracellular | Mitochondria and | Mitochondria, |
| of measurement | | and extracellular | lysosome | whole cell, or |
| | | | | organism |
| Optimal range | Present | Absent | Absent | Possible |
| (Goldilocks zone) | | | | |
| Acute oxidative | Compatible | Often neglected | Often neglected | Highly relevant |
| stress | | | | |
| Major challenge | To differentiate | To define the | Unclear path from | Intriguingly |
| | ROS that produce | balance of (non- | acute oxidative | different |
| | oxidative stress | equilibrated) pro- | stress to cumulative | dependence of |
| | from those that | oxidants and | oxidative damages | lifespan on |
| | maintain redox | antioxidants by a | | metabolic rate for |
| | signaling | single entity | | birds vs. mammals |

TABLE 2

| | View of oxidative stress from | View of oxidative stress from |
|---|---|---|
| | homeostasis | homeodynamics |
| Core concept | Life is a pseudo-equilibrium system | Life is a non-equilibrium system |
| Influential definition and | An imbalance between oxidants and | A state in which the production of ROS |
| implied causal relation | antioxidants in favor of the oxidants, | overwhelms the endogenous antioxidant |
| | leading to a disruption of redox | defense due to disrupted redox signaling |
| | signaling and control and/or molecular | |
| | damage | |
| Aging (implication) | Aging is caused by an imbalance | Aging is caused by progressively |
| | between oxidants and antioxidants in | deceased ROS scavenging rate in |
| | favor of the oxidants (high level of | comparison to ROS production rate (high |
| | oxidants, if countered by a high level of | ROS production rate, if countered by a |
| | antioxidants, does not accelerate aging) | high ROS scavenging rate, does not |
| | | accelerate aging) |
| Key molecules (targeted | Diverse ROS and redox-coupled | LOP, FAD, and NAD (autofluorescence |
| metrics) | metabolites (concentrations of related | of LOP, FAD, and Trp reflecting ROS |
| | ROS and metabolites) | production/scavenging rates) |
| Ratiometric | Diverse redox couples variable among | Redefined oxidative stress by disrupted |
| measurement | intra- and extracellular compartments | redox signaling in whole cell body based |
| | and lack of equilibration with each other | on ROS scavenging versus production |
| NAD metabolism in | Presence of the NAD ratio redox | Mitigation of this paradox by decoupling |
| aging | paradox | oxidative stress from metabolic oxidation |
| Generic term of “ROS” | Discouraging the use of this term | Useful to describe overall ROS |
| | without specifying exact molecules | production and scavenging |
| Effects caused by | Diverging due to the production of | Converging (e.g. similar protein |
| different stressors | different types of ROS and oxidative | aggregation) due to the disruption to |
| | damages | common conservative pathways |
| Spatial content (origin of | Mitochondria as the central organelle for | Cytoplasm as the central compartment for |
| cell differentiation and | ROS production (diversification is | adaptive ROS scavenging (diversification |
| diverse species- | driven by adaptive change of | is driven by different types and rates of |
| dependent cell types) | mitochondrial ROS scavenging toward | ROS production to achieve diverse |
| | homeostasis) | biological functions) |
| Opposite extreme | Reductive stress (optimal/homeostatic | Absent (no need for ROS scavenging rate |
| (rationale) | ROS level to avoid both oxidative and | to be larger than ROS production rate) |
| | reductive stresses) | |
| Hormesis (relevance to | Incompatible (exercise-induced | Compatible (acute oxidative stress from |
| exercise) | oxidative stress detrimental to health) | regular exercise beneficial for health) |
| Relevance to the | Unclear path from acute oxidative stress | Path from acute oxidative stress to |
| mitochondrial-lysosomal | to cumulative oxidative damages | cumulative oxidative damages from the |
| axis theory of aging | | perspective of hormesis |
| Normal (chronological) | Normal aging may be treated as a | Normal aging under homeodynamics is a |
| aging vs. chronic | disease of disrupted homeostasis just | not a disease (because chronic diseases |
| diseases | like chronic diseases (due to a common | produce differential oxidative stress over |
| | factor of sustained high ROS level) | normal aging) |
| Programmed cell death | Originated from sustained high ROS | Originated from disruptive redox |
| | level | signaling |
| Hayflick's limit for in | Seemingly incompatible because diluted | Compatible because progressively |
| vitro cell division and | cumulative oxidative damages from cell | disrupted redox signaling over passages |
| cell senescence | | |
| | division should allow cells to proliferate | prohibits cells from renewing themselves |
| | indefinitely | indefinitely |
| Relevance to embryonic | Existence of optimal level oxidative | Absence of optimal level oxidative stress |
| development | stress not consistent with the quiet | consistent with the quiet embryo |
| | embryo hypothesis | hypothesis |
| Antioxidant therapies by | Helpful due to the implied causal | Not helpful due to the implied causal |
| dietary supplements | relation (with counter evidence known | relation (therapies may compromise |
| | as the antioxidant paradox) | health-promoting exercise) |
| Popular strategy of redox | Administrate low molecular weight | Modulate redox signaling via enzymatic |
| medicine | antioxidants to counter oxidative stress | pathways to counter oxidative stress and |
| | and restore homeostasis | restore homeodynamics |

FIG. 6 illustrates some general concepts of this example. In FIG. 6, graphs (A)-(E) illustrate selected theories and hypotheses of aging; diagram (F) shows optical metabolic imaging of blue NAD(P)H and green FAD fluorescence; and graph set (G) shows a proposed homeodynamic hypothesis of aging with ROS production vs. scavenging and optical oxidative stress imaging of green FAD and red LOP fluorescence. Graph set (H) shows homeodynamics-shifting experiments with differential increase of LOP fluorescence over FAD fluorescence or NAD concentration after a period of external stress. Diagram set (I) shows a 6-metabolite minimum model of animal cells with yellow FAD fluorescence excited at 1110 nm. Diagram set (J) shows spectrally filtered optical excitation and spectrally resolved signal collection (top), an example system schematic (bottom left), and a photon crosstalk matrix of SOMI (bottom right). Image set (K) shows SOMI of rabbit heart tissue showing synergistic advantages of 6 highly orthogonal (independent) colors or contrasts. The scale bar represents 50 km.

An oxidation-reduction ratio (ORR) amendable for sensitive fluorescence measurement free of external labeling or genetic modification has been proposed. This metric is expressed as FAD*/[FAD*+NAD(P)H*], which involves autofluorescence (AF) intensities (*) of flavin adenine dinucleotide (FAD), reduced NAD (NADH) and its phosphate counterpart (NADPH) denoted together as NAD(P)H. Despite the use of ORR as a fluorescent surrogate for [NADH]/[NAD]-based metabolic oxidation, this redox couple has no well-documented correlation with oxidative stress like the ratio [GSH]/[GSSG]. Since the NADPH-dependent antioxidation often complicates the interpretation of ORR, an alternative label-free metric of oxidative stress was developed based on lipid oxidation. The FAD-dependent antioxidation has often been forgotten, even though FAD is a known co-factor of glutathione reductase in ROS scavenging. This ROS scavenging is assumed to balance the LOP-catalyzed ROS production in a homeodynamic hypothesis of aging, with oxidative stress defined as a normalized LOP-to-FAD ratio (LFR), i.e. LOP/(LOPF+FADA). The hypothesis supporting this example is motivated by two independently observed effects on live cells after a period of endogenous or exogenous stress, i.e. elevated LOP and FAD* suggestive of high ROS production and scavenging, respectively. Table 3 illustrates the paralleled definition of two cellular metabolic metrics, and Table 4 illustrates the independently observed increases of LOP and FAD fluorescence in homeodynamics-shifting stress experiments.

TABLE 3

| | Optical redox ratio (ORR) | LOP-to-FAD ratio (LFR) |
|---|---|---|
| Targeted metabolic aspect | Metabolic oxidation | Oxidative stress |
| Normalized fluorescence | FAD*/[FAD* + NAD(P)H*] | LOP*/(LOP* + FAD*) |
| measurement | | |
| Simplification under single band | Blue-to-green AF redshift at ~780 | Green-to-red AF redshift at ~920 |
| two-photon excitation without | nm excitation | nm excitation |
| crosstalk compensation | | |
| Further simplification under ~1110 | Blue-to-yellow RF redshift | Yellow-to-red AF redshift |
| nm multiphoton excitation | | |
| Dual roles of FAD | Oxidized element of FAD/FADH2 | Surrogate metric for ROS |
| | redox couple | scavenging rate |
| Distinct aspect | NAD(P)H as reduced element of | LOP to assess ROS production rate |
| | NAD(P)/(NAD(P)H redox couple | |
| Physiological nature | Homeostasis | Homeodynamics |

TABLE 4

| | | |
|---|---|---|
| Detection and | | |
| excitation (nm) | Sample (stressor, timescale) | Key observation |

Increased LOP autofluorescence as an apparent biomarker of oxidative stress

| | | |
|---|---|---|
| 610/70@540/35 | C. elegans (aging, days) | Red AF, not blue/green AF, is a biomarker of |
| | | aging |
| 660-720@640 | Human keratinocytes (UV radiation 1-20 | Oxidation products of peptide aggregates can |
| | s; H₂O₂ 1-mM, 19-hr) | cause increased red AF |
| >671@671 | Human forearm skin (cigarette smoke 5- | Cigarette smoke induces red and near |
| | min) | infrared AF by oxidizing skin surface lipids |
| 604-679@1120 | Human breast cancer cells (H₂O₂, | Red AF in lysosome indicative of necrosis |
| | cisplatin, thapsisgargin, 2-72 hr) | and apoptosis, and cell senescence |
| >850@808 | Cells/macrophages of mice (CC14- | Chronic liver disease is associated with |
| | induced liver fibrosis and high-fat diet- | increased near infrared AF of lipofuscin or |
| | induced non-alcoholic fatty liver disease, | ceroid, and can be monitored non-invasively |
| | weeks) | |
| 643-713@638 | Human coronary artery (atherosclerosis, | Increased red AF from ceroid (lipofuscin) |
| | years), human macrophages in vitro | under oxidized lipid-induced oxidative stress |
| | (oxidized low-density lipoprotein, days) | can be suppressed by antioxidants) |
| 629/62@561 | Mouse macrophages/microglia (active | Red AF beings to increase within (lysosome) |
| | immune response and/or aging, 2-60 | or outside microglia in 8-week-old mice |
| | days) | |
| 604-679@1040 | Mouse macrophages (high-fat diet, | Bright red AF marks the location of |
| | months) | macrophages |

Increased FAD autofluorescence as an apparent biomarker of oxidative stress

| | | |
|---|---|---|
| 515-545@488 | Mouse blood cells and mitochondria-free | Simultaneously increased FAD and |
| | cell lines (X-ray ionizing radiation, ~2- | NAD(P)H fluorescence intensities after the |
| | min) | radiation |
| 530/40@488 | Diverse epithelial cancer stem cells | Intracellular FAD autofluorescence from |
| | (chemotherapy by gemcitabine, 12-day; | cytoplasmic vesicles increases after a stress |
| | 2,4-dinitrophenol, oligomycin, rotenone, | period despite a decrease in FAD |
| | 72-hr) | autofluorescence within this period, and is a |
| | | biomarker for epithelial cancer stem cells |
| >515@470-490 | Mouse brain slices (a lower temperature | Increased FAD fluorescence (with decreased |
| | than physiological temperature of 37° C., | NAD(P)H fluorescence showing metabolic |
| | 30-min) | oxidation) |
| 530/30@488 | E. coli (ampicillin, 2-hr), yeast and | Increased expression of genes encoding |
| | human cells (sodium hypochlorite, 1-hr) | flavoproteins for bioenergetics and ROS |
| | | detoxification |
| 525/50@488 | Human mesenchymal stromal cells | FAD fluorescence links to multiple |
| | (number of passages in culturing, days) | senescence-related markers but not telomere |
| | | length (aging) |
| 550/49@880 | Keratinocytes in reconstructed human | FAD fluorescence lifetime and intensity |
| | skin (radiation UVA1 40 J/cm², 2-hr) | indicative of long UVA-induced metabolic |
| | | stress |
| 505-550@454 | Primary co-culture of neurons and | High FAD autofluorescence indicates |
| | astrocytes, and human skin fibroblasts | pathology preceding cell death but is not |
| | (senescence from cell divisions, days) | directly associated with apoptosis and |
| | | necrosis |
| 511-651@780 | In vitro produced mouse embryos | Increased FAD fluorescence for in vitro |
| | (nutrient deficiency of | embryos cultured in nutrient-deficient media |
| | pyruvate/lactate/glucose, days); collected | and for in vitro oocytes with natural and |
| | oocytes (aging, days) | induced aging |

In support of this example, the homeodynamic hypothesis and redefined oxidative stress were tested in the broad context of oxidative damage, Trp and NAD synthesis, ORR-revealed metabolic oxidation, NADPH-dependent antioxidation, lipid metabolism, and extracellular collagen distribution. Label-free optical metabolic imaging was used to simultaneously visualize Trp, NAD(P)H, FAD/LOP by four-, three-, two-photon excited AF (4PAF, 3PAF, and 2PAF/2PLAF, where 2PLAF represents two-photon-excited long-wavelength AF), along with intracellular lipid droplets and extracellular collagen (fibers) by third- and second-harmonic generation (THG and SHG), respectively. In this way, cellular inter-metabolite interaction undergoing internal or interventional metabolic changes can be tracked continuously by a simple fixed-wavelength illumination. Numerical simulation using multiphoton absorption cross sections justifies the gentle imaging by 4PAF in comparison to 3PAF.

Due to orthogonal signal collection across 340-740 nm analogous to the supercontinuum generation in a photonic crystal fiber, this imaging method is referred to herein as supercontinuum optical metabolic imaging (SOMI). Under a standardized and gentle condition, SOMI can be conducted in real time to search for a field-of-view (FOV) of interest and improve the THG-assisted 3D targeted patching in neuroscience. Ex vivo cells were compared with or without significant extracellular components to test the fluorescence lifetime imaging of SOMI. These components produced artifacts in the phasor distributions despite consistent presence of three major patterns of cellular Trp, NAD(P)H, and FAD. Thus, to quantify single-cell metabolism free of the artifacts, samples with significant extracellular components or ambiguous cell morphologies were avoided. Most samples allowed segmenting single in situ cells or cell clusters in 3D microenvironments to compare with single in vitro cells in 2D cultures. Both NAD(P)H and FAD phasor distributions of 5 distinct cell types revealed larger single-cell variations across cell types than within one cell type, but only FAD phasor distributions unambiguously distinguished these cell types. The significantly lengthened 3PAF lifetime from a subtype of intestinal immune cells with an NAD(P)H-rich nucleus revealed the NADPH-dependent antioxidation that distinguished them from other subtypes of immune cells coexisting with bacteria. In contrast, the significantly shortened 2PAF lifetime from AP3-labeled in vitro cells revealed an apparent “cytotoxicity” of this labeling that was previously promoted for live-cell SHG microscopy. Table 5 presents an analogy between supercontinuum generation in ultrafast laser physics and in biology.

TABLE 5

| | Supercontinuum generation in | Supercontinuum generation in biology |
|---|---|---|
| | ultrafast laser physics | (SOMI) |
| Applications | Many applications which include the | Generation of broadband optical signal |
| | supercontinuum laser source for | informative of intrinsic metabolites and |
| | multiphoton microscopy with multiple | other biomolecules in biology and |
| | simultaneously accessible bands | medicine |
| Source laser | 1060 nm, ps, 10-100 MHz | 1110 nm, 60-fs, 5 MHz from a filtered |
| | | supercontinuum laser source |
| Nonlinear medium | One endless single-mode photonic | A diffraction limited spot (1 μm) within |
| | crystal fiber (undoped silica) several | 1 mm depth (typically) of biological |
| | meters in length | samples |
| Nonlinear signal | Self-phase modulation, soliton | Four-, three-, two-photon excited |
| | | autofluorescence, second- and third- |
| generation processes | dynamics, dispersion wave generation, | harmonic generation |
| | four-wave mixing, sum frequency | |
| | generation, third-harmonic generation, | |
| | etc. | |
| Signal spatial profile | Single fundamental mode of the fiber | Ballistic photons under near single-mode |
| | | propagation |
| Spectral coverage | 350-2200 nm | 350-740 nm |
| Signal blueshift | Coupled soliton dynamics and | Four-photon excited autofluorescence |
| | dispersion wave generation | |
| Signal redshift | Coupled soliton dynamics and | Large stokes shift to enable two-photon |
| | dispersion wave generation | excited long-wavelength fluorescence |
| Phototoxicity at a high | Formation of long-period fiber grating | Photo-stress and subsequent permanent |
| incident power | at entrance end of the fiber | protein/lipid damage at higher power |
| Nontrivial (trivial) | Fiber dispersion engineering (with | Optimized one pulse/pixel scanning that |
| mitigation of phototoxicity | increased mode area) | fully relaxes triplet state (at lowered |
| | | excitation power) |

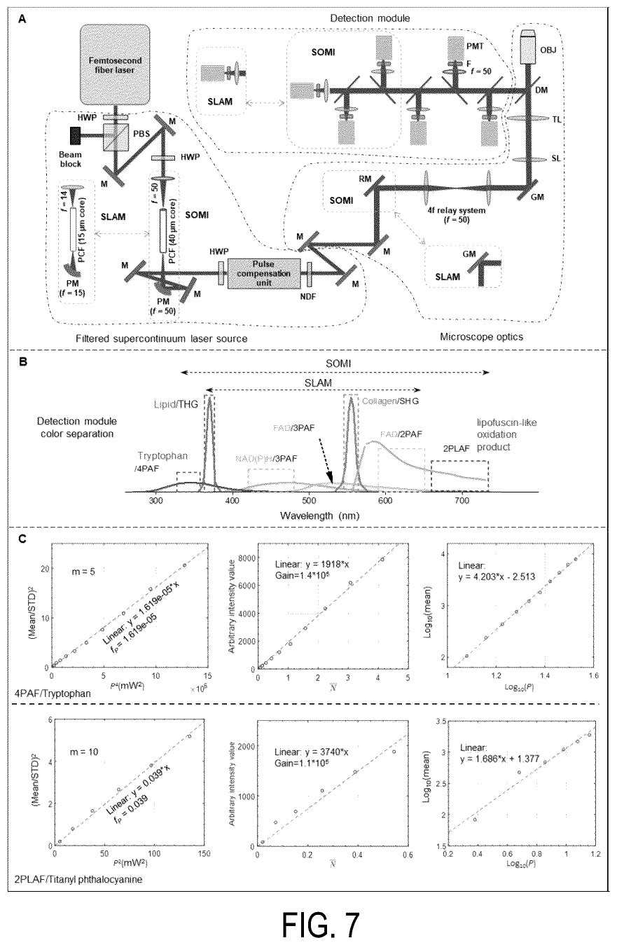

FIG. 7 illustrates an example optical schematic for SOMI versus SLAM microscopy. In FIG. 7, schematic (A), DM refers to a dichroic mirror, GM refers to a galvanometer mirror, prefers to a halfwave plate, M refers to a mirror, NDF refers to a neutral density fiber, OBJ refers to the objective of the microscope, PBS refers to a polarization beam splitter, PCF refers to a photonic crystal fiber, PM refers to a parabolic mirror, PMT refers to a photomultiplier tube, RM refers to a resonant mirror, SL refers to a scan lens, and TL refers to a tube lens. In graph (B), it can be seen that color separation of intrinsic biomolecules in detection module assuming fluorescence from lipofuscin-like oxidative product occurs exclusively in 2PLAF color. Graph set (C) presents a quantitation of 4PAF and 2PLAF signals to calibrate the 6-color photon crosstalk matrix using 50-mM tryptophan solution and titanyl phthalocyanine solution (0.01 mg/mL), respectively. Table 6 presents a comparison between hardware and imaging conditions in the multiphoton microscopy setups.

TABLE 6

| | SLAM microscopy | SOMI or SLAM 2.0 |
|---|---|---|
| Ultrafast source laser | Satsuma (Amplitude Systems) | Satsuma (Amplitude Systems) |
| Input laser parameters | 10 MHz, 2.0 W, 1030 nm, 300 fs, linear | 5 MHz, 3.25 W, 1030 nm, 300 fs, linear |
| | polarized | polarized |
| Photonic crystal fiber | LMA-PM-15 (NKT Photonics) | LMA-PM-40-SUD (NKT Photonics) |
| type | | |
| Photonic crystal fiber | 25 cm | 9 cm |
| length | | |
| Coupling lens | C280TMD-B (Thorlabs) | AC127-050-B (Thorlabs) |
| Output supercontinuum | 10 MHz, 1.4 W, polarization maintained | 5 MHz, 2.2 W, polarization maintained |
| parameters | 900-1160 nm | 900-1160 nm |
| Photonics crystal fiber | Fiber degradation after ~100-hr | No fiber degradation after ~200-hr |
| long-term stability | operation with lower output power of | operation |
| | supercontinuum | |
| Collimation parabolic | MPD019-P01 (Thorlabs) | MPD029-P01 (Thorlabs) |
| mirror for | | |
| supercontinuum | | |
| Dispersion | MIIPSBox640 (Biophotonic Solutions), | FemtoJock (Biophotonic Solutions), 128- |
| compensation unit | 640-pixel | pixel |
| Filtered | 1110 ± 30 nm | 1110 ± 30 nm |
| supercontinuum | | |
| Beam expander | | BE052-B (Thorlabs) |
| Fast scanning mirror; | 6215H (Cambridge Technology); up to | SC30-20 (EOT); fixed at 1595.3 Hz and |
| line rate | 500 MHz typically | synchronized with laser clock (repetition |
| | | rate) |
| Achromatic lens 1 | AC508-075-B-ML (Thorlabs) | AC254-050-C-ML (Thorlabs) |
| Achromatic lens 2 | AC508-075-B-ML (Thorlabs) | AC254-050-C-ML (Thorlabs) |
| Slow Scanning Mirror | 6215H (Cambridge Technology) | CVS011 (Thorlabs) |
| Achromatic lens 3 | AC254-030-B-ML (Thorlabs) | AC254-030-C-ML (Thorlabs) |
| Achromatic lens 4 | AC508-100-B-ML (Thorlabs) | AC508-100-C-ML (Thorlabs) |
| Main dichroic mirror | FF750-SDi02 (Semrock) | FF925-Di01 (Semrock) |
| Microscope objective | XLPLN25XWMP2 (Olympus) | UAPON40XW340 (Olympus) |
| type | | |
| Microscope objective | 25 × NA 1.05, working distance 2 mm | 40 × NA 1.15, working distance 0.25 mm |
| Pulses at objective | 10 MHz, 60 fs FWHM | 5 MHz, 60 fs FWHM |
| focus | | |
| Motorized sample stage | nanoXYZ (PI) | FTP-2000 (ASI) |
| Detection color THG | Dichroic mirror: FF409-Di03 (Semrock) | Dichroic mirror: FF376-Di01 (Semrock) |
| | Focusing lens AC254-050-A-ML | Focusing lens LA1131-A (Thorlabs) |
| | (Thorlabs) | Bandpass filter: FF370/10 (Semrock) |
| | Bandpass filter: FF370/10 (Semrock) | PMT: H10721-210 (Hamamatsu) |
| | PMT1: H7421-40 (Hamamatsu) | Transimpedance amplifier: TIA-60 |
| | | (Thorlabs) |
| Detection color 3PAF | Dichroic mirror: FF506-Di03 (Semrock) | Dichroic mirror: FF484-Di01 (Semrock) |
| | Focusing lens AC254-050-A-ML | Focusing lens LA1131-A (Thorlabs) |
| | (Thorlabs) | Bandpass filter: FF02-447/60 (Semrock) |
| | Bandpass filter: FF02-447-60 (Semrock) | PMT: H4722A-40 (Hamamatsu) |
| | PMT1: H7421-40 (Hamamatsu) | Transimpedance amplifier: C5594-12 |
| | | (Hamamatsu) |
| Detection color SHG | Dichroic mirror: FF570-Di01 (Semrock) | Dichroic mirror: FF580-FDi01 (Semrock) |
| | Focusing lens AC254-050-A-ML | Focusing lens LA1131-A (Thorlabs) |
| | (Thorlabs) | Bandpass filter: FF01-554/23 (Semrock) |
| | Bandpass filter: FF01-559-34 (Semrock) | PMT: H10721-20 (Hamamatsu) |
| | PMT1: H7421-40 (Hamamatsu) | Transimpedance amplifier: TIA-60 |
| | | (Thorlabs) |
| Detection color 2PAF | Dichroic mirror: FF750-SDi02 | Dichroic mirror: FF652-Di01 (Semrock) |
| | (Semrock) | Focusing lens LA1131-A (Thorlabs) |
| | Focusing lens AC254-050-A-ML | Bandpass filter: FF01-618/50 (Semrock) |
| | (Thorlabs) | PMT: H7422A-40 (Hamamatsu) |
| | Bandpass filter: FF301-609/62 | Transimpedance amplifier: C5594-12 |
| | (Semrock) | (Hamamatsu) |
| | PMT1: H7421-40 (Hamamatsu) | |
| Detection color 4PAF | Absent | Dichroic mirror: FF355-Di01 (Semrock) |
| | | Focusing lens 48-284 (Edmund) |
| | | Bandpass filter: FF01-618/50 (Semrock) |
| | | PMT: H10721-210 (Hamamatsu) |
| | | Transimpedance amplifier: TIA-60 |
| | | (Thorlabs) or C5594-12 (Hamamatsu) for |
| | | optional FLIM |
| Detection color 2PLAF | Absent | Dichroic mirror: FF652-Di01 (Semrock) |
| | | Focusing lens: LA1131-A (Thorlabs) |
| | | Optional attenuator (leaves): OD 1.3 |
| | | (Thorlabs) |
| | | Shortpass filter: 86-104 (Edmund) |
| | | PMT: H47422A-40 (Hamamatsu) |
| | | Transimpedance amplifier: TIA-60 |
| | | (Thorlabs |
| Output signal from | Photon counts | Analog voltage |
| PMT | | |
| Signal throughput | <0.2 photons/pulse for accurate | Up to 4 photons/pulse using photon- |
| | quantification | resolved analog detection |
| Digitizer for data | PCle-6612 (National Instruments) | ATS9440 (Alazar Technologies) for THG, |
| acquisition | | SHG, 4PAF, and 2PLAF; ATS9373 |
| | | (Alazar Technologies) for 3PAF and 2PAF |
| | | with optional FLIM |
| Frame size (pixels) | Flexible up to 1024 × 1024 | 1024 × 1024 fixed |
| Pulses/pixel | 10-50 (typically) | 1 |
| Pixel dwell time | 1-5 μs (typically) | 0.2 μs |
| Frame acquisition time | >1 s (typically) | 0.33 s |
| Time-laps imaging | <0.5 Hz for one-way scanning | Up to 1 Hz for unidirectional scanning (up |
| frame rate | | to ~3 Hz using bidirectional scanning and |
| | | fast data acquisition) |
| Field of view | Flexible up to 400 × 400 μm² | Flexible up to 300 × 300 μm² |
| Average power on | ~15 mW fixed (5-200 μm) | 15 mW (10-20 μm) for animal samples, |
| sample (imaging depth) | | 7.5-10 mW (10-20 μm) for plant samples, |
| | | up to 20 mW in 3D imaging (5-300 μm) |
| Controlling software | Lab View (National Instruments) | LabView (National Instruments) |

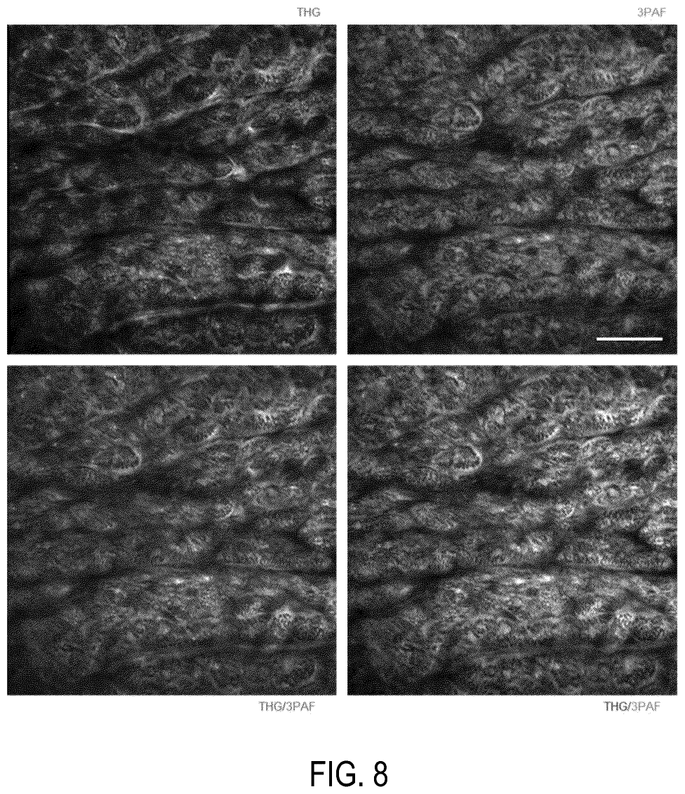

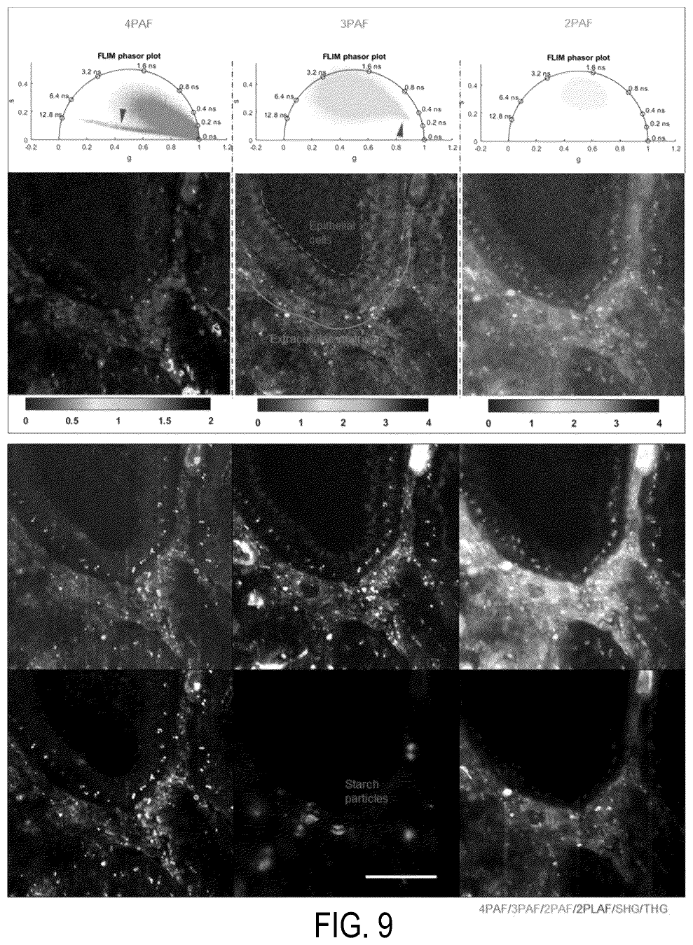

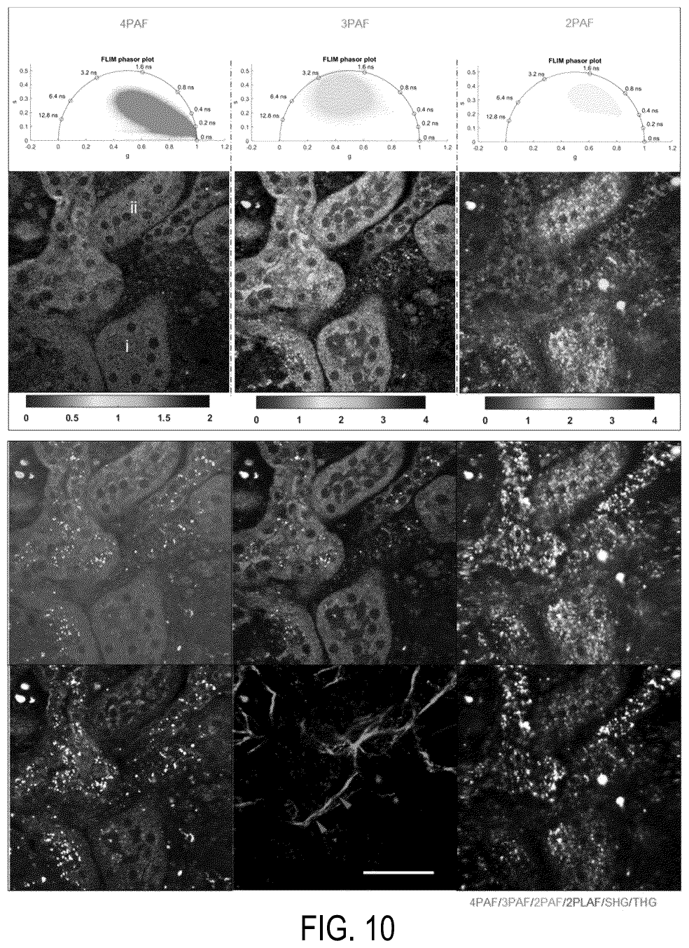

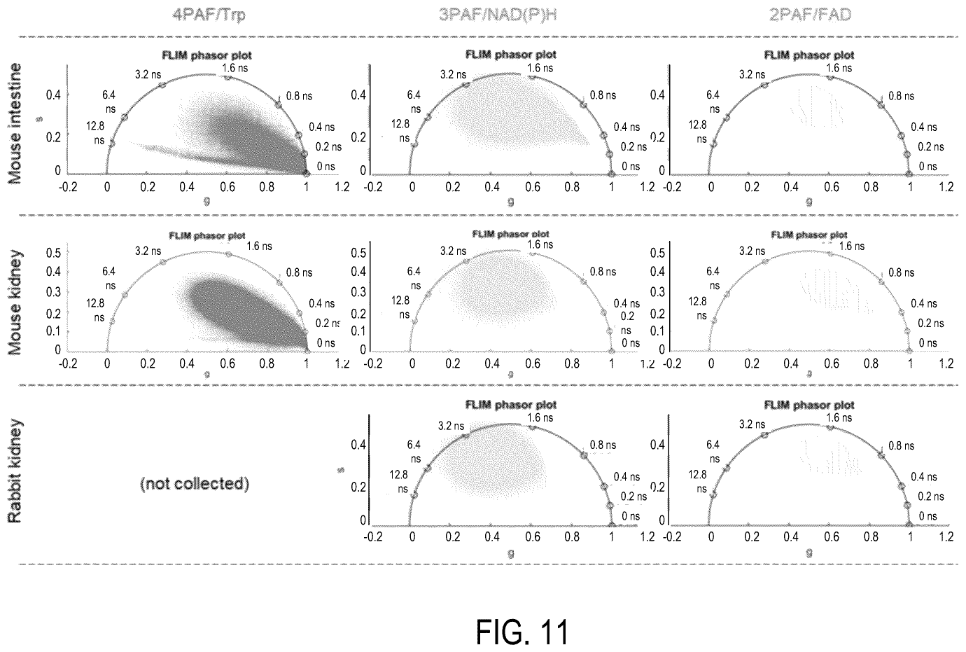

FIG. 8 shows single-versus dual-color SOMI images of rabbit heart tissue. Subtle differences between THG (upper left) and 3PAF (upper right) images can be resolved by either magenta/green (lower left) or red/cyan (lower right) dual-color visualization. In FIG. 8, the scale bar represents 50 μm. FIG. 9 shows an example of cellular SOMI profiling of a niche of ex vivo mouse intestine with prominent extracellular matrix. The top row of images are tri-color FLIM images with intensity overlay (9-pixel averaging over neighboring pixels) and full-field phasor distributions to show artifacts in 4PAF and 3PAF phasor distributions (arrowheads) due to large-scale extracellular matrix (cyan curve) near intestinal epithelial cells (magenta curve). The bottom rows are co-registered 6-color SOMI intensity images. FIG. 10 shows an example of cellular SOMI profiling of a niche of ex vivo mouse kidney without prominent extracellular matrix. The top row of images corresponding to tri-color FLIM data and show no artifact in the phasor distributions with sparse collagen-based extracellular matrix (arrowheads), whereas subtle difference between two kidney lobules not obvious in 3PAF- and 2PAF-FLIM images can be resolved in 4PAF-FLIM image (Insets i and ii). The bottom rows are co-registered 6-color SOMI intensity images. The scale bar represents 50 μm in both FIGS. 9 and 10. FIG. 11 illustrates the consistent presence of three major intrinsic fluorophores in the ex vivo tissue samples.

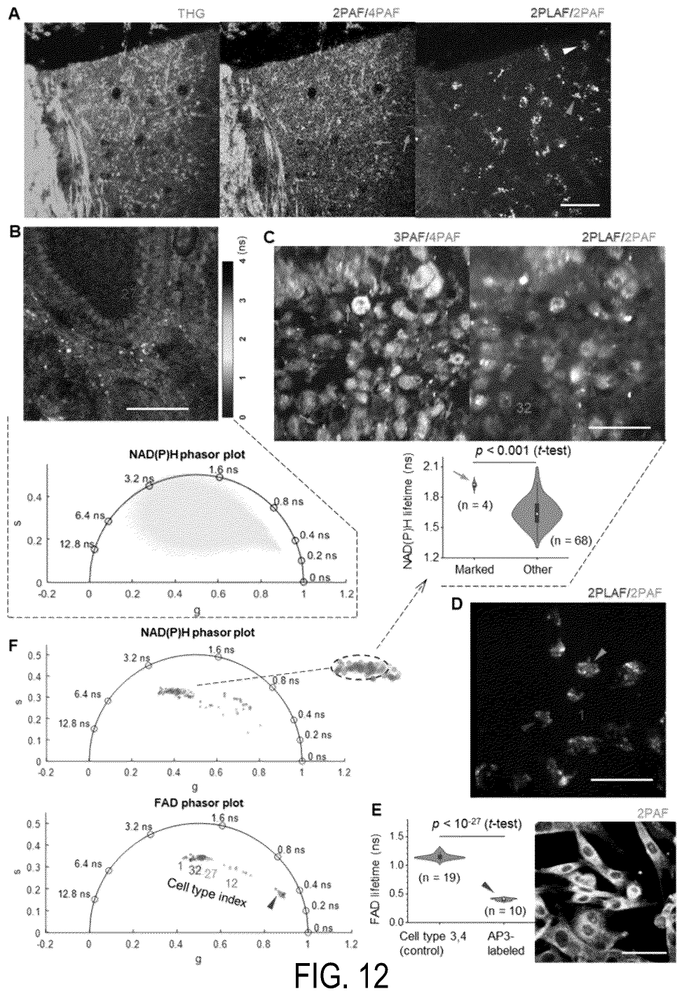

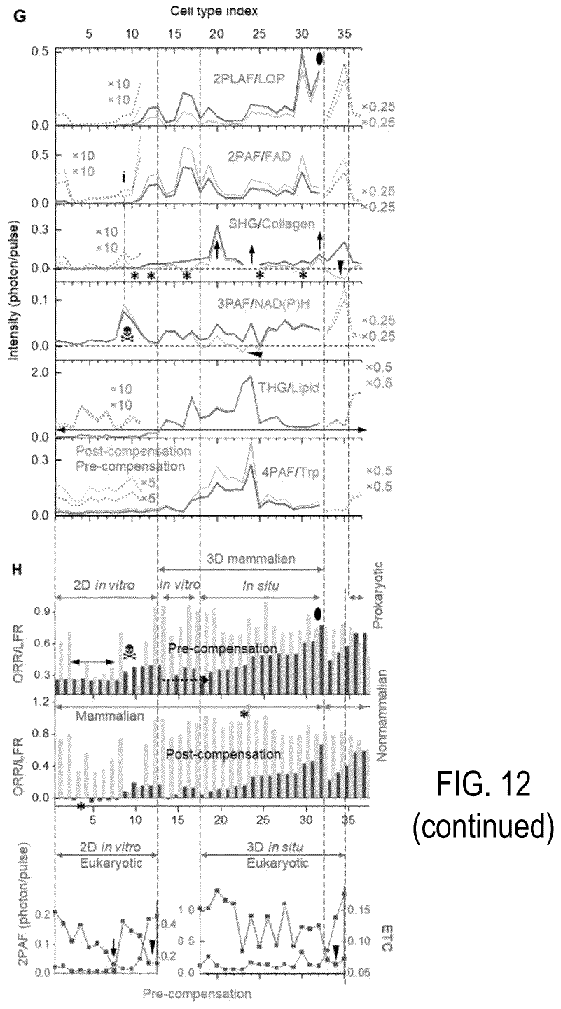

FIG. 12 illustrates the multiparametric imaging of single-cell metabolism. Image set (A) shows a real-time single-frame image (0.33 s per frame at 1 Hz) of rat brain slice showing 2PAF-visible neurons (arrows) and intracellular 2PAF/2PALF-compartmentation (arrowheads) not obvious in THG imaging where the somata appears as dark shadow (star) in a continuous phase of myelin. Image (B) is a FLIM image of a mouse intestinal niche (top) and is shown with a related NAD(P)H phasor distribution of full field-of-view without cell segmentation (bottom). Image set (C) shows a rabbit intestinal niche with distinct 2PLAF contrast (arrowhead) and 72 segmented immune cells, four of which (arrows) have a NAD(P)H-visible nucleus with significantly longer NAD(P)H fluorescence lifetime than the other cells (bottom). Image (D) shows single in vitro human breast cancer cells. Image (E) shows single in vitro AP3-labeled hamster kidney cells (right) with significantly shorter FAD fluorescence lifetime than unlabeled control (left). The scale bar in images (A)-(E) represents 50 m, and the numbers in the images specify cell types. Graph set (F) shows FAD and NADH phasor distributions of segmentations of the mouse intestinal epithelial cells (yellow dots, n=9; Cell type 27), the rabbit intestinal immune cells (red dots, n=72; Cell type 32), in vitro mouse neural stem cells (green dots, n=10; Cell type 12), the human breast cancer cells (blue dots, n=12; Cell type 1), and the in vitro AP3-labeled hamster kidney cells (purple dots, n=10). Inset are 72 segmented rabbit intestinal immune cells (oval) with seemingly converged phasor distributions (red dots) that allow intra-cell-type discrimination (arrow). Graph set (G) shows 6-color SOMI profiling of indexed cell types without (green curves) and with crosstalk compensation (orange curves) from segmented single cells or cell clusters in different fields-of-view/samples, with scaled weak/strong signals for clarity. Graph set (H) presents comparative plots of ORR versus LRR (top) and ETC versus 2PAF/FAD (bottom) for selected cell types, showing low dynamic-range dimensionless ORR, LFR, and ETC that contrast sharply with their high dynamic-range raw signals across 3 orders of magnitude.

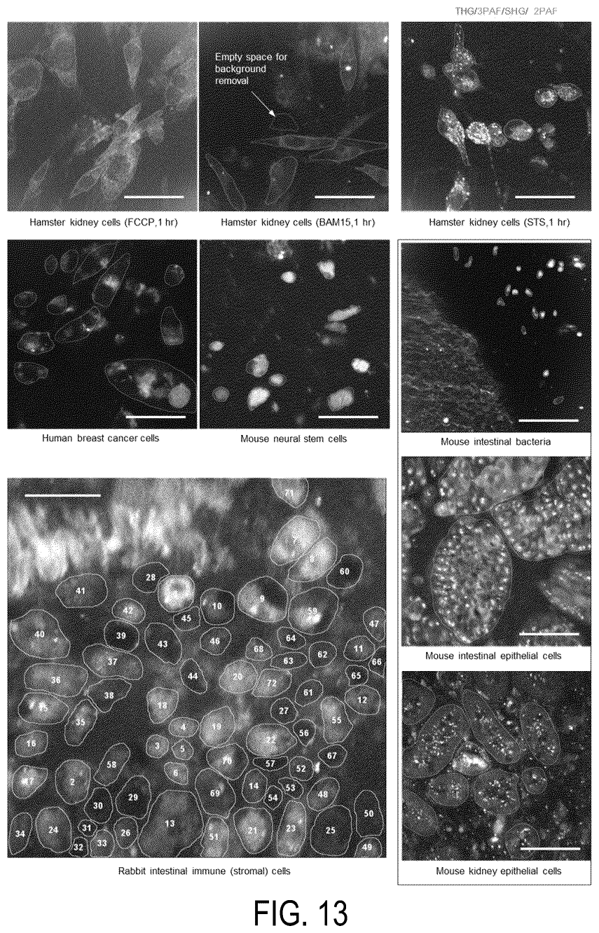

FIG. 13 illustrates an exemplary segmentation for single-cell SOMI profiling with customized colorization. The top images show segmentation of drug-treated and untreated in vitro cells where empty spaces among them are employed for background removal The bottom left image shows the segmenting and indexing of 72 immune cells in a niche of rabbit intestine. The bottom right images show the segmentation of bacteria and cell clusters in situ. The scale bar is 50 jam. Table 7 presents a quantification of segmented immune cells in a rabbit intestine niche by SOMI 6-color intensity profiles (in units of effective photons per excitation pulse) and fluorescence lifetimes (in units of ns). The cell labels in Table 7 correspond to the labels in FIG. 13, with additional cells listed.

TABLE 7

| Single cell | | | | | | | 3PAF | 2PAF |
|---|---|---|---|---|---|---|---|---|
| label | 4PAF | THG | 3PAF | SHG | 2PAF | 2PLAF | lifetime | lifetime |
| 1 | 0.110 | 0.829 | 0.080 | 0.096 | 0.177 | 0.479 | 1.58 | 1.33 |
| 2 | 0.060 | 0.468 | 0.038 | 0.063 | 0.110 | 0.390 | 1.51 | 1.33 |
| 3 | 0.085 | 0.647 | 0.051 | 0.110 | 0.112 | 0.426 | 1.58 | 1.32 |
| 4 | 0.072 | 0.561 | 0.049 | 0.168 | 0.135 | 0.487 | 1.54 | 1.31 |
| 5 | 0.086 | 0.702 | 0.044 | 0.109 | 0.107 | 0.397 | 1.61 | 1.36 |
| 6 | 0.090 | 0.706 | 0.048 | 0.073 | 0.119 | 0.495 | 1.64 | 1.31 |
| 7 | 0.096 | 0.719 | 0.083 | 0.088 | 0.176 | 0.483 | 1.64 | 1.29 |
| 8 | 0.095 | 0.697 | 0.073 | 0.108 | 0.170 | 0.523 | 1.73 | 1.33 |
| 9 | 0.067 | 0.519 | 0.049 | 0.084 | 0.127 | 0.393 | 1.58 | 1.35 |
| 10 | 0.065 | 0.555 | 0.034 | 0.075 | 0.087 | 0.198 | 1.59 | 1.36 |
| 11 | 0.067 | 0.480 | 0.041 | 0.083 | 0.097 | 0.213 | 1.53 | 1.33 |
| 12 | 0.091 | 0.721 | 0.035 | 0.211 | 0.094 | 0.226 | 1.59 | 1.35 |
| 13 | 0.064 | 0.511 | 0.036 | 0.062 | 0.091 | 0.268 | 1.64 | 1.33 |
| 14 | 0.077 | 0.570 | 0.037 | 0.065 | 0.086 | 0.203 | 1.64 | 1.34 |
| 15 | 0.049 | 0.444 | 0.027 | 0.130 | 0.162 | 0.760 | 1.44 | 1.35 |
| 16 | 0.050 | 0.444 | 0.028 | 0.079 | 0.141 | 0.563 | 1.43 | 1.32 |
| 17 | 0.057 | 0.499 | 0.032 | 0.068 | 0.180 | 0.757 | 1.35 | 1.33 |
| 18 | 0.068 | 0.598 | 0.037 | 0.181 | 0.164 | 0.644 | 1.54 | 1.35 |
| 19 | 0.059 | 0.535 | 0.025 | 0.194 | 0.204 | 0.928 | 1.58 | 1.34 |
| 20 | 0.088 | 0.770 | 0.040 | 0.316 | 0.177 | 0.577 | 1.46 | 1.37 |
| 21 | 0.064 | 0.493 | 0.039 | 0.066 | 0.129 | 0.726 | 1.60 | 1.43 |
| 22 | 0.070 | 0.503 | 0.048 | 0.107 | 0.150 | 0.577 | 1.61 | 1.32 |
| 23 | 0.088 | 0.626 | 0.050 | 0.067 | 0.119 | 0.569 | 1.60 | 1.38 |
| 24 | 0.058 | 0.495 | 0.031 | 0.061 | 0.099 | 0.480 | 1.53 | 1.34 |
| 25 | 0.040 | 0.285 | 0.033 | 0.056 | 0.062 | 0.165 | 1.92 | 1.30 |
| 26 | 0.039 | 0.289 | 0.036 | 0.062 | 0.082 | 0.346 | 1.93 | 1.34 |
| 27 | 0.037 | 0.271 | 0.031 | 0.239 | 0.083 | 0.217 | 1.89 | 1.35 |
| 28 | 0.033 | 0.263 | 0.031 | 0.132 | 0.091 | 0.191 | 1.95 | 1.34 |
| 29 | 0.038 | 0.304 | 0.021 | 0.061 | 0.074 | 0.193 | 1.62 | 1.32 |
| 30 | 0.034 | 0.274 | 0.019 | 0.057 | 0.073 | 0.205 | 1.78 | 1.33 |
| 31 | 0.036 | 0.297 | 0.021 | 0.056 | 0.071 | 0.218 | 1.80 | 1.35 |
| 32 | 0.038 | 0.324 | 0.017 | 0.053 | 0.070 | 0.213 | 1.50 | 1.28 |
| 33 | 0.075 | 0.575 | 0.042 | 0.060 | 0.088 | 0.326 | 1.58 | 1.33 |
| 34 | 0.046 | 0.375 | 0.029 | 0.055 | 0.084 | 0.348 | 1.67 | 1.31 |
| 35 | 0.048 | 0.409 | 0.028 | 0.085 | 0.128 | 0.452 | 1.45 | 1.33 |
| 36 | 0.044 | 0.479 | 0.022 | 0.514 | 0.142 | 0.531 | 1.52 | 1.32 |
| 37 | 0.052 | 0.427 | 0.034 | 0.158 | 0.119 | 0.438 | 1.65 | 1.32 |
| 38 | 0.038 | 0.325 | 0.024 | 0.138 | 0.100 | 0.355 | 1.77 | 1.32 |
| 39 | 0.033 | 0.276 | 0.023 | 0.074 | 0.078 | 0.207 | 1.77 | 1.34 |
| 40 | 0.049 | 0.476 | 0.028 | 0.115 | 0.145 | 0.596 | 1.47 | 1.34 |
| 41 | 0.044 | 0.410 | 0.026 | 0.143 | 0.122 | 0.384 | 1.50 | 1.34 |
| 42 | 0.056 | 0.434 | 0.047 | 0.072 | 0.119 | 0.539 | 1.56 | 1.35 |
| 43 | 0.037 | 0.319 | 0.024 | 0.097 | 0.094 | 0.271 | 1.70 | 1.35 |
| 44 | 0.048 | 0.389 | 0.027 | 0.176 | 0.099 | 0.240 | 1.72 | 1.32 |
| 45 | 0.045 | 0.388 | 0.033 | 0.062 | 0.084 | 0.228 | 1.70 | 1.38 |
| 46 | 0.061 | 0.491 | 0.035 | 0.087 | 0.098 | 0.266 | 1.66 | 1.37 |
| 47 | 0.086 | 0.648 | 0.042 | 0.065 | 0.093 | 0.246 | 1.63 | 1.34 |
| 48 | 0.085 | 0.641 | 0.038 | 0.068 | 0.087 | 0.249 | 1.53 | 1.38 |
| 49 | 0.079 | 0.537 | 0.046 | 0.057 | 0.081 | 0.193 | 1.51 | 1.29 |
| 50 | 0.044 | 0.287 | 0.027 | 0.060 | 0.068 | 0.149 | 1.70 | 1.34 |
| 51 | 0.075 | 0.572 | 0.046 | 0.065 | 0.129 | 0.733 | 1.59 | 1.38 |
| 52 | 0.051 | 0.351 | 0.032 | 0.078 | 0.095 | 0.247 | 1.81 | 1.32 |
| 53 | 0.040 | 0.315 | 0.024 | 0.068 | 0.085 | 0.259 | 1.68 | 1.32 |
| 54 | 0.040 | 0.302 | 0.022 | 0.061 | 0.077 | 0.210 | 1.83 | 1.36 |
| 55 | 0.066 | 0.520 | 0.036 | 0.215 | 0.143 | 0.524 | 1.62 | 1.31 |
| 56 | 0.040 | 0.303 | 0.024 | 0.235 | 0.094 | 0.251 | 1.88 | 1.28 |
| 57 | 0.030 | 0.202 | 0.024 | 0.070 | 0.075 | 0.164 | 2.05 | 1.28 |
| 58 | 0.062 | 0.505 | 0.032 | 0.074 | 0.083 | 0.278 | 1.59 | 1.32 |
| 59 | 0.056 | 0.409 | 0.039 | 0.076 | 0.137 | 0.533 | 1.68 | 1.35 |
| 60 | 0.043 | 0.334 | 0.025 | 0.100 | 0.085 | 0.198 | 1.70 | 1.33 |
| 61 | 0.047 | 0.331 | 0.034 | 0.152 | 0.093 | 0.260 | 1.95 | 1.33 |
| 62 | 0.046 | 0.329 | 0.032 | 0.135 | 0.095 | 0.238 | 1.92 | 1.31 |
| 63 | 0.056 | 0.434 | 0.032 | 0.160 | 0.100 | 0.253 | 1.75 | 1.38 |
| 64 | 0.051 | 0.409 | 0.029 | 0.071 | 0.090 | 0.267 | 1.69 | 1.40 |
| 65 | 0.041 | 0.318 | 0.022 | 0.153 | 0.085 | 0.200 | 1.50 | 1.30 |
| 66 | 0.043 | 0.303 | 0.026 | 0.110 | 0.087 | 0.201 | 1.75 | 1.35 |
| 67 | 0.041 | 0.318 | 0.022 | 0.079 | 0.089 | 0.243 | 1.78 | 1.30 |
| 68 | 0.085 | 0.733 | 0.031 | 0.161 | 0.124 | 0.302 | 1.61 | 1.33 |
| 69 | 0.047 | 0.354 | 0.025 | 0.063 | 0.106 | 0.438 | 1.76 | 1.32 |
| 70 | 0.070 | 0.531 | 0.036 | 0.074 | 0.127 | 0.415 | 1.60 | 1.32 |
| 71 | 0.082 | 0.705 | 0.057 | 0.115 | 0.155 | 0.414 | 1.63 | 1.32 |
| 72 | 0.058 | 0.464 | 0.041 | 0.224 | 0.139 | 0.587 | 1.73 | 1.34 |
| Mean (STD | 0.058 (33%) | 0.463 (32%) | 0.035 (37%) | 0.111 (66%) | 0.110 (30%) | 0.371 (48%) | 1.65 (8%) | 1.33 (2%) |
| in %) | | | | | | | | |

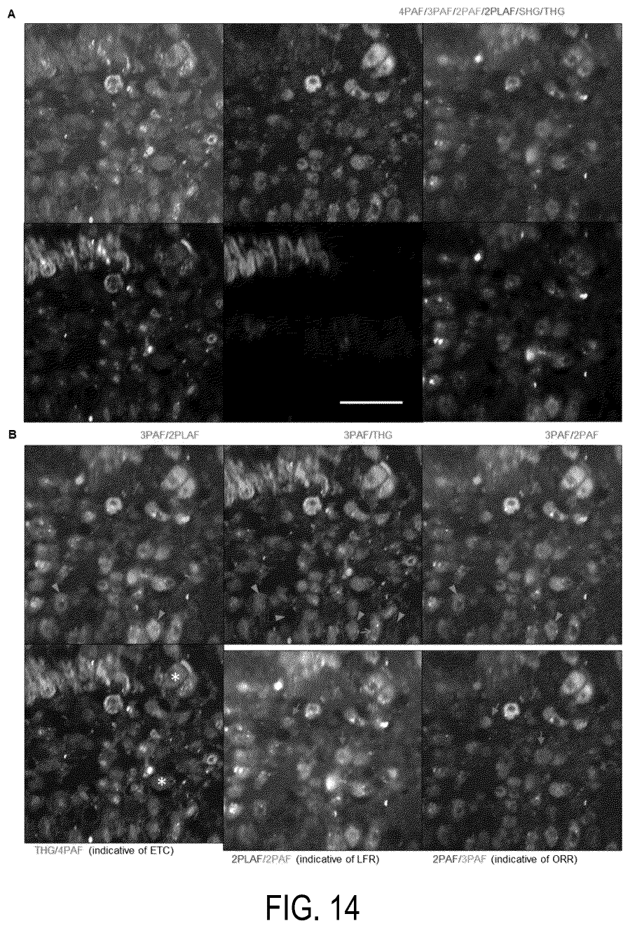

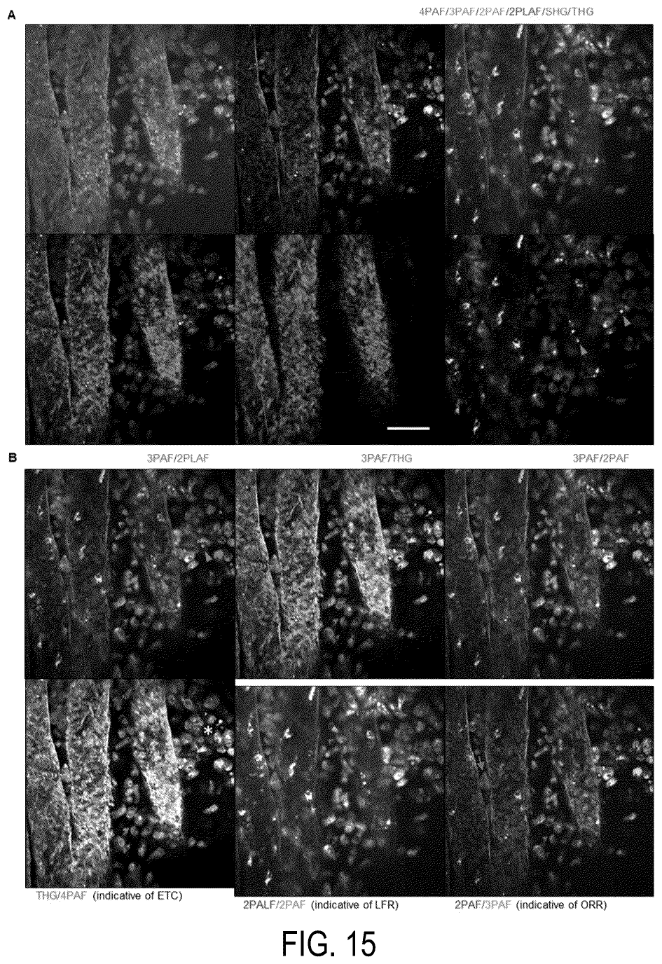

FIG. 14 shows diverse immune cells in ex vivo rabbit small intestine. Co-registered 6-color SOMI images are obtained from one niche (top) while selective dual-color visualizations (bottom) reveal 4 cell subtypes (i: 3PAF-visible cytoplasm and 4PAF/THG-visible nucleus with overall low 2PLAF; ii: 3PAF-visible cytoplasm and 4PIF/THG-visible nucleus with overall high 2PLAF; iii: 4PAF/THG-visible nuclear/cytoplasmic membrane; and iv: 3PAF-visible nucleus), cellular THG-4PAF intensity correlation with a gray-like hue (stars), and high-LFR low-ORR cell (green arrows) versus low-LFR high-ORR cell (magenta arrows). FIG. 15 shows a neighboring intestinal niche with villi near epithelium. Co-registered 6-color SOMI images (top) show immune or stromal cells with few bacteria (arrowheads) due to the antimicrobial peptides secreted by villi (magenta lines), while selective dual-color visualizations (bottom) reveal the THG-4PAF intensity correlation of the immune or stromal cells (star) with a gray-like hue and high-LFR low-ORR cell (green arrow) versus low-LFR high-ORR cell (magenta arrow).

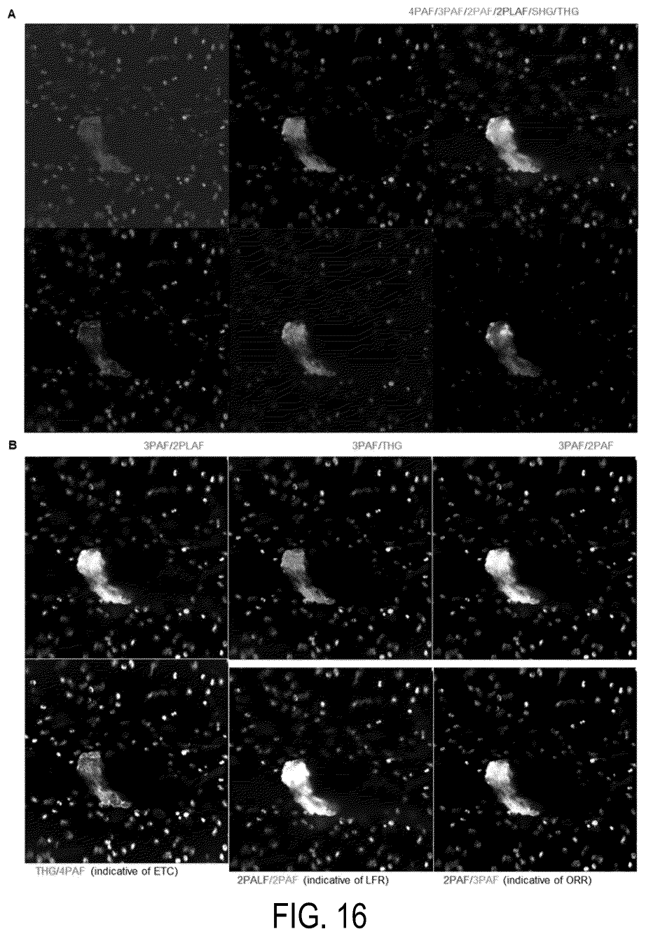

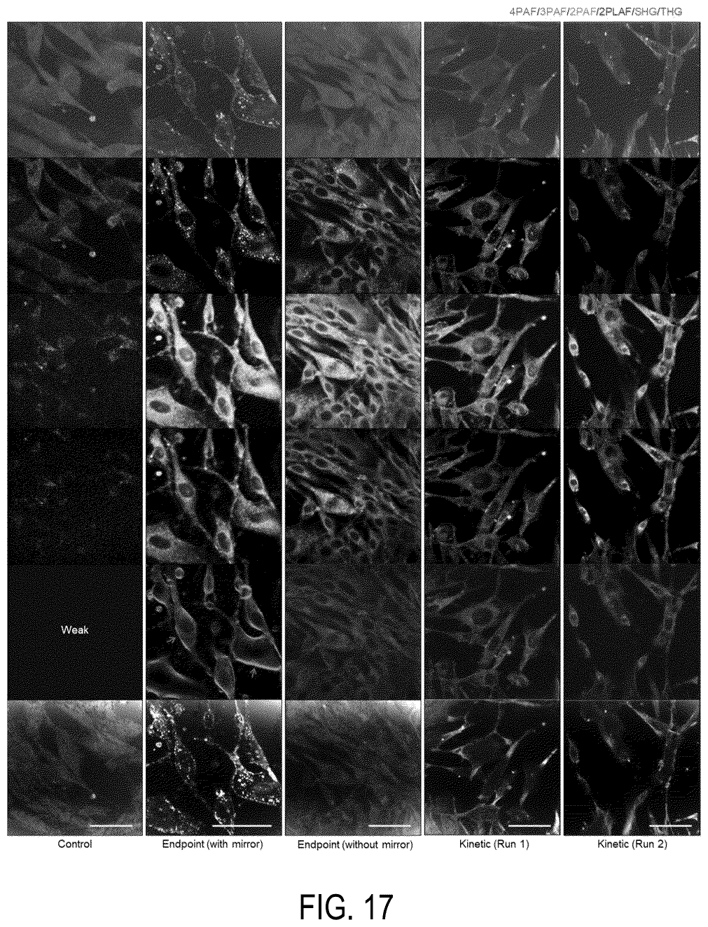

FIG. 16 shows a neighboring intestinal niche in mucus with abundant bacteria. Selective dual-color visualizations (bottom) highlight differences in single bacteria not obvious from single-color visualizations. FIG. 17 shows a comparison between endpoint and kinetic assays of AP3-labeled hamster kidney cells. In contrast to the control, both endpoint (6 hours after AP3 exposure) and kinetic assays (3 minutes after AP3 exposure) produce stronger 3PAF, 2PAF, and 2PLAF but not 4PAF. Note that the nucleolus after AP3 exposure may only be detectable by 4PAF among all colors (arrowheads), while an external reflective mirror is needed to observe the SHG signal of AP3 that labels cell membrane (arrows). The scale bar in FIGS. 14-17 represents 50 km.

To complement the fluorescence lifetime data, a 6-color SOMI intensity profile was generated for diverse cell types from segmented living single cells or cell clusters with or without the photon crosstalk matrix-based compensation. Despite some sample-dependent artifacts, this compensation is validated by the cleared SHG signals in collagen-free cells to differentiate from cells with co-localized collagen likely due to live sample movement. The small or positive compensation-induced intensity changes in 4PAF, 3PAF, and 2PAF but not 2PLAF largely ensures the correctness of Trp, NAD(P)H, and FAD fluorescence lifetimes with no crosstalk compensation. The bright NAD(P)H* of in vitro apoptotic cells induced by staurosporine (STS) may detect the apoptosis of mammalian (but not nonmammalian) cells in vivo. The obvious 2PAF-2PLAF correlation reflects localized FAD and LOP respectively in mitochondria and lysosomes in situ not obvious in vitro, with a noticeable anomaly that indicates the distinct LOP versus FAD distribution at the highest LFR. Another noticeable correlation exists between 4PAF and THG with overlapping imaging contrast, leading to a 4PAF/THG ratiometric of effective Trp concentration (ETC). This definition originates from the increased Trp* (4PAF) with microenvironmental hydrophobicity assumed to be proportional to lipid content (THG).

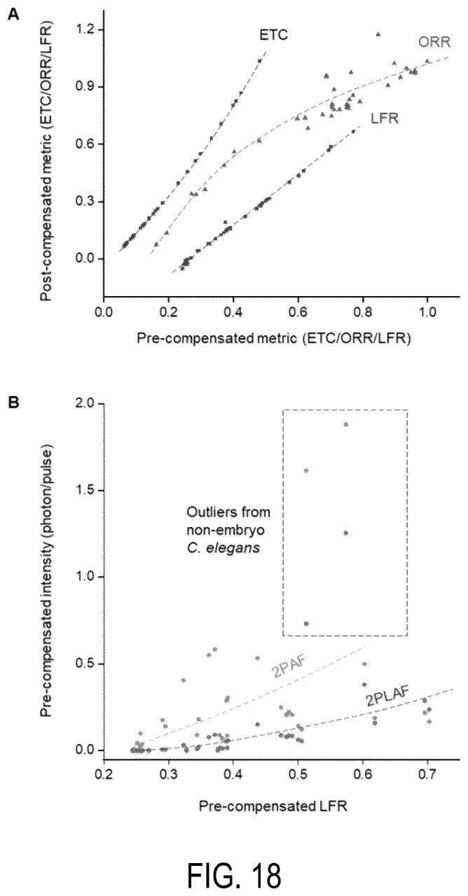

Quantitative insights can be broadly gained. First, THG is more sensitive than AF to convert incident photons into signal photons, with a much higher efficiency in 3D in situ or in vitro cells (˜1×10⁻¹⁰) than 2D in vitro cells. This implies that reproducibly cultured cells gain immortality by a mutation to limit lipid production (e.g. immortal hamster kidney cells/fibroblasts and mortal/primary mouse fibroblasts differ in THG by ˜50-fold). Second, for 3D mammalian cells, AF manifests as the plateau of one narrowband THG peak (˜10 nm) with a comparable integrated magnitude of ˜1 photon/pulse. However, it is spread across 340-740 nm rich in molecular information. Third, under the single-band excitation, increasing ORR (or LFR) is monotonically correlated with the blue-to-yellow (or yellow-to-red) redshift of raw AF without the crosstalk compensation. FIG. 18 shows quantitative relations among 37 cell types under study (dots). Monotonic relations between pre- and post-compensated metrics (top) along with weak correlations between pre-compensated 2PLAF/2PAF intensity and LFR (bottom) are shown. Pre-compensated ORR, LFR, and ETC were thus adopted to avoid plausible artifacts while recovering the LFR-ORR decorrelation. The combination of these dimensionless metrics with a 5-color (SHG-less) SOMI profile constitutes a comprehensive 8-parameter metabolic profile to characterize a specific cell type. Fourth, reliable ORR measurements are validated by the near-unity values from in situ neurons (ORR 0.99) and in vitro neural stem cells (ORR 0.95) known to have high metabolic oxidation, highlighting the strikingly high organismal metabolic oxidation of a morula-stage bovine embryo (ORR 0.92).

In the above analysis, for a given fluorophore, it was first considered whether it is advantageous to conduct imaging over 4PAF or over 3PAF/2PAF/2PLAF under a common constraint of phototoxicity. Without loss of generality, fluorescein is chosen in the supporting simulation due to its known four-, three-, and two-photon action cross sections required for calculating the time-averaged fluorescence signal S according to the following Equation (1).

$${S}^{( n )} ∝ {g}^{( n )} {a}^{( n )} μ {σ}^{( n )} \frac{{( NA )}^{n 2 - 4}}{n ( {π}^{3 - n} {λ}^{2 n - 3}} \frac{1}{{( f τ )}^{n - 1}} {( \frac{P}{hc / λ} )}^{n} \qquad ( 1 )$$

In Equation (1), n is the photon order of excitation, g⁽ⁿ⁾ is the n^{th}-order temporal coherence of the excitation source (assuming Gaussian temporal profile, g⁽⁴⁾, g⁽³⁾, and g⁽²⁾ are 0.415, 0.510, and 0.664, respectively), a⁽ⁿ⁾ is an n-dependent constant (a⁽⁴⁾, a⁽³⁾, and a⁽²⁾ are 18.3, 28.1, and 64, respectively), μσ⁽ⁿ⁾ is the multiphoton action cross section of fluorescein (μσ⁽⁴⁾, μσ⁽³⁾, and μσ⁽²⁾ are 1.05×10⁻¹¹⁵ cm⁸ (s/photon)³ at 1680 nm, 1.63×10⁻⁸³ cm⁶ (s/photon)² at 1300 nm, and 3.28×10⁴⁹ cm² (s/photon) at 800 nm, respectively), NA is the numerical aperture of the microscope objective (1.15 in this example), λ is the central wavelength of excitation, f is Planck's constant (6.63×10³⁴ J·s), and c is the speed of light in vacuum (3×10⁸ m/s). Using these parameters at a constant P of 15 mW (i.e., the onset of linear absorption-mediated phototoxicity from intrinsic photosensitizers across a broad spectrum of near-infrared excitation, signal intensity at a given n can be calculated according to two representative excitation sources, as shown in Table 8.

TABLE 8

| | Low peak-power source | High peak-power source |
|---|---|---|
| | f = 80 MHz, τ = 170 fs (sech) | f = 5 MHz, τ = 34 fs (sech) |
| Signal | or 300 fs (FWHM) | or 60 fs (FWHM) |
| n = 2, λ = 800 nm | 8.6 | 6.9 × 10² |
| n = 3, λ = 1300 nm | 1.6 × 10⁻⁴ | 1 (baseline) |
| n = 4, λ = 1680 nm | 3.1 × 10⁻⁷ | 0.16 |

From this simulation, it becomes clear that a shift from low peak-power to high peak-power excitation is broadly beneficial (regardless of the photon order) if high f (i.e. high-speed laser point-scanning imaging) is not required, e.g. for imaging of intrinsic rather than extrinsic fluorophores. This highlights the unmet need to develop a widely tunable (700-1700 nm) high peak-power source for multiphoton microscopy. Also, it may be beneficial to use a low photon-order excitation when deep imaging (or signal-to-background ratio) is not required (or important) while the excitation of fluorophores other than fluorescein must be minimized (reductionism-based imaging). Surprisingly, 4PF imaging attains a comparable (16%) signal in comparison to 3PF imaging under the high peak-power excitation but not the low peak-power excitation. Because the order of magnitude for multiphoton cross section is rather consistent according to the single-intermediate state approximation, the conclusions from fluorescein are applicable to Trp excited by 2PAF at 590 nm, by 3PAF at 740 nm, and 4PAF at 1110 nm. Specifically, by abandoning the reductionism-based imaging strategy at the cost of a lower Trp signal than that available from 2PAF, the 4PAF high peak-power imaging at 1110 nm attains a comparable Trp signal to its 3PF counterpart at 740 nm but gains a systems biology benefit to simultaneously image NAD(P)H/FAD/LOP by 3PAF/2PAF/2PLAF and generate comparable signals across diverse samples. The otherwise strong 2PAF/FAD fluorescence excited at the optimal wavelength of 900 nm is attenuated by the highly detuned excitation at 1110 nm and does not obscure the LOP signal. In summary, the systems biology-inspired SOMI takes advantage of the high peak-power excitation source to produce a supercontinuum signal (340-740 nm) quantitatively informative of a maximized number of ubiquitous intrinsic biomolecules, rather than pursue its benefit of deep tissue labeled or label-free imaging. This biological supercontinuum generation is impossible using the low peak-power excitation source, which shows much larger differences in signal generation efficiency among different photon orders.

To put the above conclusion in a broad context, it is noted that focusing picosecond-femtosecond optical pulses on a nonlinear medium generates supercontinuum signal highly blue-shifted from the incident wavelength or band. This observation raises the interesting possibility of spectroscopic biopsy if the often-studied transparent bulk gases/solids were replaced with living biological samples as the nonlinear media. However, the generated supercontinuum signals of plasma luminescence typically from picosecond irradiation and white-light filamentation typically from loose femtosecond focusing were accompanied by optical breakdown (phototoxicity), which was instead harnessed for precision surgery and micromachining via tight femtosecond focusing. A lowered irradiance on the biological samples, intended for high resolution label-free multiphoton imaging, suppressed this supercontinuum generation around the near-infrared incident band but often induced new molecules (phototoxicity) emitting supercontinuum-like (blue-to-red) fluorescence, known as hyper-fluorescence. Thus, observed biological supercontinuum signals have been associated with various forms of phototoxicity detrimental to sample health. It is thus a significant finding that living samples can tolerate rather high irradiance up to one-half of water optical breakdown before the onset of phototoxicity, if successive illumination pulses are spatially separated by ˜1 diffraction-limited resolution. Within this window of illumination, biological supercontinuum signals are gently generated by combining the photon order super-multiplexed imaging with common photon order multicolor imaging with large Stokes shift. From this perspective, SOMI is a technological advance over its precursor of SLAM microscopy.

In contrast to reductionism-based fluorescence imaging, the systems biology-based imaging with biological supercontinuum generation overcomes a challenge to quantify the fluorophores in the minimum model of animal cell with highly overlapped emission spectra. This challenge may have contributed to the low popularity of comparative systems biology-based imaging strategies. To overcome it, 4PAF detection was calibrated using 50 mM Trp solution in HEPES, 3PAF detection using 10 mM NADH solution in HEPES, and 2PAF detection using 50 mM FAD solution in HEPES. These solutions were prepared using Trp (>98.0% HPLC, Sigma), NADH (Grade I, Sigma) and FAD (94% dry wt., ThermoFisher Scientific) dissolved in a 1 M HEPES buffer with stabilized pH. To calibrate SHG detection with no spectral overlapping with other colors, any solution of an arbitrary fluorophore could be used if sufficient signal would be generated in the detection color (channel) of SHG. Acridine orange dissolved in sterile water at 1 mg/mL was prepared for this purpose. Also, to calibrate THG detection with no spectral overlapping with other colors, the interface of a coverslip was used. Finally, to calibrate 2PLAF detection, titanyl phthalocyanine dissolved in DMSO at 0.01 mg/mL was prepared, to mimic an LOP solution, because LOP remains poorly characterized and commercially unavailable.

Power-dependent “imaging” experiments were conducted on the prepared solutions and coverslip across the six colors by an excitation that would be standardized for biological imaging. These experiments not only established the linear relation between the arbitrary intensity value of a pixel and the effectively detected photons in that pixel within each color, but also revealed the bleed-through (crosstalk) across colors in the form of 6×6 photon crosstalk matrix by the simultaneous signal acquisition of SOMI. For the 6-color SOMI images (1024×1024 pixels) collected from a biological sample, the raw intensity image of each color was converted into a photon-count image (unit: photon/pulse) using the established (calibrated) relation for that color at the same photomultiplier gain. Then, some (2-72) discernable single cells or cell clusters were manually segmented in the 6-color photon-count images. Finally, the SOMI intensity profiles of segmented single cells (or cell clusters) averaged over the corresponding pixels were obtained after a background subtraction. Specifically, the background of the culture medium in the empty space among the segmented cells was subtracted for 2D cell culture samples while the background with blocked illumination was subtracted for all 3D (tissue) samples. Note that the demonstrated photon-resolved analog detection has a much higher dynamic range (>4 photons/pulse) than the photon counting of SLAM microscopy often used in fluorescence lifetime imaging microscopy (FLIM), which is typically limited to <0.2 photon/pulse to avoid detection artifacts.

For the optional crosstalk compensation, the photon crosstalk matrix was normalized by the total applied load in each color to derive the transfer matrix K:

$$\begin{matrix}0.5787 & 0.0244 & 0 & 0 & 0 & 0 \\ 0.3079 & 0.9756 & 0 & 0 & 0 & 0 \\ 0.1134 & 0 & 0.7849 & 0 & 0 & 0 \\ 0 & 0 & 0.0565 & 1 & 0.135 & 0 \\ 0 & 0 & 0.106 & 0 & 0.6426 & 0 \\ 0 & 0 & 0.0526 & 0 & 0.2224 & 1\end{matrix}$$

Applying the inverse of K (K⁻¹) to the 6-color SOMI photon-count profile of each cell type from the corresponding segmented cells, the crosstalk-compensated 6-color SOMI photon profiles were obtained for all cell types. It should be noted that this crosstalk compensation is imperfect due to the oversimplification of the 6-metabolite minimum model of animal cell and the uncertainty of LOP as a single chemical species. However, the robustness of FLIM and dimensionless metrics (ORR, LFR, and ETC) against this compensation can be demonstrated.

In contrast to reductionism-based imaging, the lack of FLIM capability for general fluorescence imaging presented another challenge that may have contributed to the low popularity of comparative systems biology-based imaging strategies. Due to the high dynamic range of SOMI in gentle biological imaging, comparative photon counting of FLIM with low dynamic range (<0.2 photon/pulse, typically) cannot be used. To recover this capability, time-resolved photon counts were determined using computational photon counting, which provides single-photon accuracy for signals with high dynamic range. The output of three analog output photomultipliers for 4PAF, 3PAF, and 2PAF was optionally amplified with a high-speed transimpedance amplifier (C5594, Hamamatsu), and digitized at 2 GS/s with a high-speed digitizer (ATS9373, AlazarTech). Digitized values were saved, and photon-counting and lifetime information was computed in post-processing using custom MATLAB scripts (Mathworks). FLIM for the 2PAF and 3PAF colors were validated using NADH, FAD, and other standard dyes. To calibrate computational photon counting for 4PAF, Trp solutions from 0 to 50 mM were examined and a single-photon peak threshold was determined based on the peak height histogram to ensure a linear relationship between intensity and concentration over this range. After computational photon counting, mean fluorescence lifetime and phasor components g and s were determined by phasor analysis. For single-cell quantification, all fluorescence decays within a segmented cell were summed together, and one mean fluorescence lifetime was estimated from the total decay, along with one g and one s value.

In contrast to fluorescently labeled (reductionism-based) imaging, the intrinsically low signal-to-noise ratio in label-free fluorescence imaging often prohibits real-time imaging and therefore presented a third challenge that may have contributed to the low popularity of comparative systems biology-based imaging strategies. Typically, the multiphoton action cross section of an intrinsic fluorophore is three orders of magnitude lower than that of an extrinsic fluorophore. To mitigate the low signal-to-noise ratio, deep learning-based self-supervised movie denoising techniques were utilized as a data-driven approach to recover faithful signals from degraded recordings and reduce the photon budget of imaging. Three self-supervised denoising models, known as UDVD, Noise2Void, and DeepCAD-RT, were implemented and compared. The models were trained separately for the individual colors of real-time SOMI frames (1024×1024 pixels at 0.75 Hz up to −3 Hz). After training, each color was denoised by the corresponding models. Both 2D and 3D Noise2Void models were implemented. When using 2D Noise2Void, the model was trained on individual frames. While for 3D Noise2Void, frames were treated together as 3D cubes, with the time axis serving as the third dimension. The same patch size (128×128 pixels) was used for all models, all of which were trained for 100 epochs. A workstation computer, equipped with a central processing unit (CPU) (Xeon W-2195, Intel), four graphics processing units (GPUs) (RTX 8000, Nvidia), and 256 gigabytes of memory, was employed for the training and prediction of self-supervised movie denoising models.

Peak signal-to-noise ratio (PSNR), structural similarity index measure (SSIM), and signal-to-noise ratio (SNR) metrics were calculated to evaluate the denoising performance. Since the high-SNR ground truth frames were infeasible to acquire in this example, PSNR and SSIM were computed within manually selected regions of the frames where minimal object movements were observed. The noise-free ground truth was approximated by averaging all frames within the cropped movie cube. Utilizing both the ground truth and individual frames from the original or denoised movies, the PSNR scores were calculated according to the following Equation (2).

$$PSNR = 10 \times {log}_{10} \frac{{L}^{2}}{MSE} \qquad ( 2 )$$

In Equation (2), L is the pixel value range of the noise-free ground truth and MSE is the mean squared error between the frame and the ground truth. The SSIM index was calculated using a sliding window (7×7 pixels) in ground truth (x) and the selected frame (y) using the following Equation (3).

$$SSIM = \frac{( 2 {μ}_{x} {μ}_{y} + {c}_{1} ) ( 2 {σ}_{xy} + {c}_{2} )}{( {μ}_{x}^{2} + {μ}_{y}^{2} + {c}_{1} ) ( {σ}_{x}^{2} + {σ}_{y}^{2} + {c}_{2} )} \qquad ( 3 )$$

In Equation (3), μₓ and μ_{y} are mean pixel values in sliding window x and y, respectively; σ_{z}² and σ_{y}² are the variances of pixel values in x and y; and oxy is the cross-correlation of x and y. The parameters c₁ and c₂ were calculated as (k₁L)² and (k₂L)², where k₁ and k₂ were set to 0.01 and 0.03, respectively. PSNR and SSIM scores were calculated on each frame of the cropped movie cube before and after denoising.

To quantify the noise level across the entire movie in the absence of a noise-free ground truth, an alternative definition of SNR was employed, which is the reciprocal of the coefficient of variation. This is given by the following Equation (4), where μ and σ are the mean pixel value and standard deviation of the pixel value, respectively.

$$SNR = \frac{μ}{σ} \qquad ( 4 )$$

The self-supervised movie denoising models, particularly UDVD, significantly improve the performance of real-time SOMI. In sharp contrast to their fully supervised counterparts, no pairs of training samples with identical faithful signals are needed. In other words, the demonstrated “blind-spot” approaches depend only on the noisy data itself. The self-supervised frameworks can achieve comparable performance with supervised approaches, despite not having access to ground truth clean data during training. In-line deep learning may be used to greatly improve the real-time search of a region of interest in biology, such as 3D targeted patching in neuroscience.

After the multiparametric profiling described above, it was next sought to compare organismal metabolism within one FOV in situ (i.e. in pseudo-native microenvironment free of perturbative sample preparation). Because the metabolic rate of C. elegans would be insensitive to the oxygen level of culturing and imaging conditions, the embryo-to-larva development revealed a robust ontogenetic trend of increasing ORR. Just like using extant C. elegans worms to study the anaerobic metabolism of their triploblastic ancestor, extant intestinal bacteria under chemically maintained hypoxia was used to study the extremely anaerobic metabolism of their prokaryotic ancestor. Interestingly, perceived prokaryote-to-eukaryote evolution revealed a phylogenetic trend of increasing ORR that mirrored the ontogenetic trend. Recurrently, this parallel between ontogeny and phylogeny remained valid when three sequential preimplantation stages of in vitro bovine embryo development recapitulated the increasing organismal metabolic oxidation from bacteria to a C. elegans embryos and finally to bovine morula-stage embryos. Also, upregulated lipid droplet production (elevated THG) occurred between the ˜16-cell stage (not the early 2.5-cell stage) and morula stage under near constant ETC, recapitulating the similar C. elegans development.

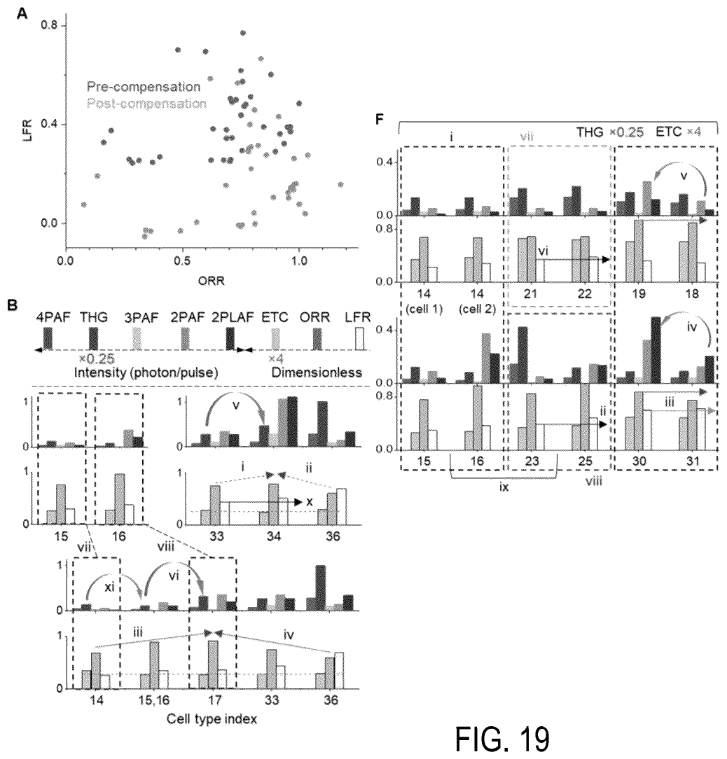

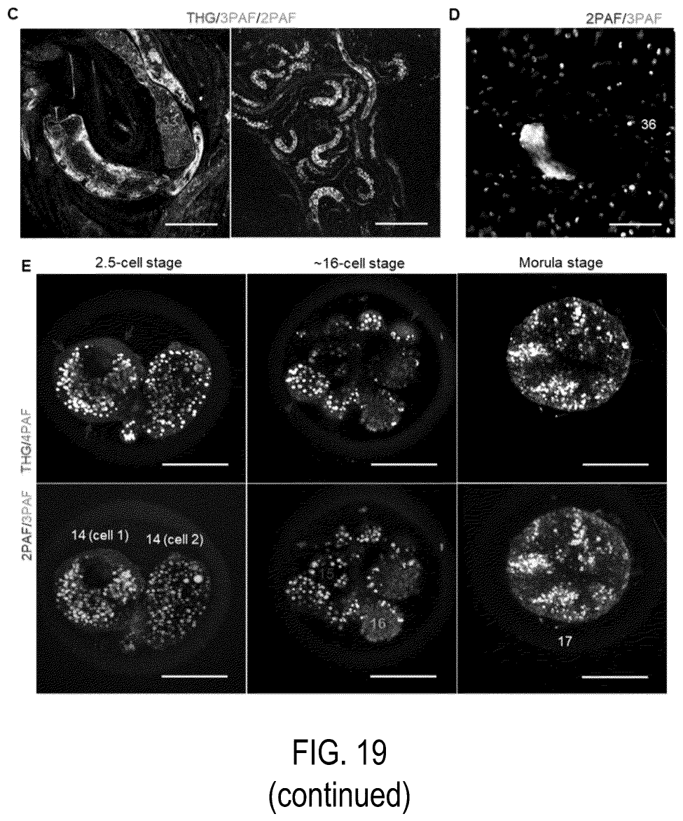

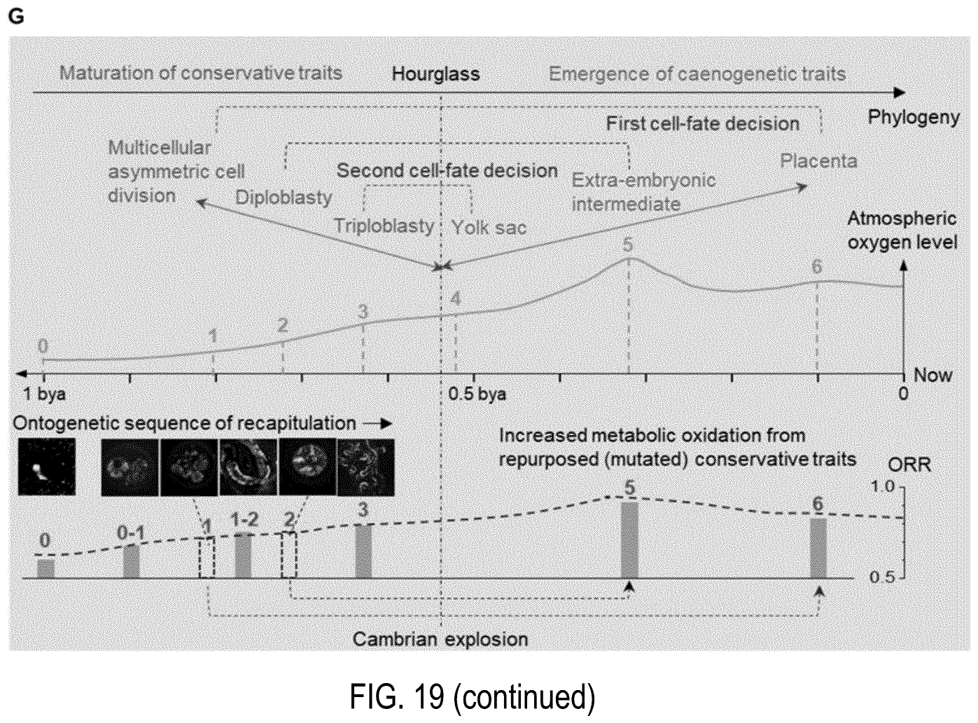

FIG. 19 illustrates metabolic oxidation in the context of metabolic noises. In all images of FIG. 19, the scale bar represents 50 μm and numbers in images specify cell types. Graph (A) of FIG. 19 shows a minimal correlation between LFR and ORR before and after crosstalk compensation for 37 investigated cell types. Graph set (b) presents a comparison of 8-parameter metabolic profiles for indexed cell types related to embryogenesis. Despite large “noise” from 5-color intensity profiles, ETC remains rather constant (broken lines) to ensure reliable comparation among different cell types and species. Image set (C) shows single-frame images of C. elegans embryos (Cell type 33) in the germline part of a freely moving adult and multiple freely moving C. elegans larva (right). Segmentations are performed on cell clusters or single organisms rather than single cells. Image (D) shows bacteria in a rabbit intestinal niche. Image set (E) of FIG. 19 shows bovine embryos at 2.5-cell, ˜16-cell, and morula stages showing either uniform intracellular distribution of 4PAF (arrows) or apical polarity cap (arrowheads), and the clean separation of high-ORR inner cell mass-fated cells (Cell type 16) from low-ORR trophectoderm-fated cells (Cell type 15) at the ˜16-cell stage only. Graph set (F) presents a comparison of 8-parameter metabolic profiles for indexed cell types in redox biology. Graph set (G) shows the alignment of 6 observed ORR levels in embryogenesis (yellow bars) with geological history of atmospheric oxygen levels 0-6 (solid curve) by a reformulated biogenetic law.

To further understand bovine embryogenesis, the three stages were classified into one category with one SOMI-resolvable cell type (2.5-cell, morula) and another category with two SOMI-resolvable cell types (˜16-cell), which can be quantitatively deduced. For the latter, the observable blastomeres or embryonic stem cells are cleanly divided into three 2PAF-visible cells with an 8-parameter metabolic profile approximating that of the morula-stage cell type and six 4PAF/3PAF-visible cells with an 8-parameter profile approximating that of the 2.5-cell-stage cell type. In contrast to the rather even cellular distribution of 4PAF versus THG at the 2.5-cell stage, the corresponding uneven distribution in the 4PAF-visible cells marks the emergence of symmetry-breaking apical polarity cap, which has only been detected by clinically impermissible fluorescently labeled imaging or deep learning-trained label-free imaging. Without the 4PAF (Trp) contrast, the apical polarity cap would be undetectable. Importantly, the label-free markers of the present disclosure place the first cell-fate decision between 4PAF-visible trophectoderm lineage (fate) toward placenta and 2PAF-visible inner cell mass toward embryo proper at a cleavage stage, which is earlier than the reported morula or compaction stage with an inter-blastomere angle above 1200.

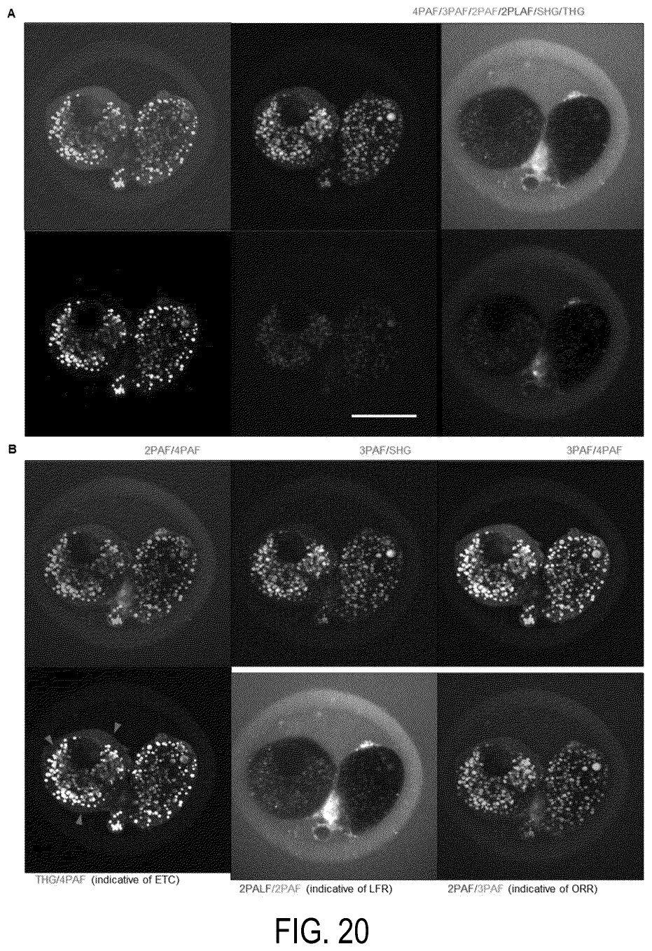

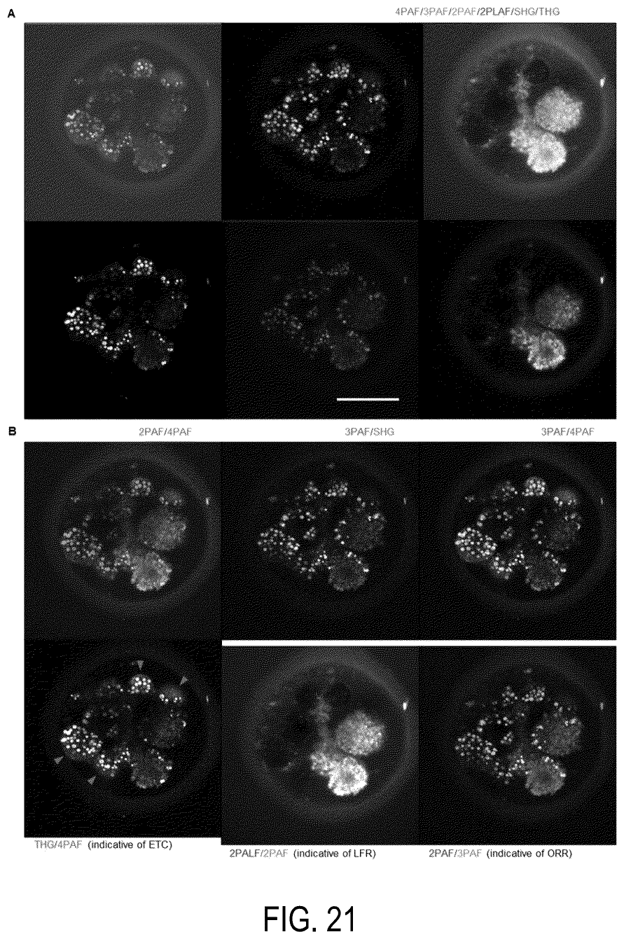

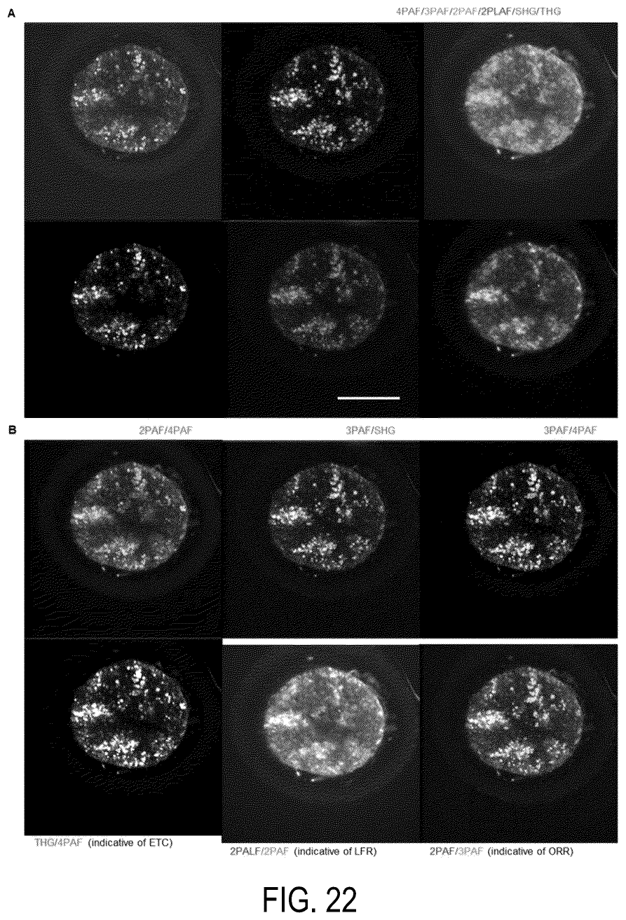

FIGS. 20-22 show the bovine embryo in more detail. In particular, FIG. 20 shows the embryo at the 2.5 cell stage, FIG. 21 shows the embryo at the 16 cell stage, and FIG. 22 shows the embryo at the morula stage. The scale bar in the images is 50 μm. In FIG. 20, selective dual-color visualizations reveal orthogonal 2PAF vs. 4PAF contrasts and non-polarized intracellular 4PAF distribution (arrowheads) with no apical polarity cap. In FIG. 21, selective dual-color visualizations reveal orthogonal 2PAF vs. 4PAF contrasts and apical polarity cap with a polarized intracellular 4PAF distribution (arrowheads). In FIG. 22, selective dual-color visualizations (bottom) reveal common trends from 2.5-cell stage to ˜16-cell stages and then to the morula stage not obvious from single-color visualizations (top).

This evidence may be used for a reformulation of often discredited Haeckel's recapitulation theory based on the developmental hourglass model and two earliest cell-fate decisions of mammalian development. Following Haeckel's basic concepts, the stage (bottleneck of the hourglass) associated with Cambrian explosion at 0.535 billion years ago (bya) was used to delineate the evolution from conservative to caenogenetic traits. The alignment between the two produces heterochrony that may obscure the sequence of phylogenetic embryology. The bottleneck of the hourglass forms a blueprint in which each late caenogenetic trait originates from a repurposed early conservative counterpart, e.g. placenta originates from repurposed multicellular asymmetric cell division for the first cell-fate decision between inner cell mass and trophectoderm. In this way, developing advanced species recapitulate a series of embryonic structural-metabolic stages of more primitive species without the controversies from adult traits, while the recapitulation and increased metabolic oxidation from repurposed conservative traits predict 6 sampled ORR levels by the geological history of oxygenation with a high statistical significance of p=0.0014. As an implication, the emergence of placental mammals from their closest ancestors was driven by the sustained high oxygenation around 0.1 bya, giving rise to a high-ORR mutant at a cleavage stage before the morula stage. Consistently, this high-ORR mutant is accompanied by decreased lipid synthesis from 2.5-cell to ˜16-cell stage typically associated with increased oxidative phosphorylation.

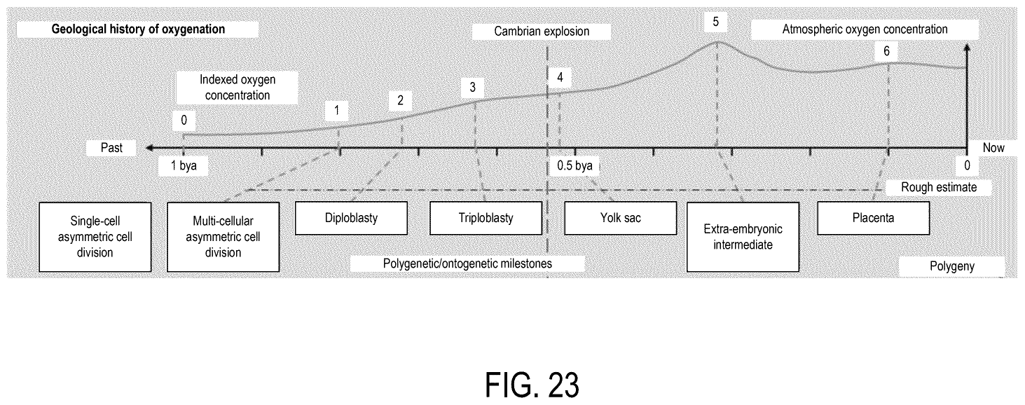

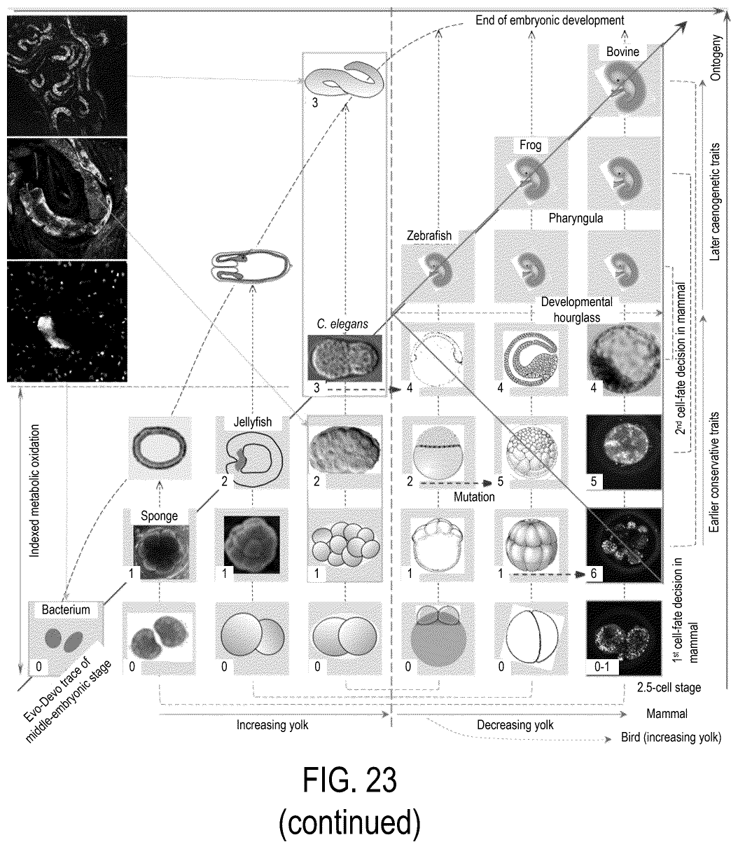

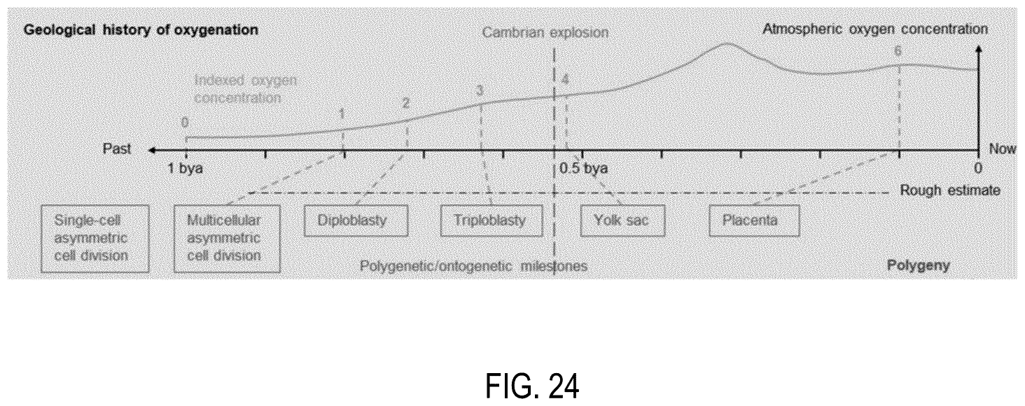

FIG. 23 shows a reformulation of Haeckel's biogenetic law with paralleled polygeny and ontogeny. As a bovine embryo develops, it sequentially recapitulates the middle-embryonic stage of sponge with multicellular asymmetric cell division, the middle-embryonic stage of jellyfish with diploblastic structure, the middle-embryonic stage of C. elegans with triploblastic structure, the middle-embryonic stage of zebrafish with yolk sac, the middle-embryonic stage of frog with extra-embryonic intermediate between yolk sac and placenta, and the middle-embryonic stage of bovine with placenta (solid red arrow). Assuming a developmental hourglass (green triangle) that couples early conservative traits (multicellular asymmetric cell division, diploblasty, and triploblasty) with later caenogenetic traits (yolk sac, extra-embryonic intermediate, and placenta), i.e. three mutations of increased metabolic oxidation to repurpose conservative traits (broken red arrows), the measured states of metabolic oxidation via ORR (cyan lined boxes) agree with the prediction from the geological history of oxygenation (yellow/magenta numbers). This developmental hourglass is further supported by the polygenic yolk trends at the earliest embryonic stage (green brackets) that bifurcate into the two clades associated with mammal and bird from a common fish-like ancestor. FIG. 24 illustrates an alternative form of reformulation. Existing knowledge that positions the 1^{st} cell-fate decision in mammal development at the morula stage (rather than an earlier cleavage stage) leads to an alternative reformulation inconsistent with the ORR measurement in this study and the polygenic trend of yolk content (lower right).

Further investigations were conducted to determine whether a high LFR could be linked to endogenous/exogenous oxidative stress independent of co-existing ORR. Increased C. elegans organismal LFR observed from embryo to larvae could be simply attributed to chronological aging. Consistently, increased LFR in erythrocytes (red blood cells) was observed from mouse embryo to adult, while a converged LFR of 0.49 was attained from age-matched mature fibroblasts and epithelial intestine/kidney cells. Likely due to the difference in senescence experienced by different cell types, mature erythrocytes experienced a lower senescence than the age-matched fibroblasts to attain a lower LFR of 0.35, whereas in situ neurons experienced a higher senescence than the migratory oligodendrocyte progenitor cells along the vasculature in a developing mouse brain to reach 0.49 prematurely. Also, the highest LFR of 0.77 was attained by the immune cells known to produce high ROS under inflammation. In contrast, the lowest LFR of 0.25 or a near-zero post-compensated LFR was convergently approached by bovine blastomeres at the 2.5-cell stage and two cultured cell lines, forming a common baseline for in situ and in vitro cells. While the increased LFR of in situ cells was attributed to chronological aging or cellular senescence, the increased LFR of in vitro cells might detect the exogenous stress from nonideal culturing that generated uneven single-cell LFR, the highest of which coincided with morphologically senescent spherically shaped cells. Finally, an increase in LFR was observed from in vitro STS-induced apoptosis confirmed by single-cell morphological change.

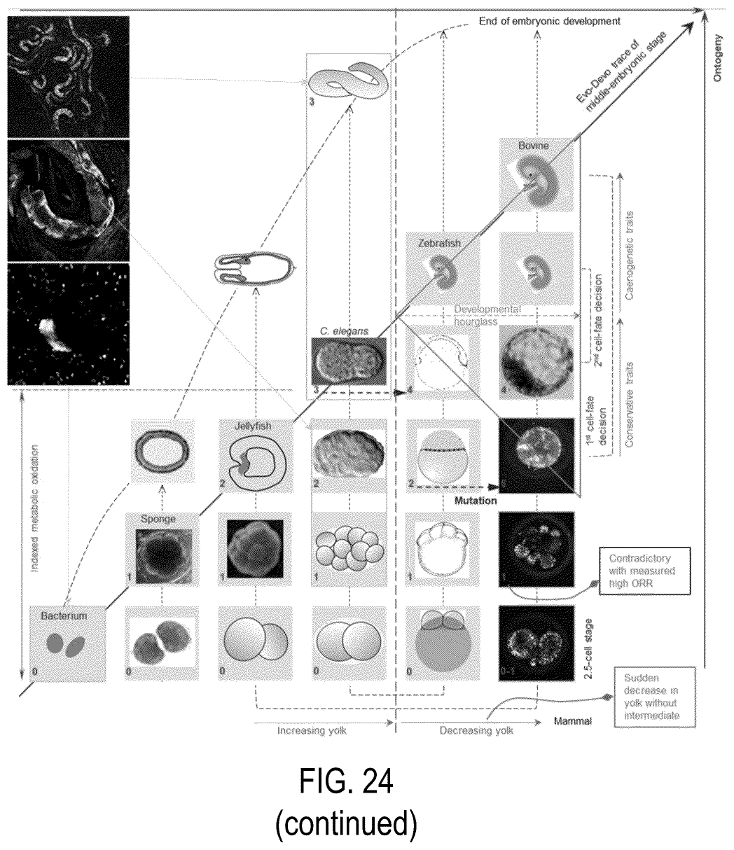

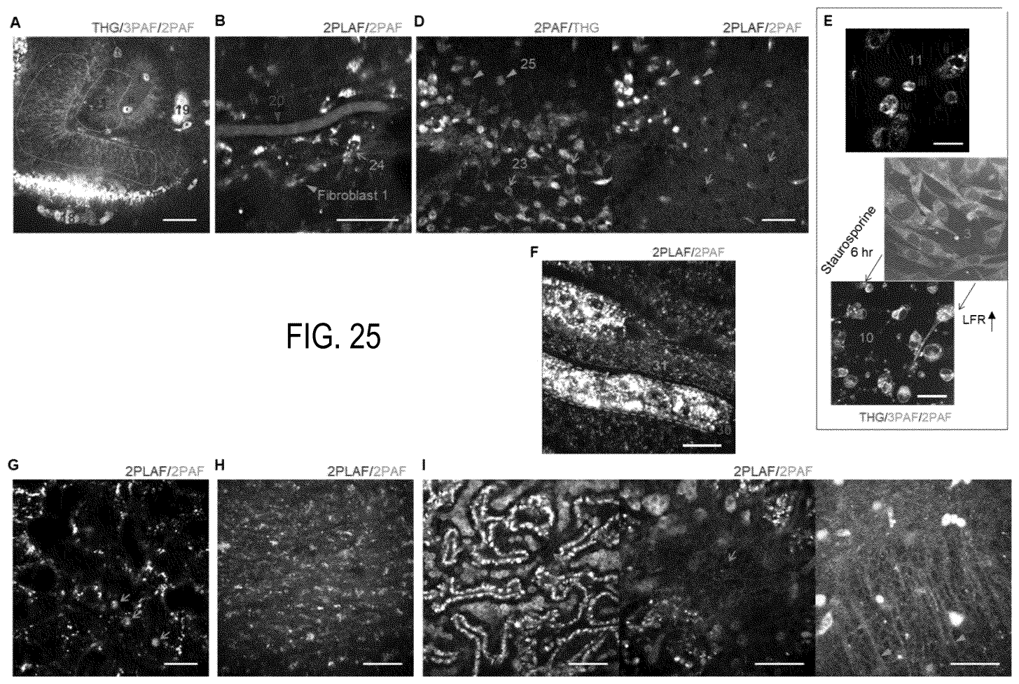

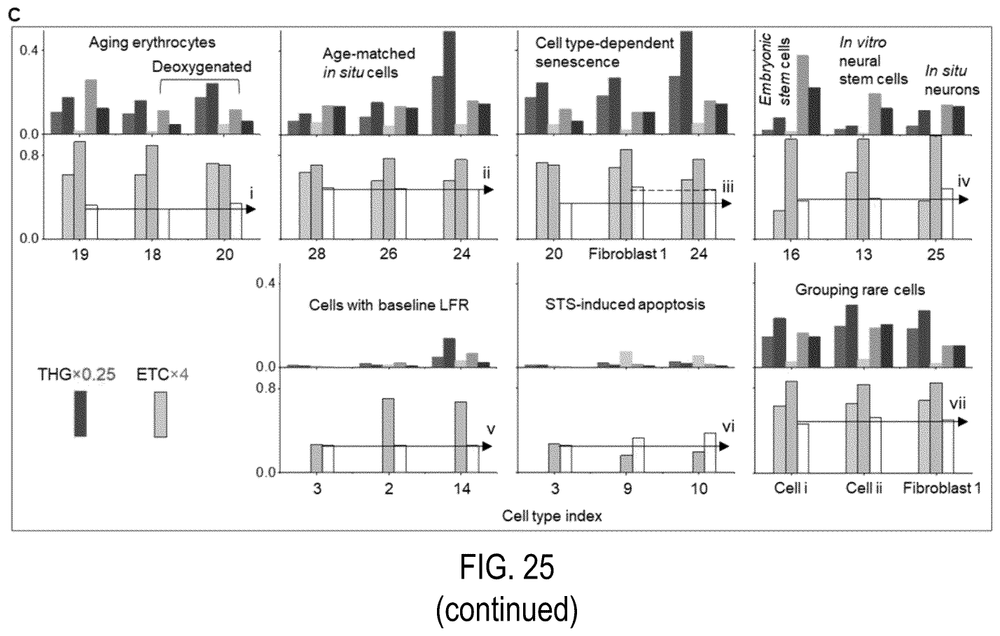

FIG. 25 illustrates oxidative stress in the context of metabolic noises. In all images of FIG. 25, the scale bar represents 50 μm and numbers in images specify cell types. Image (A) shows a developing mouse eye with ocular lens (Cell type 21) and optic-cup (Cell type 22) lined with similar elongated cells, rare cells inside the lens (Insets i, ii), and oxygenated (Cell type 19) versus deoxygenated erythrocytes (Cell type 18). Image (B) shows flowing erythrocytes (Cell type 20) versus abundant (Cell type 24) and rare fibroblasts (Fibroblast 1) in skin flap of a mature mouse. Graph set (C) presents LFR measurements of indexed cell types that support the homeodynamic hypothesis of aging in the context of the metabolic noises from non-LFR parameters of the 8-parameter metabolic profiles. Image set (D) shows neurons (Cell type 25) and oligodendrocyte progenitor cells (Cell type 23) in a developmental mouse brain. Image set (E) shows, at top, discrimination of low-LFR non-spherical pig stem cells (i and ii) against high-LFR spherically shaped counterparts (iii and iv); and at bottom, endpoint SOMI snapshots of in vitro hamster kidney cells before and after STS treatment showing simultaneous apoptosis-induced morphological change and increase in LFR. Image (F) is of epithelial cells in proximal/oxygenated (Cell type 30) or distal/deoxygenated tubule (Cell type 31) of rabbit kidney. Image (G) shows high-LFR 2PLAF-visible immune cells (arrows) in mouse lung tissue. Image (H) shows plausible atherosclerotic plaque (arrowheads) in rabbit heart tissue. Image set (I) includes three FOVs of mouse yolk sac showing emergent layer of endothelial cells visible only by 2PLAF (arrows) and individual erythrocytes (star). The endothelial cells may deposit non-collagen fibrils (arrowheads) visible only by 2PLAF.

Subsequently, tests were performed to integrate LFR- with ORR-based interpretations due to their decorrelation, i.e. decoupling of oxidative stress from metabolic oxidation. Mature rabbit kidney cells in proximal versus distal tubule exhibited a higher ORR at near constant LFR, which was due to increased 2PAF and 2PLAF at near constant 4PAF, THG, and 3PAF. This could be attributed to an increased oxygenation in vasculature (normal metabolism) under the same oxidative stress, as similar changes in embryonic erythrocytes were observed for oxygenated versus deoxygenated capillaries. Within the same FOV of these erythrocytes, the elongated cells lining a developing lens exhibited a lower LFR than those of hosting optic cup, supporting the “fiber-differentiating signal” from a preexisting optic cup to a lately developed more proliferate lens to produce a converged metabolism and morphology for the corresponding two cell types. In contrast to the two cell types with hardly differentiable 8-parameter profiles, the embryonic neurons versus oligodendrocyte progenitor cells exhibited increased 2PAF and 2PLAF, and decreased 4PAF, THG, and 3PAF, resulting in a strikingly similar change in ORR, LFR, and ETC to the two lineages of a ˜16-cell stage bovine embryo. Just like the first cell-fate decision giving rise to the two early lineages of inner cell mass and trophectoderm, a similar molecular machinery might produce the late lineages of neurons and oligodendrocyte progenitor cells from a common progenitor such as polydendrocytes. Remarkably, single-cell analysis of isolated cells inside the developing lens revealed an 8-parameter profile approximating that of a mature fibroblast, suggesting a transient signaling from these prematurely aged non-proliferate cells.

The metabolic imaging modalities of the present disclosure empower label-free diagnostic medicine. First, SOMI profiling of oligodendrocyte progenitor cells and neurons along with the visualization of (re-)myelination as a “phase change” allows interrogating the “malfunction of oxidative metabolism” associated with multiple sclerosis. Second, the high LFR of intestinal bacteria (0.70) may be treated as an adaptation to host intestinal immune cells (LFR as high as 0.77), despite the highly anaerobic bacterial metabolism with a low ORR. This high-LFR low-ORR trait contrasts sharply with the low-LFR high-ORR trait of the embryonic erythrocytes, motivating further investigation into gut microbiota and related metabolic diseases. Third, in the context of diverse cell types, the increased LFI with the development of bovine embryos within days can be attributed more to the oxidative stress of in vitro over in vivo production than to chronological aging. Due to the low correlation between ORR and pregnancy, limiting the increase in LFI for in vitro produced embryos may improve livestock or human assisted reproductive technology. Fourth, the epithelial cancer stem cells with strong FAD* may mimic the emergent low-LPR high-ORR inner cell mass-fated blastomeres at the ˜16-cell stage to enable stemness and epithelial-mesenchymal transition. Fifth, accumulated high-LFR macrophages or other immune cells due to an inflammation may lead to large-scale (intercellular) atherosclerotic plaques with distinct 2PLAF contrast. A similar structure arises from the high-LFR endothelial cells in mouse yolk sac that may deposit non-collagen fibers, which may offer insights into amyloid fibril formation.

In support of the homeodynamic hypothesis with heightened FAD as an antioxidative response, time-lapse SOMI was conducted on a green ivy leaf with chloroplasts prone to excessive light-induced photo-stress. Although intrinsic fluorophores from plant samples are different from those in the minimum model of animal cells, the 2PAF-revealed chloroplasts by FAD* are cleanly separated from 3PAF-revealed vacuoles of palisade mesophyll cells by stilbene fluorescence and from 2PLAF-revealed photosystem II (PSII) structures by intense and ×20-attenuated chlorophyll-a fluorescence. The intercellular non-chloroplast ring-like PSII structures are identified by the Kautsky effect at the peripherals of the vacuoles, defying the conventional wisdom of spatially restricted chlorophyll-a to chloroplasts only. This observation extends the comparative visible/single-photon photosynthesis to near-infrared/two-photon photosynthesis, resembling the effect of human two-photon vision. In one phase of the Kautsky effect, the otherwise 2PAF-invisible chloroplasts emerge with increasing FAD* during time-lapse SOMI, a subtle effect that has been masked by the intense but decreasing chlorophyll-a fluorescence from standard measurements. This dynamic effect can occur at up to 50% weaker illumination of standard SOMI (i.e. down to 7.5 mW), with a refractory period within 10-20 min and a dark acclimation time of >60 min. These results suggest that the increasing FAD* in chloroplasts is a specific antioxidative response that maintains normal photosynthesis (the Kautsky effect). Consistently, bright FAD* and the Kautsky effect were absent from the chloroplasts in a yellow (senescent) ivy leaf, which contrasted oppositely with its green counterpart in 2PAF/2PALF composite images.

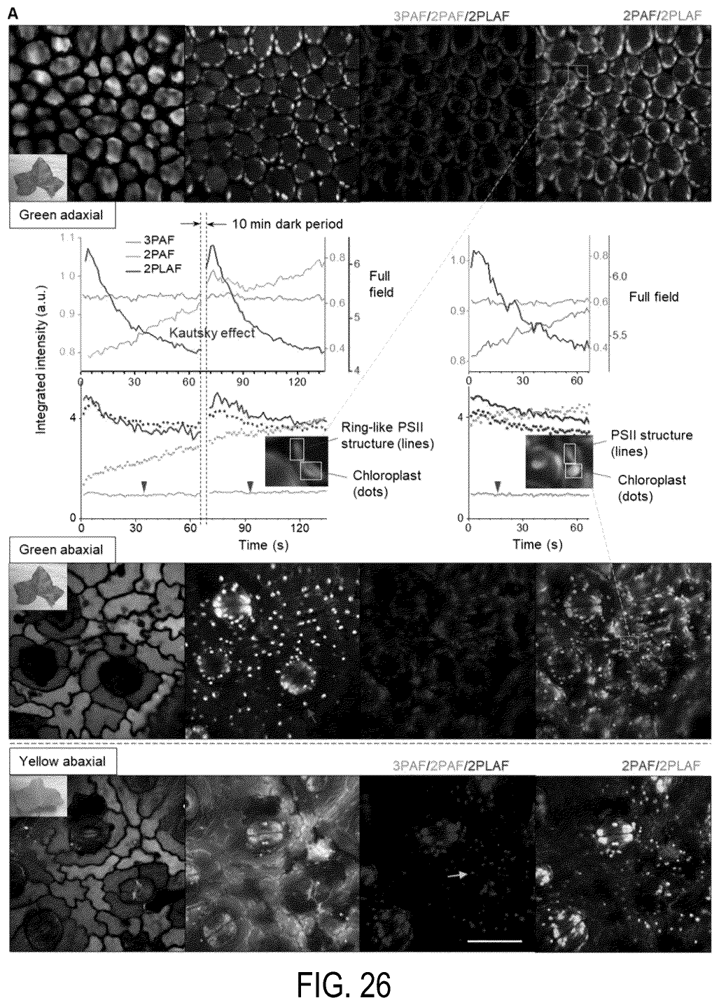

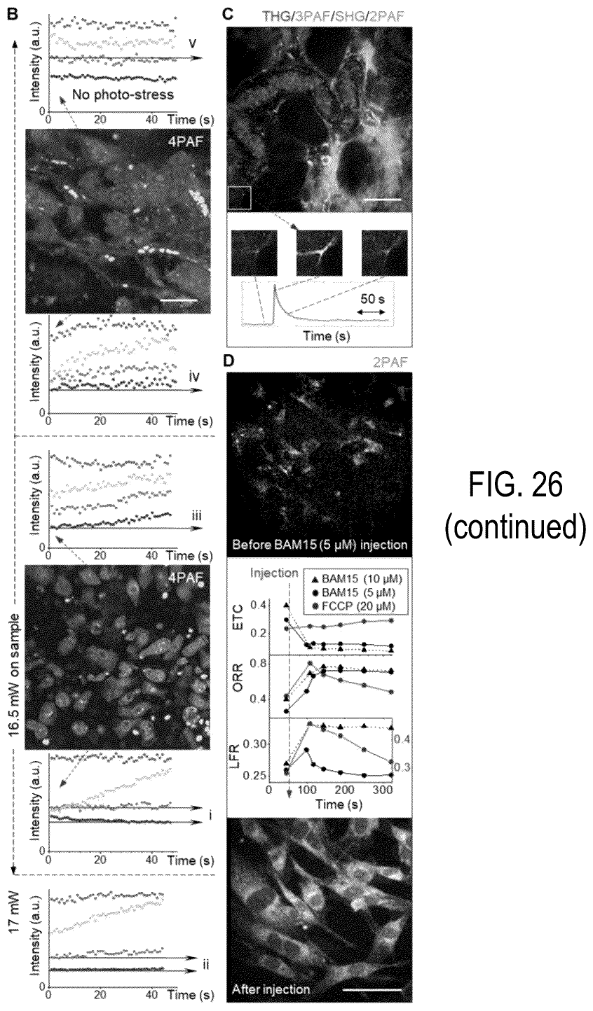

FIG. 26 illustrates antioxidative responses to acute oxidative stress. In all images of FIG. 26, the scale bar represents 50 μm. In FIG. 26, image and graph set (A) shows, at top, time-lapse imaging of adaxial and abaxial surfaces of green ivy leaf with 3PAF/stilbene-visible vacuoles, 2PAF/FAD-visible chloroplasts (magenta arrow), and ×20-attenuated 2PLAF/chlorophyll-visible PSII structures subjective to full field recurrent Kautsky effect (red curves) with constant vacuole visibility (cyan curves) but increasing chloroplast visibility (yellow curves). The same phenomenon is found for the segmented areas (white boxes) from one chloroplast (dotted curves) but not adjacent non-chloroplast PSII structure (solid curves and arrowheads), while the abaxial surface more clearly shows that the Kautsky effect is dominated by continuous non-chloroplast PSII structures rather than chloroplasts. Image and graph set (A) shows, at bottom, a yellow ivy leaf with unattenuated 2PLAF/chlorophyll-visible chloroplasts (cyan arrow) barely visible by 2PAF/FAD. Image and graph set (B) of FIG. 26 shows, at top, time-lapse imaging (˜1 Hz frame rate) of ex vivo rabbit kidney showing a synchronized increase of 2PAF/FAD and 2PLAF/LOP under increasing 3PAF/NAD(P)H as photo-stress (Inset iv) in a segmented erythrocyte (arrowhead), which is absent (Inset v) from a segmented epithelial cell (oval); at middle, the same synchronized increase (Inset iii) observed in a segmented bacterium (arrowhead) in ex vivo rabbit intestine absent from a segmented immune cell (oval, Inset i), which exhibits increasing 3PAF/NAD(P)H only; and at bottom, emergence of the synchronized increase (Inset ii) in an immune cell at a higher illumination power. Note that the bacterium shares the same form of photo-stress as the immune cell and can therefore be discriminated against a non-living particle with no increase in AF signals. Image and graph set (C) shows intravital imaging of mouse mammary tissue near a leg area by simultaneous label-free autofluorescence multi-harmonic microscopy, showing a spike of 2PAF/FAD signal in segmented axon of a peripheral neuron due to a random “superoxide flash.” Image and graph set (D) shows, at middle, ETC-ORR-LFR kinetics of segmented in vitro hamster kidney cells after a transient exposure of FCCP and BAM15 from single-cell pharmacokinetic SOMI; and at top and bottom, emergence of 2PAF-visible cytoplasm (arrowhead) beyond mitochondria (arrow) after a BAM15 exposure.

To detect similar photo-stress from in situ animal cells, frame-by-frame increase in AF during time-lapse imaging was examined at ˜10% higher powers than standard SOMI illumination (15 mW). At 16.5 mW, the photo-stress of single intestinal immune cells exhibits increasing 3PAF or NADPH-dependent antioxidation under rather constant 4PAF/2PAF/2PLAF. At 17 mW, 2PAF and 2PLAF undergo a synchronized increase, which is also observed in single intestinal bacteria at a lower threshold of 16.5 mW. Thus, increasing FAD* (2PAF) may be treated as an antioxidative response to increasing LOP* (2PLAF) to stabilize LFR when the NADPH-dependent antioxidation becomes insufficient. Just like the bacteria among the immune cells, the same low-threshold photo-stress is found in erythrocytes among epithelial kidney cells, consistent with the evolution of erythrocytes from a bacterium-like unicellular ancestor. In sharp contrast to the low-threshold photo-stress of intracellular chloroplasts at 7.5 mW and in situ erythrocytes or bacteria at 16.5 mW, no increase of FAD* is induced at 16.5 mW in the animal cells in situ or their intracellular compartments such as ROS-generating mitochondria. At 17 mW, the animal cells would initiate FAD-dependent antioxidation throughout the cytoplasm.

For diverse cells subjective to spontaneous mitochondrial “superoxide flashes” at a timescale of 10-s, the hypothesized FAD-dependent antioxidation predicts label-free 2PAF imaging of this general phenomenon. Indeed, a spike of FAD* was observed in s peripheral neuron responding to a random ROS flash. At a similar timescale, an initial spike of FAD* can be observed by fluorometry from electrically stimulated neurons, which may be treated more as an antioxidative response to electrically stimulated stress than a passive response of metabolic oxidation.

Finally, in vitro pharmacokinetics were explored to visualize how the FAD*-visible antioxidation responded to drug-induced acute oxidative stress. The kinetic imaging assay modified for SOMI indicated that the “cytotoxicity” of AP3 arose from AP3 fluorescence labeling ability ignored previously, which might be misinterpreted as an intrinsic cellular response from the corresponding endpoint assay. Therefore, attempts were made kinetically detect plausible metabolic shift from mitochondrial uncouplers BAM15 and undetectable from the endpoint assay. Despite similar kinetics from transient BAM15 and AP3 exposures, the opposite trend in fluorescence lifetime and absence of intrinsic BAM15 fluorescence allowed attributing the BAM15-induced change to an intrinsic cellular response. Comparative kinetic assays using the two mitochondrial uncouplers revealed interesting metabolic kinetics: i) endocytosis via THG-visible nanovesicles might enable cellular uptake of BAM15 but not FCCP; ii) early rise in LFR indicated a faster rise of LOP* (acute ROS increase as cause) over FAD* (antioxidation as effect) likely from a causal relationship; iii) with a common shift to more oxidative metabolism (early rise in ORR), agile LFR recovery was found for the low-concentration BAM15 exposure but not the high-concentration exposure, suggesting that a small acute rise of oxidative stress such as exercise might not lead to cumulative oxidative damage; iv) for both BAM15 concentrations, the coincidence of sudden decease in ETC with ˜10-fold rise in FAD* supported the increase of FAD-dependent antioxidation via Trp-based NAD biosynthesis; v) surprisingly larger FAD* was induced by BAM15 than FCCP to counter the oxidative stress in cytoplasm rather than mitochondria, defying the common wisdom on mitochondria-centered FAD pool; and vi) for BAM15 exposures, the NADPH-dependent antioxidation with increased NAD(P)H* intensity and lifetime occurred latter than the FAD-dependent antioxidation despite at a lower threshold of oxidative stress.

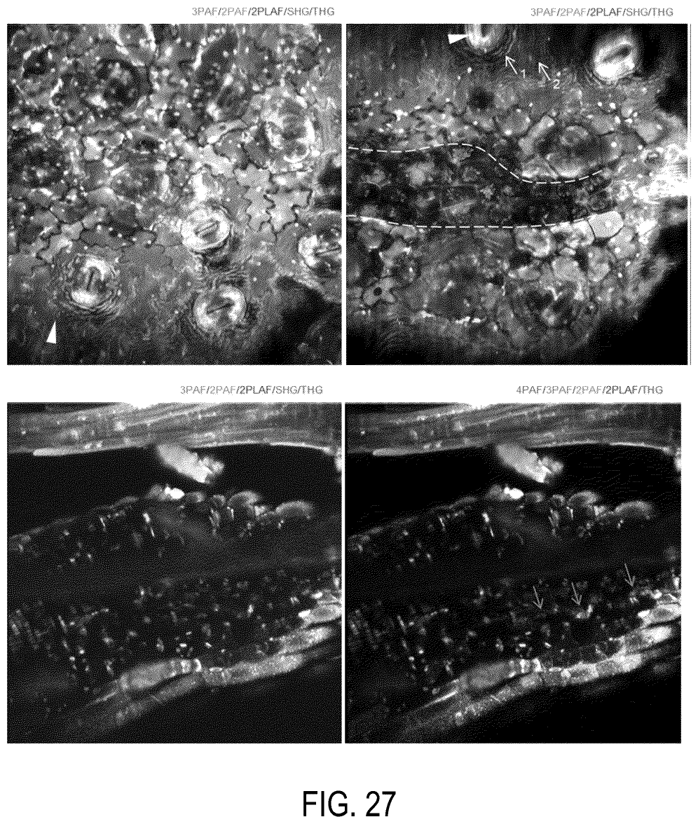

FIG. 27 presents a visualization of plant samples. The adaxial side of a green ivy leaf shows THG-visible stomata (arrowheads) and surrounding SHG- and THG-visible ‘wrinkles’ (arrows, top) as well as the phloem cells with THG-visible sieve elements (broken curves) absent from the abaxial side, whereas the leaf stalk of mimosa pudica shows unique 4PAF/green visible structures not observable from other colors (arrows, bottom). The scale bar represents 50 μm.

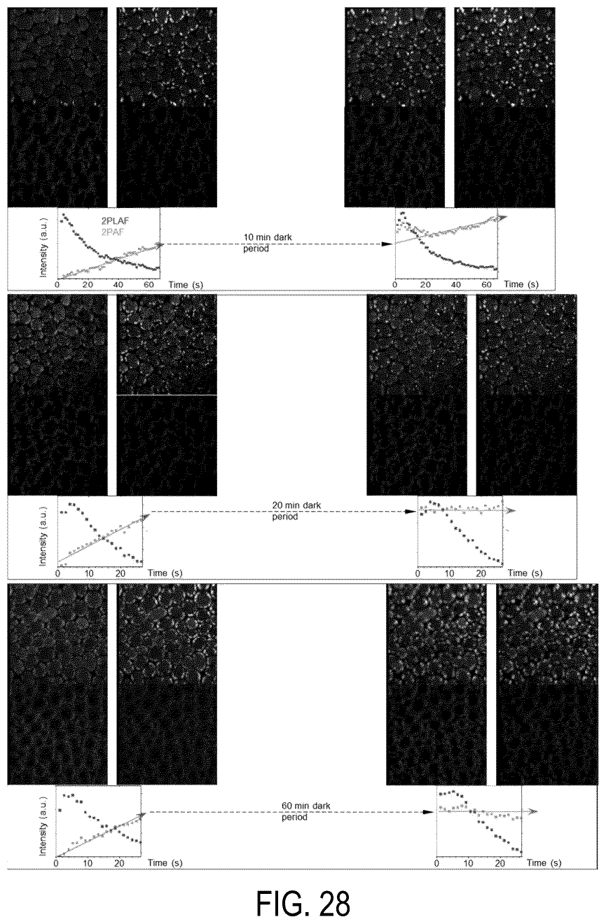

FIG. 28 shows two cycles of Kautsky effect and related physiology in green ivy leaves. In particular, FIG. 28 illustrates the time-dependent visibility of 2PAF/yellow-visible chloroplasts and 2PLAF/red-visible photosystem II structures on the dark time (10, 20, or 60 min) between two imaging sections indicates a refractory period within 10-20 min (dark time to transit from increasing to plateauing 2PAF visibility of chloroplasts in the second cycle) and a dark acclimation time of >60 min (dark time to transit from 2PAF-visibile to 2PAF-invisible chloroplasts at the beginning of the second cycle).

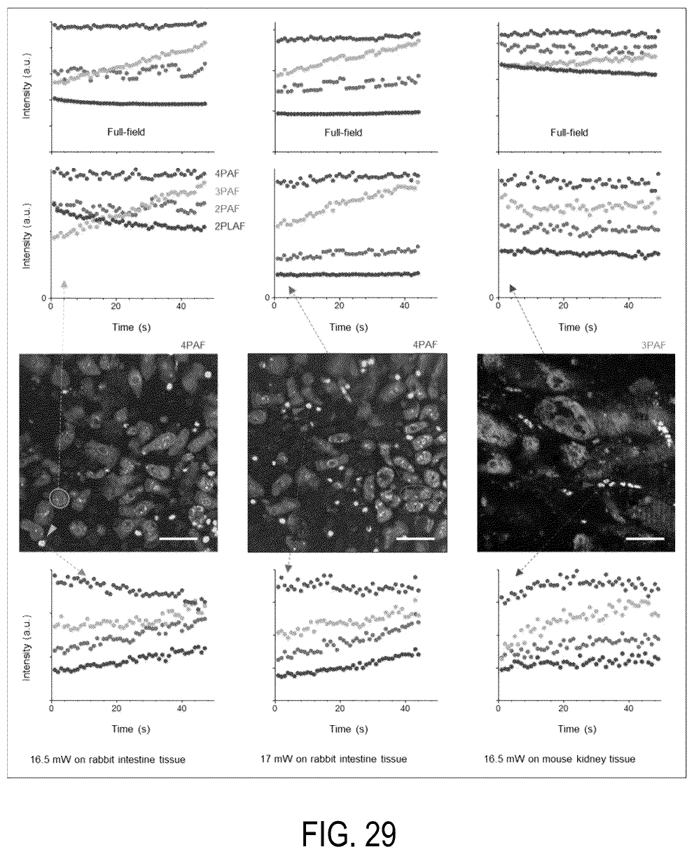

FIG. 29 illustrates photo-stresses of in situ cells under time-lapse imaging. With rather constant 4PAF, a synchronized increase in 2PAF and 2PLAF is detected at 16.5 mW for a segmented bacterium (cyan arrowhead) and erythrocyte (red arrowhead) but not epithelial cell (red oval), and at 17 mW for a segmented immune cell (magenta oval). Also, a lower threshold photo-stress with increase in 3PAF but not 2PAF and 2PLAF is detected at 16.5 mW for another segmented immune cell (cyan oval). These photo-stresses can also be detected in full-field kinetics without single-cell resolution, while the observed kinetics of FAD, LOP, and NAD(P)H are highly reproducible among different single cells within the same cell type in the same FOV. The scale bar corresponds to 50 μm.

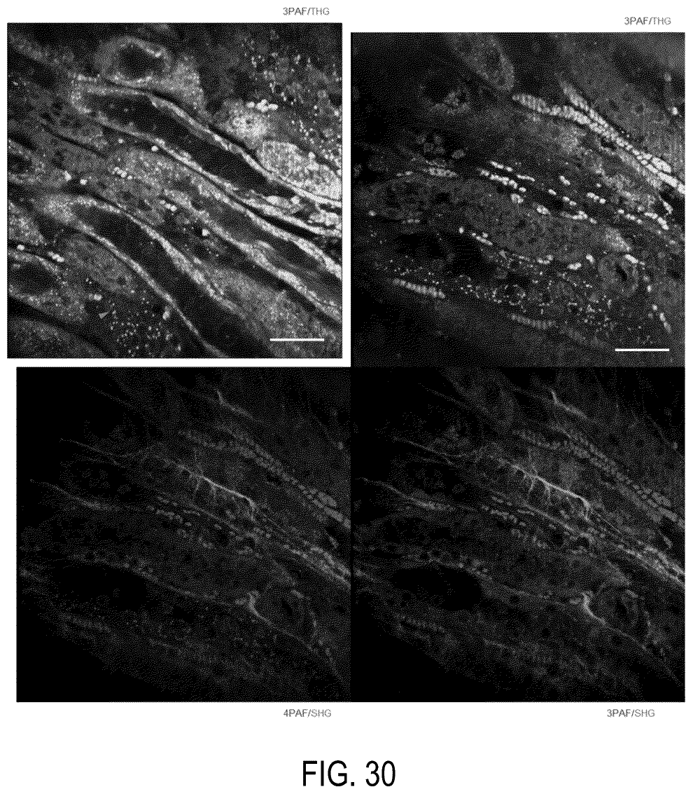

FIG. 30 illustrates synergistic THG/SHG and intrinsic fluorescence imaging of ex vivo rabbit kidney. Dual-color 3PAF/THG composite helps identify intracellular vesicles (arrowhead, top left) and erythrocytes (arrows, top left) that are clearer in another field-of-view (top right), while dual-color 4PAF/SHG or 3PAF/SHG composite indicates no intrinsic fluorescence from SHG-visible collagen fibers (lack of yellow contrast in bottom panels). It should be noted that dual-color red/green visualization is an alternative to magenta/green and red/cyan dual-color visualizations widely used in other images but may be insensitive to color-blind viewers.

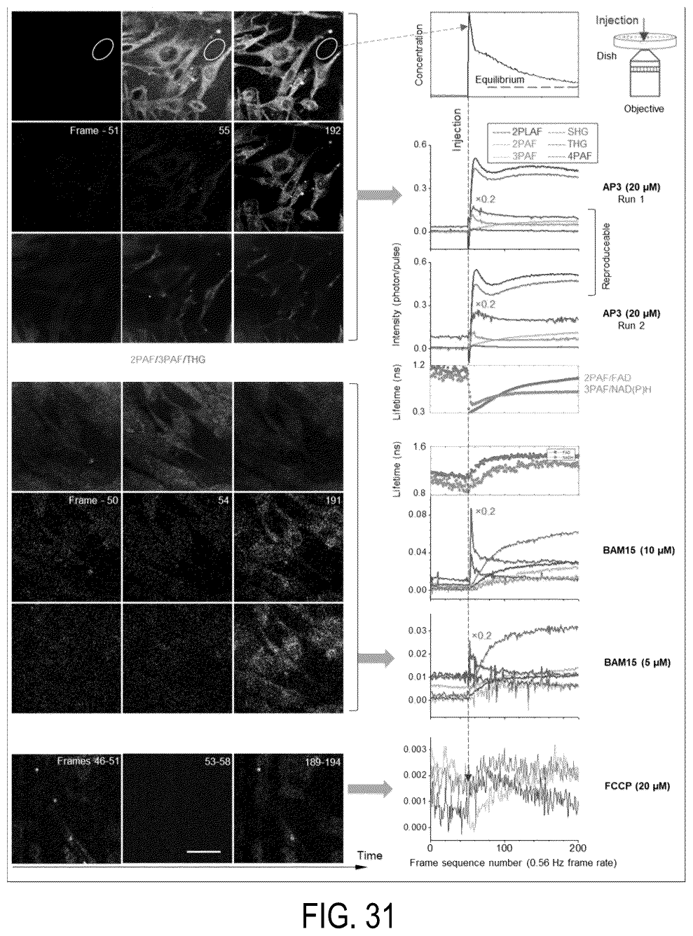

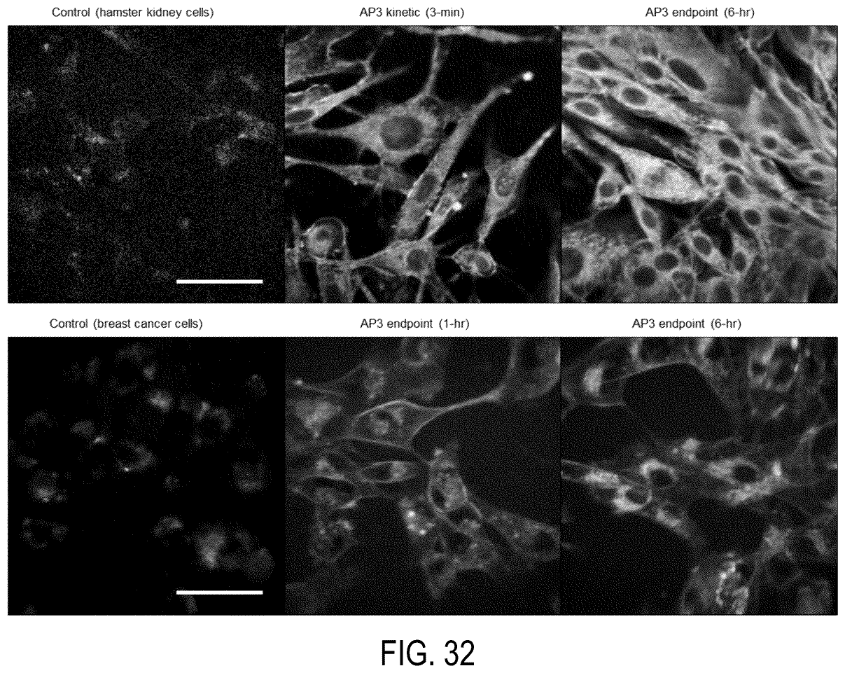

FIG. 31 illustrates in vitro kinetic imaging assays for drugs and labeling agents. The time-dependent concentration profile of an injected chemical can be measured by AP3 fluorescence in an empty space among cultured hamster kidney cells (oval) before and after the injection of AP3 labeling dye at the center of imaging dish, which produces reproducible cellular response in two runs. Similar injection of a non-fluorescent drug (BAM15 or FCCP), which should follow a similar concentration profile, produces different cellular responses. FIG. 32 illustrates the general applicability of AP3 to fluorescently label the cytoplasm. Both hamster kidney cells and breast cancer cells can be clearly visualized by 2PAF color after AP3 labeling. The scale bar represents 50 μm in FIGS. 31 and 32.

Aging is accompanied by a gradual decrease of non-fluorescent NAD, which has been correlated with fluorescent FAD in concentration. The corresponding proportionality in concentration has been indirectly confirmed by the symmetrically opposed acute kinetics of FAD and NADH (as the opposite of NAD kinetics) in a temperature-dependent study, the circadian roles of both NAD and FAD, and the reported anti-aging by NAD- and FAD-related dietary supplements. Another indirect evidence is the dramatically decreased FAD in senescent chloroplasts. Thus, the observed FAD-dependent antioxidation may reinforce the perceived antioxidative role of NAD, enable the resistance of FAD-high cancer stem cells to chemotherapy, and demystify the protection of tardigrades from UV radiation by unknown AF-emitting biomolecule(s). The unusual coincidence of high 2PAF/FAD with low ETC in C. elegans larva, in vitro neural stem cells, and kinetically BAM15-treated hamster kidney cells suggests a low Trp level from upregulated NAD biosynthesis to strengthen the FAD/NAD-dependent antioxidation. As to drug development, the absence of this FAD/NAD-dependent antioxidation in STS-treated cells activates apoptosis despite the presence of alterative NADPH-based antioxidation, validating the potency of related drugs in cancer therapy. In contrast, the expanded FAD/NAD-dependent antioxidation beyond mitochondria into the whole cytoplasm may explain why BAM15 is less toxic than FCCP in mitochondrial uncoupling. As an apparent biomarker of oxidative stress or cell type-dependent aging clock, the yellow-to-red AF redshift (LFR) is weakly correlated with 2PAF/FAD, and to a larger degree, 2PLAF/LOP, validating the homeodynamics-shifting stress experiments.

The above evidence supports a homeodynamic picture of redox biology that illuminates a path from acute oxidative stress to cumulative oxidative damage. Likely due to the coupled evolution of life and geological oxygenation history, pairing a level of cellular LOP (pertinent to ROS production for redox signaling) with a proportional FAD/NAD-dependent antioxidation is universally harnessed by diverse cell types from different species and cell differentiation within one species to achieve diverse functions. For example, simple increase in FAD/LOP without varying NAD(P)H, lipid, and Trp metabolism allows oxygenation of erythrocytes and epithelial cells. As another example, the emergence of unique FAD/LOP-high blastomeres at ˜16-cell stage from FAD/LOP-low blastomeres at 2.5-cell stage dictates “fate” via inner cell mass. On the other hand, an acutely elevated LOP does not necessarily accumulate oxidative damage (irreversible increase of LFR) if countered by an elevated FAD/NAD to heighten ROS scavenging, even though a delayed response may result in a spike (reversible increase) of LFR. However, the FAD/NAD-dependent antioxidation may deteriorate over time to allow sustained high LFR. This can cause aggregation and precipitation of otherwise soluble LOP to enrich in lysosomes and prioritize the antioxidation in mitochondria with high ROS production, leading to the cumulative oxidative damage of intracellularly compartmented LOP and FAD that increases LFR continuously. The resulting chronological aging may then preferably damage high-LFR cells of immune, endothelial, or other origins, converting LOP aggregates into insoluble intercellular deposits and disordered extracellular plaques or specifically ordered fibrils toward heart failure, neurodegeneration, or other chronic diseases.

In contrast to the oxidative stress simply visible by the yellow-to-red AF redshift, metabolic oxidation is an independent redox metric simply visible by the blue-to-yellow AF redshift. This independence may be responsible for many failed antioxidant therapies and may mitigate not only the antioxidant paradox but also the NAD ratio redox paradox. Except for a constraint early in embryogenesis to recapacitate the anaerobic metabolism of their ancestors, multicellular organisms gain adaptivity to vary NADH acutely at a given level of antioxidation (FAD/NAD), generating diverse redox states of oxidative phosphorylation, glycolysis, glutaminolysis, mitochondrial uncoupling, and fatty acid synthesis. The evolutionary diversification of multicellular traits over a billion years of increasing oxygenation heightens the importance of ORR- and LFR-based embryonic adaptations. It is thus a paradox that multicellular life gains highly variable ORR and LOP/FAD among cells to achieve complexity, but at the price of irreversibly increasing LFR as a general cause for chronological aging and chronic diseases. Acutely, the simultaneously visualized oxygenation (ORR) and stress (LPR) of erythrocytes and constituent cells in tissue offers a new way to track ischemia-reperfusion injury. By combining these dimensionless metrics with supercontinuum signal intensities and AF lifetimes, a renaissance of Heimstaedt's fluorescent microscope may metabolically and quantitatively phenotype unperturbed and unlabeled live cells in diverse biological contexts.

The ability of SOMI to monitor photo-stress guarantees the authenticity of acquired multiparametric single-cell metabolism free from imaging artifacts, while the limitations of low signal-to-noise ratio and small FOV can be mitigated by modern machine learning. Without spectral interference in signal, emergent near-infrared fluorescent labeling may put an arbitrary molecular content of interest into a broad metabolic context including collagen, Trp, and lipid metabolism, and thus bridge labeled (preclinical) and label-free (clinical) optical imaging. This metabolic context is broadly useful for assessing the cytotoxicity of labeling agents and drugs. The universally low level of intracellular lipid droplets in vitro promotes the shift from immortal cell lines to primary cells or complex 3D models (e.g. organoids) for future drug screening. Importantly, SOMI recovers the fast inter-biomolecule interaction absent from reductionism-based live-cell optical imaging and overcomes an intrinsic challenge of molecular quantitation in fluorescently labeled microscopy.

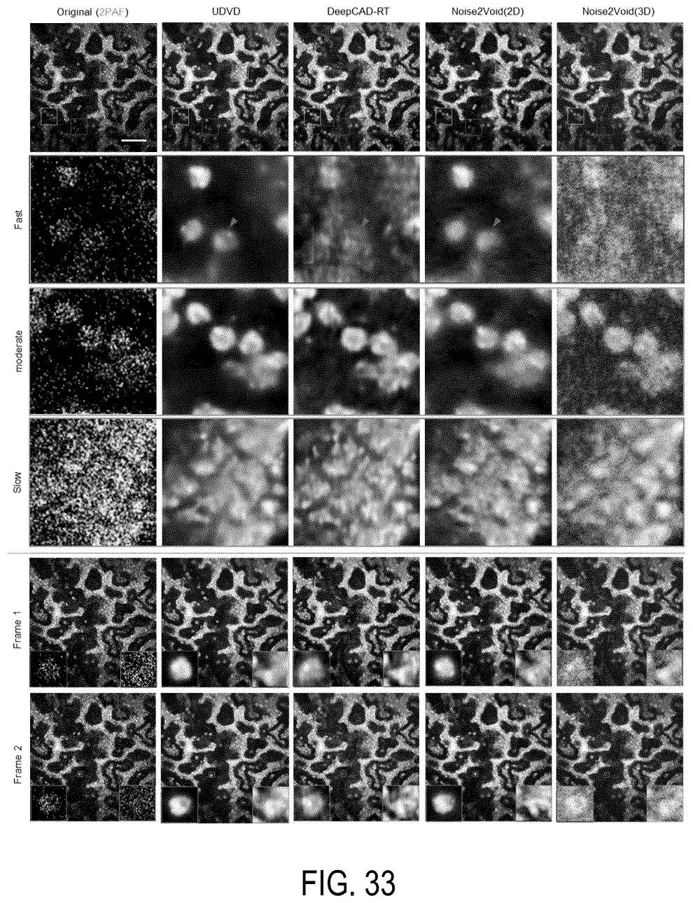

FIG. 33 presents a comparison of video denoising models to visualize moving erythrocytes in yolk sac of an E11 mouse embryo. The top four rows present one frame with large local regions of fast (red boxes), moderate (orange boxes), or slow (blue boxes) movement, and it can be seen that DeepCAD-RT or N2V-3D but not UDVD or N2V-2D denoising introduces significant distortion to flowing erythrocytes with weak temporal dependency (red boxes), whereas little distortion is introduced to slow-moving vasculogenic microenvironment with strong temporal dependency (blue boxes). In the bottom two rows, a similar observation in two randomly selected frames with smaller local regions of fast (red and green boxes) and slow movement (blue boxes) can be seen, showing single file flowing of different erythrocytes in a narrow emergent/invisible vessel (red and green boxes). The scale bar is 50 μm.

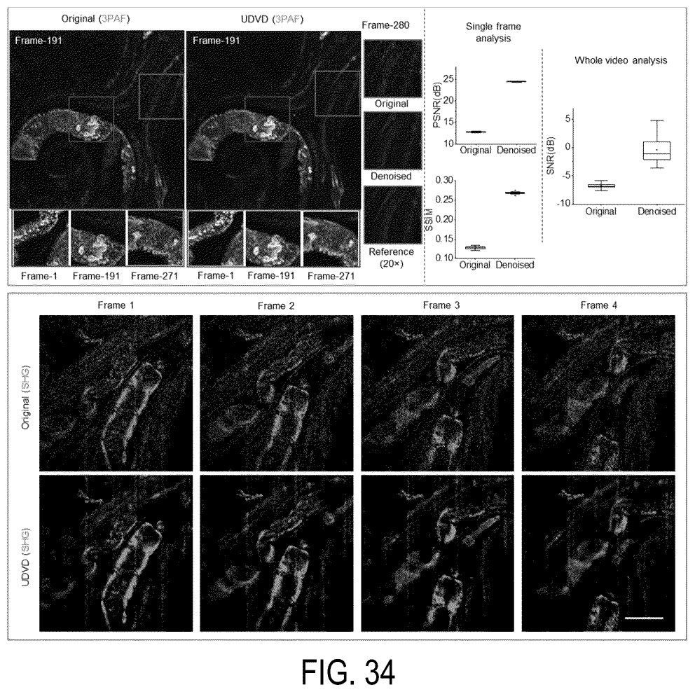

FIG. 34 shows denoising free movement of C. elegans by UDVD. At top, a single-frame analysis of one selected region with fast movement (red boxes) reveals˜12 dB improvement of both peak signal-to-noise ratio (PSNR) and structural similarity index (SSIM) in a period near Frame-280 with 20 consecutive frames, during which a reference image is produced in a region with little movement (magenta box) by averaging all frames while this reference image can be approximated by denoised Frame-280. After the denoising, electric noise manifests as oblique periodic line-shaped artifacts (zoom in for clear view) predictable by neighboring spatiotemporal regions, indicating the suitability of UDVD for removing independent noise while retaining the spatiotemporally dependent noise. Consistently, the corresponding whole video analysis based on the mean versus standard deviation of pixel intensities in each frame (SNR) reveals ˜5 dB improvement. At bottom, original and denoised SHG videos of C. elegans are shown, in which electric noise manifests as vertical line-shaped artifacts instead after the denoising. The scale bar is 50 μm.

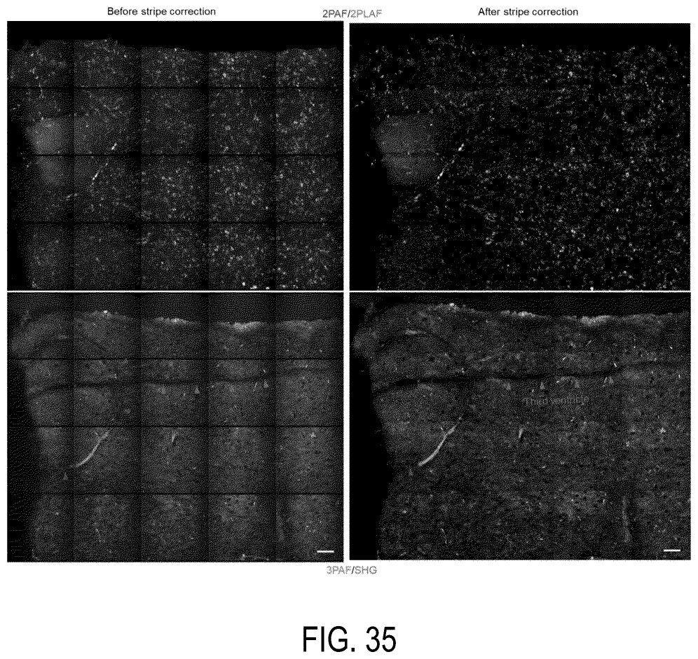

FIG. 35 illustrates the discovery of large-scale structures in rat brain slice containing suprachiasmatic nucleus (SCN). The third ventricle is not visible in 2PAF/2PLAF image but emerges in 3PAF/SHG image despite the stitching artifacts from mechanical stage-assisted mosaicking of 4×5 fields of view (magenta arrowheads). A large-scale structure around SCN can be detected in the 3PAF/SHG image across multiple fields of view (red arrowheads), while subsequent stripe self-correction removes the stitching artifacts to improve the visibility of the novel large-scale structure and the third ventricle. The scale bar is 50 μm.

In the above experiments (e.g., in the procedures used to generate the images described above), the following materials and methods were provided or performed. Adherent Syrian golden hamster kidney fibroblast cells BHK-21 (clone 13, ATCC CCL-10) were cultured in phenol red-free Eagle's Minimum Essential Medium (EMEM) supplemented with 10% FBS, 1% penicillin-streptomycin-amphotericin B (PSA), and 2.5 mM L-Glutamine at 37° C. under 5% CO2, and atmospheric O2 conditions. Before imaging, 1 mL of trypsinized cells was resuspended in 1 mL of 1×TrypLE™ Select Enzyme cell dissociation reagent (TFS, Cat #12563029). The cells were plated on poly-D-lysine coated 35-mm diameter glass-bottom imaging dishes and maintained inside a humidified incubator with 5% CO2 and 21% O2 conditions at 37° C. The incubation time varied between 1-6 hours while the culture media might be supplemented with specific drugs or labeling agents at M-level concentrations. The cells were imaged within 10 min of being taken out of the incubator.

Secondary cultures of NE-4C mouse neural stem cells (ATCC CRL-2925) were grown on treated BioLite T75 cell culture flasks (ThermoFisher; 12-556-010) in EMEM supplemented with 10% fetal bovine serum (FBS, 16140071, Thermo Fisher Scientific, Waltham, MA, USA), 1% Penicillin/Streptomycin (10378016, Thermo Fisher Scientific) and a final concentration of 4 M L-Glutamine (10009CV, Corning, Corning, NY, USA). Once 70% confluent, cells were trypsanized, replated at a 1:10 ratio on the T75 flasks for continued growth, and a subset were plated on a 35-mm glass-bottom imaging dish coated with poly-L-lysine, and grown in supplemented EMEM for 30 hours in an incubator at 37° C. with 95% air and 5% CO2. Differentiated cultures were incubated with 1 M retinoic acid for 7 days to promote differentiation into neurons. Media was replaced every 2-3 days. Imaging was performed after 7 days of incubation in differentiated cultures at room temperature within 10 min of being taken out of the incubator.

Human breast cancer cells MCF7 (ATCC HTB-22) were maintained in EMEM (Sigma-Aldrich) supplemented with 10% FBS (Corning), 5 g/mL insulin and 1% penicillin streptomycin antibiotic, and grown in an incubator at 37° C. with 5% CO2. One day prior to imaging, cells were plated on poly-D-lysine coated 35-mm diameter glass-bottom imaging dishes and incubated overnight in 2 mL of supplemented EMEM media to adhere to the glass-bottom imaging dishes. The cells were imaged at room temperature within 10 min of being taken out of the incubator. Pig adipose-derived stem cells were isolated and cultured according to a special protocol. Subcutaneous back fat and bone marrow were acquired from castrated Yorkshire crossbred male pigs, at approximately 6 months of age, under protocols approved by the University of Illinois Institutional Animal Care and Use Committee (IACUC #04296). Pigs were euthanized at the University of Illinois Meat Science Laboratory abattoir. The skin overlying the loin area was shaved to remove the hair and scrubbed three times using Betadine® solution (Povidoneiodine, 10%—Purdue Products L.P., Cranbury, NJ), and three times with 70% ethanol to avoid contamination of the sample. A square of subcutaneous back fat (˜100 cm²) was then excised from the sanitized area from each pig, placed in a sterile plastic bag, transported to the laboratory on ice and placed at 4° C. until cell harvest (<1 hr). The subcutaneous fat was dissected from the skin with a sterile scalpel. All the surfaces of the fat that were originally exposed at tissue harvest were also trimmed off with a sterile scalpel blade, so the only sterile fat was processed for cell isolation. Strips of sterile fat were washed twice in Dulbecco's Phosphate Buffer Saline (DPBS, Sigma Aldrich D5773, St. Louis, MO) containing 1% Penicillin G-Streptomycin (Sigma P3539) and 5.0 mg/L of Amphotericin B (Sigma A9528). After washing, tissue was minced with scalpel blades and then digested with 0.075% collagenase type I-A (Sigma C2674) in DPBS, in a 50 ml conical tube (Corning, NY) (v/v—tissue/collagenase), in the incubator at 37° C. for 90 min. The conical tubes, containing fat and collagenase, were vigorously shaken every 10 to 15 min to ensure a uniform digestion. After digestion, tubes were centrifuged at 200×g for 10 min at room temperature. The buoyant cell fraction and supernatant were discarded, and 2 mL of red blood cell lysis buffer (Sigma R7757) was added to the pellet and gently mixed for 2 min. Subsequently, 20 mL of DPBS were added to the tubes and were centrifuged at 200×g for 5 min at room temperature, to obtain a cell pellet that was then re-suspended in culture medium. The culture medium used was high glucose Dulbecco's Modified Eagle's Medium (DMEM, Sigma D5648), supplemented with 10% Fetal Bovine Serum (FBS, BenchMark™, Gemini Bio-Products, West Sacramento, CA), plus 1% Penicillin G-Streptomycin and 5.0 mg/L of Amphotericin B. Cells were counted using an hemocytometer, plated in 75 cm² Corning cell culture flasks at 7.5×10⁵ cells in 15 mL of culture medium, and incubated at 39° C. and 5% CO₂ in 100% humidified air. Medium was changed every other day until the initial cell culture passage. Passage-0 cells reached confluence at approximately day 10 of culture. To keep the cells at a sufficiently low density to stimulate further growth, the initial cell cultures were washed using DPBS and harvested by digestion with 0.25% Trypsin (Sigma T4799)—0.04% EDTA (Sigma E6753) for 3 min. Trypsin was then inactivated by adding an equivalent volume of culture medium and the cells were centrifuged at 200×g for 5 min at room temperature. Cells were resuspended in culture medium for plating in 75 cm² cell culture flasks at a density of approximately 7.5×10⁵ cells/75 cm². These passage-1 cells were 80% confluent after 4 days. Cells were trypsinized, as described above, and frozen at 3×10⁶ cells per 1.2 mL in cryogenic vials (Nalgene® Labware, Rochester, NY). Freezing medium consisted of 75% DMEM supplemented with 15% FBS and 10% dimethyl sulfoxide (DMSO, Sigma D2650). Vials were placed in Nalgene Cryo 1° C. Freezing containers (Nalgene® Labware) and placed in a −80° C. freezer. On the following day, cells were transferred to liquid nitrogen and stored. Finally, cells were resuspended in culture medium for plating in 75 cm² cell culture flasks at a density of approximately 7.5×10⁵ cells/75 cm², plated on poly-D-lysine coated 35 mm diameter glass-bottom imaging dishes in 2 mL of media, and incubated at 39° C. and 5% CO₂ in 100% humidified air. The cells were imaged at room temperature within 10 min of being taken out of the incubator.

All reagents of media for bovine preimplantation embryos were purchased from Sigma-Aldrich (St. Louis, MO, USA) to obtain the in vitro maturation (IVM) medium H-IVM (Cat #1.04.020, StrobechMedia, Copenhagen, Denmark), the in vitro fertilization (IVF) medium (Cat #1.06.020, StrobechMedia, Copenhagen, Denmark), and the in vitro culture (IVC) medium (Cat #1.07.020, StrobechMedia, Copenhagen, Denmark). The mineral oil was Stroebech Oil (Cat #2.08.050, peroxide tested, pre-washed oil, StrobechMedia, Copenhagen, Denmark). The wash solution was Wash Medium containing HEPES (Cat #1.02.020, StrobechMedia, Copenhagen, Denmark). The immature oocytes were aspirated from bovine ovaries obtained from a local abattoir (JBS Beef Production Facility, Green Bay, WI). Oocytes were placed into 750 μl H-IVM medium and allowed to mature for 21-24 hours at 38.8° C. Embryos were produced as previously described (88). First, in vitro matured COCs were washed, transferred into 500 μl drops of IVF medium and placed in the incubator at 38.8° C. in 5% CO2 in air. The sperm samples were then processed via Bovipure discontinuous gradient (45-90%) (Nidacon Laboratories AB, Gathenborg, Sweden). After processing, the sperm pellets were diluted with IVF medium and added to the fertilization drops at the concentration of 2×10⁶ sperm/mL (final volume 40 μl). Gametes were co-incubated for 18-20 h at 38.8° C. in 5% CO₂ in air, after which presumptive zygotes were vortexed to remove cumulus cells in Wash medium, and then washed once in the same medium and once in the IVC medium. Presumptive zygotes were placed in 500 drops of IVC covered with 400 μl of mineral oil, where they were incubated in a humidified mixture of 5% CO₂, 6% O₂, and 89% N₂, at 38.8° C. (Day 1). At Day 2 of culture (48 hours from the beginning of the culture), zygotes were evaluated for cleavage and cleavage rate was calculated. The embryos were placed in a freshly equilibrated IVC for an additional 7 days of culture. On different days of culture, embryos at 2.5-cell, ˜16-cell, and morula stage were removed for imaging. The embryos were maintained under the conditions of 5% CO₂, 6% O₂, and 89% N₂, at 38.8° C. At the end of imaging, the embryos were returned to the IVF laboratory, washed in fresh, equilibrated IVC medium and returned to the incubator to culture.

In addition to the bovine embryos, whole-organism imaging was conducted on vital young and matured worms of C. elegans obtained from Carolina Biological Supply Company. After additional growth of 2-4 days for the obtained worms growing on agar plate seeded with E. coli, a small portion of agar plate was cut and placed in a 35-mm dish for imaging at the room temperature.

All animal procedures were conducted in compliance with the Guide for Care and Use of Laboratory Animals of the National Institutes of Health and approved by the Institutional Animal Care and Use Committee at the University of Illinois at Urbana-Champaign.

Organotypic rat brain tissue slice culture was selected for imaging. Brains of 4-week Long-Evans rats from an inbred colony (LE/BluGill) were removed and immersed in ice-cold slicing media (93 mM N-Methyl-D-glucamine, 2.5 mM KCl, 1.2 mM NaH₂PO₄, 30 mM NaHCO₃, 20 mM HEPES, 25 mM glucose, 2 mM Thiourea, 3 mM Sodium pyruvate, 10 mM MgSO₄, 0.5 mM CaCl₂, pH 7.4) bubbled with CO2. Coronal slices (400 mm) containing the medial suprachiasmatic nucleus (SCN) were sectioned by vibrotome (Leica VT1000S). The slices were blocked to reduce the slice to the SCN and minor surrounding hypothalamic tissue. Slices were transferred to tissue culture inserts (0.4 m; Millicell-CM, Millipore) contained within 35-mm tissue culture dishes. The dishes were immersed in 1 ml of organotypic media (DMEM without sodium pyruvate supplemented with 10 mM HEPES, GS21 (1:50, GlobalStem), Penicillin-Streptomycin (1:100, ThermoFisher Scientific) and 1 mM L-glutamine). Cultures were kept at 37° C. in 5% CO₂ and media were exchanged every other day. Brain slices were kept in culture for <1 week. The brain slices were removed from the incubator for imaging at room temperature.

Ex vivo rabbit tissue samples of heart, kidney, and intestine were obtained from ˜3-month-old 2.8 kg laboratory female New Zealand white albino rabbits (Oryctolagus cuniculus, Charles River Laboratories, Wilmington, MA) bearing subcutaneous rabbit mammary tumors within 15 minutes post-mortem. All animals were donated for organ harvest without prior knowledge about metastatic tumor progression. The excised kidney (heart, or intestine) samples were immediately submerged in sterile Ca²+/Mg²+-free 0.1 μm filter-sterilized PBS (pH 7.0-7.2) and underwent three PBS changes to remove blood. Axial and sagittal slices of each organ were manually prepared in sterile tissue culture dishes placed on ice. The slices were then transferred onto uncoated 35 mm imaging dishes with No. 0 coverslips and a glass diameter of 20 mm (MatTek, #P35G0-20-C), and incubated in 500 μL of FluoroBright™ DMEM (TFS, #A1896701) supplemented with 10% FBS, 1% PSA, and 4 mM L-Glutamine solutions. The imaging was conducted at room temperature. Bacteria were found along with immune or stromal cells in some intestine samples.

Ex vivo mouse tissue samples of kidney, intestine, and lung were obtained from ˜8-week-old mice (C57BL/6J, Jackson Laboratory). Healthy mice were euthanized with CO₂ asphyxiation. Tissue samples were then surgically resected and placed in an imaging dish with a clear cover-glass bottom containing approximately 100 μL of freshly prepared phosphate-buffered saline. The dishes were placed on ice and the tissues were imaged at room temperature within 2 hours of extraction. Bacteria were found by imaging along with extracellular matrix in an intestine sample.

Ex vivo embryonic mouse samples of brain, eye, and yolk sac were obtained from post-implantation mouse embryos. Female and male mice were group housed throughout a breeding experiment. A male and a female mouse were placed together in a cage for breeding towards the end of the day. The next morning the female was checked for the presence of a vaginal plug indicative of the occurrence of mating. If a plug was present, the female was assumed pregnant while the next day was denoted as EL. If no vaginal plug was seen, the female was checked again the next morning and every morning after until a plug was seen. All pregnancies were terminated after E8 but before E18. Under anesthesia, the females were first euthanized by CO₂ inhalation followed by cervical dislocation and confirmed by thoracotomy. The embryos were then harvested and placed on 35-mm diameter glass-bottom dishes to image intact developing eye and yolk sac. One E15 embryo was cut in the head area to expose a brain section for imaging. All embryonic samples were imaged at room temperature within 2 hours of extraction.

In vivo (or intravital) imaging was conducted on the skin flap of an 8-week-old C57BL/6J mouse and the mammary tissue of a female Wistar-Furth rat. First, under 3% isoflurane anesthesia, hair was removed in a 1-cm² region in the dorsal caudal region of the mouse along the midline (or in a leg area of the rat near the mammary tissue). Then, incision was performed to externalize a skin flap (or the mammary tissue), which was subsequently placed on a large coverslip for imaging. During the imaging, the mouse (or rat) was under anesthesia via nosecone delivery of 1% isoflurane-O₂ gas mixture at a flow rate of 1 L/min. Also, a heating blanket was placed on the mouse (or the rat) to maintain the physiological temperature. Respiration rate was monitored throughout the imaging session by observing the imaging artefacts from breathing. Finally, the mouse (or rat) was euthanized under deep sedation after the imaging, which was limited to 2 hours from the onset of anesthesia.

For plant tissue, green/yellow ivy leaves and a leaf stalk portion of mimosa pudica were collected in natural environments adjacent to the laboratory. An area approximately 1-cm in diameter was cut and placed in a 35-mm diameter glass-bottom imaging dish and pressed lightly to prevent movement. Imaging was conducted at room temperature within 2 hours of sample collection. To visualize the Kautsky effect, the focus of SOMI was first placed on ivy leaf surface from adaxial side to reveal the chloroplasts. Subsequently, the field-of-view was shifted to an adjacent area without prior SOMI irradiation by moving the mechanical stage that held the imaging dish. The first phase of time-lapse imaging, lasting approximately 50 s, was followed by a 10-60 min wait in darkness before starting the second phase of imaging.

The SOMI microscope synergistically integrated three advanced features despite the surface similarity to its SLAM microscope precursor in hardware, software, and operation. First, a fiber supercontinuum laser with long-term (>2000 hours) stability was employed as the high-peak-power excitation source. Second, a laser scanning method of one pulse per diffraction-limited spot (pixel) at a high pixel rate (5 MHz) was adopted to relax linear absorption-mediated triplet and thus avoid the earliest onset of phototoxicity. Third, a daily calibration method, i.e. pixelation with concentration-encoded effective photons, was employed for standardized and reproducible imaging over 1 year to collect reliable data.

Optically, the pulses from supercontinuum laser were first filtered by a pulse shaper, then raster scanned by a resonant mirror (10×10 mm² in size) and an orthogonally oriented galvanometer mirror in a telecentric 4f lens configuration, and finally focused by a microscope objective with up to ˜30 mW average power on sample. The incident power might be adjusted by a neutral density filter to accommodate the needs for animal and plant samples and for different imaging depths, while the incident pulse width was compressed to near-transform-limited value (˜60 fs, FWHM) by the pulse shaper. Average incident power at the sample plane was measured by a microscope slide power meter (S175C, Thorlabs).

All colors were synchronized to the laser clock to ensure exactly one-pulse-per-pixel on sample and for accurate detection in FLIM. This was achieved by an established architecture for clock synchronization to high-speed digitizers. The data for the 4PAF, THG, SHG, and 2PLAF colors were acquired at 125 MHz using a 4-channel digitizer (ATS9440, AlazarTech Inc). The data for the 3PAF and 2PAF colors were acquired at 2 GHz using a 2-channel digitizer (ATS9373, AlazarTech). The two digitizers and the data acquisition unit (DAQ: PCIe 6353, NI) could be synchronized via phase-locked loop to an external 10-MHz signal. This was derived by dividing the clock of the source laser (Satsuma, Amplitude Systemes) at 40 MHz to 10 MHz using a frequency divider (PRL-260BNT, Pulse Research Lab) and distributed by a fanout line driver (PRL-414B, Pulse Research Lab). The DAQ was used to generate the synchronization signal to the resonant galvo mirror at its peak, the amplitude and phase signals for the resonant galvo control, the frame clocks, the line clocks, shutter control, and analog output signals for the slow-axis galvanometer mirror; each of which were synchronized to the laser. The line clocks and frame clocks were also used to time and trigger the acquisition and buffering of the two digitizers.

Each pixel consisted of the period for a single laser pulse, which corresponded to 25 samples for the 4 channels at 125 MHz and 400 samples for the 2 channels at 2 GHz. Rather than saving all these points, a phase-locked window in time, corresponding to ˜10 to 30 ns with respect to the instant excitation, was implemented. To build the resulting images, the area under this window was extracted as the sum of the photocurrents in this region. This enabled noise reduction by rejecting photons with low probability of originating from the excitation laser (outside the window). For the 2 channels sampled at 2-GHz, the trace across these 40-ns were also saved for FLIM. All these processing steps were performed on a graphical processing unit (GPU: GeForce RTX 2080, NVIDIA Corp) using custom C++-based programs written using the CUDA libraries. A custom LabVIEW program with C-based wrappers for digitizer acquisition and GPU-processing included as dynamic linked libraries were used in an interactive interface capable for real-time searching of a region of interest. The design supported a maximal frame (1024×1024 pixels) rate of 3 Hz by bidirectional resonant scanning but was limited to ˜1.7 Hz for sustained long-term imaging due to the large amount of data and limits of PCIe transfer speeds.

Large area or 3D SOMI was enabled by a motorized sample stage. Without moving the stage, time-lapse imaging of dynamic phenomenon or frame-averaged imaging of static samples were conducted in a constant field-of-view. Single-cell pharmacokinetics imaging was performed in a time-lapse SOMI of 200-frame period at the center of a 35-mm diameter glass-bottom imaging culture dish with 2 mL culture media of live BHK-21 cells. During the imaging near the 50-frame timepoint, 0.1 mL of preprepared concentrated solution of a drug (BAM15/FCCP) or labeling agent (AP3) was injected in ˜1 s by a mounted pipette into the center of the dish, attaining an ending/equilibrium concentration of 5-20 M. The fluorescence from AP3 in a segmented empty space among the cells was used to detect the transient concentration profile of injected drugs and labeling agents during the time-lapse imaging.

Manual single-cell segmentation was performed based on composite THG/3PAF/SHG/2PAF images using ImageJ, while rather arbitrary colorizations were customized for different observers to better visualize the cells. The additional colors of 4PAF and 2PLAF were not used due to their high correlation with THG and 2PAF, respectively. For in situ cells or whole C. elegans organisms with unidentifiable cell boundaries, cell clusters rather than single cells were segmented. The same segmentation mask was applied to each color of 6-color SOMI images to quantify cellular metabolism.

To correct the stripes in large-area SOMI images over 4×5 fields-of-view, a two-step strategy consisting of an initial correction by background and shading correction (BaSiC) and a subsequent correction by the stripe self-correction (SSCOR) was employed. BaSiC effectively removed the uniformly stitched stripes by correcting the shading of each tile, i.e., single field-of-view images. It estimated the correction model based on the physical process of stripe image generation but introduced unnatural or non-smooth transitions at the image stitching positions. It thus posed a challenge in achieving perfect stripe removal, including the scenarios with nonuniform stripes or more complex patterns. To address this issue, the SSCOR method was utilized for subsequent correction based on a self-supervised method using a proximity sampling scheme. This method employed stripe-free patches sampled from the stitched image itself to correct adjacent patches. Specifically, negative samples were sampled at the stitched striped positions, while positive samples were simultaneously sampled in adjacent regions. These samples were used for training the stripe correction network. The trained correction network was subsequently applied to the initial BaSiC-corrected image. This two-step strategy not only removed the stripes more effectively but also preserved the intrinsic information of the SOMI images.

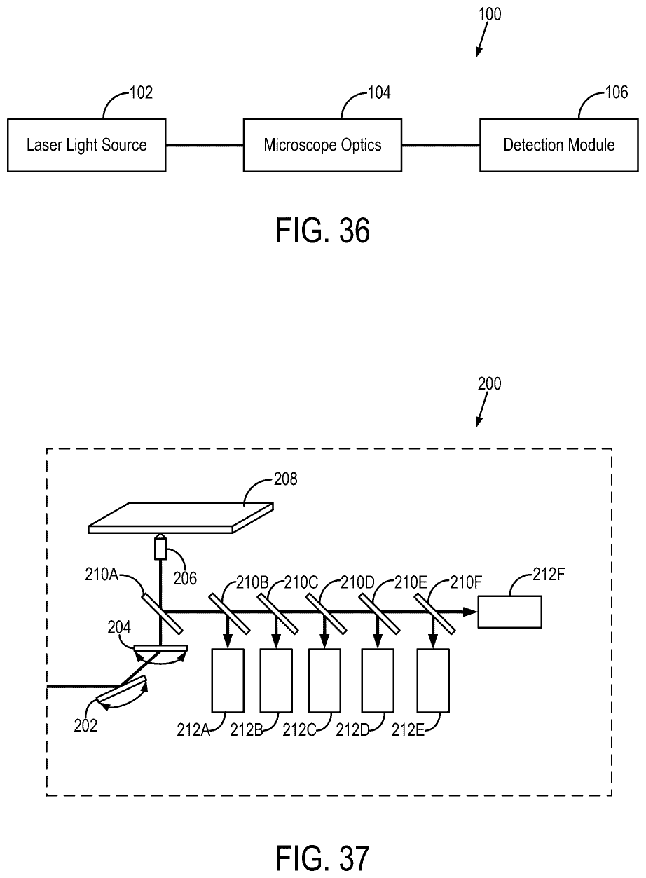

FIG. 36 illustrates an example imaging system 100 that is configured for SOMI microscopy. The system 100 generally includes a laser light source 102, microscope optics 104, and a detection module 106. The laser light source 102 outputs illumination that is received by the microscope optics 104. The microscope optics 104 redirect the illumination to a sample that fluoresces in response to the illumination, and then redirect the fluorescence response to the detection module 106. The detection module 106 outputs a multi-component signal that may be received by a computing device (not shown) to enable SOMI microscopy.

The laser light source 102 may include a femtosecond laser (e.g., a femtosecond fiber laser. As one example, the laser light source 102 can include an extended cavity laser. As another example, the laser light source 102 can include a mode-locked laser, such as a mode-locked Yb:fiber laser. In still other examples, the laser light source 102 can include other solid-state bulk lasers, fiber lasers, semiconductor lasers, microchip lasers (e.g., Q-switched microchip lasers), or the like. As mentioned above, the laser light source 102 may, for example, generate a single laser pulse with a wavelength of about 1030 nm, a pulse repetition rate on the order of a few megahertz (e.g., approximately 5 MHz), a pulse width on the order of 300 femtoseconds (e.g., which may be ensured by a pulse shaper), and an average power of 3.25 mW.

The output of the femtosecond laser may be provided to a filtered supercontinuum laser source including optical components (e.g., filters, lenses, mirrors, spatial light modulators, pulse shapers, pulse compressors, etc.) configured to modify (e.g., shape) the output of the femtosecond laser, thereby to generate an output supercontinuum. The output supercontinuum may have a wavelength of 1110±30 nm, a pulse repetition rate of about 5 MHz, and an average power of about 2.2 W. In other examples, the laser light source 102 may be a near-infrared pulsed laser source. The laser light source 102 may thus be configured to generate an excitation light having a wavelength range that includes an excitation wavelength of a biological sample that is being examined. The output of the laser light source 102 (i.e., excitation light) may then be provided to the microscope optics 104, for example via an optical fiber.

The microscope optics 104 may include several optical components to redirect, shape, focus, etc. the excitation light. For example, the microscope may include mirrors (e.g., resonant mirrors, galvanometric mirrors, dichroic mirrors, relay systems, scanning lenses, tube lenses, a microscope objective, and the like. The microscope optics 104 may be configured to direct the excitation light to a biological sample, to receive an emission light generated by the biological sample in response to the excitation light, and to direct the emission light to the detection module 106. The emission light may be a supercontinuum optical signal including a wavelength range of, for example 340-740 nm.

The detection module 106 receives the emission light from the microscope optics 104 and separates the emission light into a plurality of detection light components. For example, the detection module 106 may include a plurality of beam splitters (e.g., dichroic mirrors) that each separate out a different wavelength range from the emission light. Alternatively, the detection module 106 may include an optical element to spectroscopically split the emission light into the detection light components. Whereas the beam splitter implementation may result in discrete wavelength bands for the detection light components, the spectroscopic splitting element may result in a signal that is split more continuously. In this case, spectroscopic separation can be performed to resolve signals from different imaging modalities. For discrete non-spectroscopic detection, the number of different detection light components is six. The detection module 106 is configured to direct each detection light component to a corresponding detector. Thus, the detection module 106 may include various optical components such as lenses and filters in addition to the dichroic mirrors.

For instance, as one non-limiting example, the detection module 106 can collect observed light using one or more high-sensitivity detectors, such as one or more photomultiplier tubes (PMTs). As a non-limiting example, a different PMT (or group of PMTs) can be used for each different imaging modality (e.g., 2PAF, 2PLAF, 3PAF, 4PAF, SHG, THG, etc.). In some implementations, each imaging modality may correspond to a PMT or group of PMTs in the detection module 106 that is configured to collect optical signal data that are indicative of an image of the biological sample. The different detectors may be configured to simultaneously visualize the biological sample through the different imaging modalities, each in a different color component.

Output signals (e.g., output images) from the detectors may be provided to a computing device having at least one electronic processor and a memory operatively connected thereto. The output signals may be communicated by a wireless communication interface, a wired communication interface, or a combination thereof. The computing device may be configured to perform various image processing operations on the received output signals, such as co-registration, denoising (e.g., via a self-supervised denoising model such as UDVD), and the like.

FIG. 37 illustrates an example of a portion of the microscope optics 104 and the detection module 106 in more detail. This example illustrates an implementation as a laser scanning microscope 200. As shown in FIG. 37, the laser scanning microscope 200 may include first and second scanning mirrors 202 and 204, an objective 206, and a specimen stage 208 on which a biological specimen may be disposed for imaging. The laser scanning microscope 200 may further include a dichroic mirror 210A configured to transmit light in a first wavelength range (e.g., corresponding to excitation light) toward the specimen stage 208 and to reflect light in a second wavelength range (e.g., corresponding to emission light) from the specimen stage 208 and towards various detection components. Collectively, the scanning mirrors 202 and 204, the objective 206, the specimen stage 208, and the dichroic mirror 210A may be considered as corresponding to the microscope optics 104 of FIG. 36.

The scanning mirrors 202 and 204 allow for raster scanning of the incoming light beam from the pulse shaper 108. As a non-limiting example, the scanning mirrors 202 and 204 may be galvanometer mirrors. In an example configuration, the objective 206 may be a high-UV transmission objective with a relatively low magnification (such as 40×), but a relatively high numerical aperture (such as 1.15). This combination of raster scanning and relatively low magnification objective enables a field-of-view of on the order of 0.3×0.3 mm², with an average power of 15 mW (for animal samples), 7.5-10 mW (for plant samples), or up to 20 mW (for 3D imaging) incident on a sample on the specimen stage 208 after the loss along the excitation beam path.

The specimen stage 208 may hold a biological sample containing a plurality of fluorophores of interest, harmonophores of interest, or combinations thereof. As noted above, examples of fluorophores can include FAD, other flavoproteins or flavoprotein-like fluorophores, NADH, nicotinamide adenine dinucleotide phosphate (NADPH), tryptophan, genetically encoded calcium indicators, and dyes, among others. Examples for harmonophores include collagen (SHG) and lipid (THG). To this end and as an example, dichroic mirror 210A may have a 50%-cut-off edge wavelength (edge) of 750 nm so that light with a wavelength of less than 750 nm is reflected towards the detection components of the laser scanning microscope 200 and wavelength of higher than 750 nm is transmitted toward the specimen stage 208.

The laser scanning microscope 200 may in some configurations include dichroic mirrors 210B-210F and PMTs 212A-212F (or other types of detectors as described above) to separate the light emitted by the fluorophores and/or harmonophores into spectrally distinct channels. The PMTs 212A-212F may be photon-counting PMTs, analog PMTs, or the like, and may include bandpass filters (not shown in FIG. 37) that work together with the dichroic mirrors (e.g., dichroic mirrors 210B-210F) to collect spectrally resolved multimodal multiphoton signals in the PMTs 212A-212F. One particular example of the cut-off wavelengths of the dichroic mirrors 210A-210F and of the optical parameters of the corresponding filters, lenses, and PMTs is set forth above in Table 6. However, it will be appreciated by those skilled in the art that the edge wavelengths of dichroic mirrors 210A-210F and the bandpass filter wavelengths of PMTs 212A-212F described above are illustrative examples only. Any combination of mirror edge wavelength and bandpass filter wavelength that minimize crosstalk between individual channels and that lead to spectrally resolved, distinct signals generated by the PMTs 212A-212F may be chosen by the skilled person.

Collectively, the dichroic mirrors 210B-210F, the PMTs 212A-212F, and the associated optical components such as lenses and filters may be considered as corresponding to the detection module 106 of FIG. 36. Thus, between the dichroic mirror 210A and the dichroic mirror 210B, an optical coupling interface may be present, for example between an optical output of the microscope optics 104 and an optical input of the detection module 106 of FIG. 26. It should be noted that, while FIG. 37 illustrates six PMTs 212A-212F to detect via six different imaging modalities using five dichroic mirrors 210B-210F, in some implementations one of the PMTs and one of the dichroic mirrors may be omitted such that detection occurs via five different imaging modalities using four dichroic mirrors. The different imaging modalities may be selected from 4PAF, 3PAF, 2PAF, 2PLAF, THG, and SHG as described above.

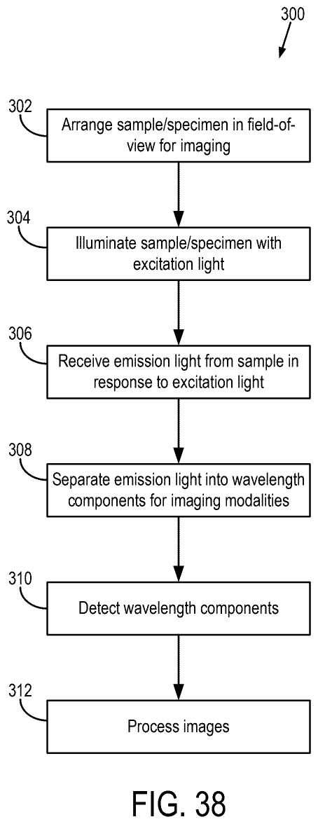

FIG. 38 illustrates an example microscopy method 300 for multiphoton microscopy and/or imaging using the techniques described in the present disclosure. The method 300 includes an operation 302 of arranging a sample and/or specimen within a field-of-view of the multiphoton microscopy and/or imaging system. For instance, arranging the sample and/or specimen within the field-of-view can include arranging the sample and/or specimen on a stage (e.g., stage 208) for imaging.

Operation 304 includes illuminating the biological sample with an excitation light having a wavelength range that includes an excitation wavelength of the biological sample. In operation 304, the laser light source may be operated to generate a laser beam. As described above, the laser beam may be engineered to facilitate multiphoton imaging through the SOMI technique, or using other techniques described in the present disclosure. For instance, the laser beam can be generated as a single laser pulse with characteristics such as those set forth in Table 6. In operation 304, the laser beam may scanned over the sample to generate an emission light responsive to the excitation light.

At operation 306, the emission light emitted by the sample in response to the excitation light may be received. The emission light may include a supercontinuum (e.g., 340-740 nm). Next, at operation 308, the received emission light is separated into wavelength components each corresponding to a different imaging modality. For example, operation 308 may include separating the emission light into five or six wavelength ranges. Each of these components may be directed to a different detector and, at operation 310, the wavelength components may be detected by the detector. Thus, operation 310 may include simultaneously detecting the five or six wavelength ranges of the emission light (having been separated in operation 308) by five or six corresponding detectors. Operation 310 may result in the generation of five or six corresponding images, one by each of the detectors. At operation 312, these images may be output and/or processed. The image processing of operation 312 may include any of the processing operations described above, including but not limited to co-registration, self-supervised denoising, etc. In another example, operation 312 may include detecting one or more biomarkers based on one or more of the output images (i.e., based on the output images from one or more detectors). For example, ratio metrics using one pair of output images may be used to assess metabolic oxidation, while ratio metrics using another pair of output images may be used to assess oxidative stress independently.

Through operations 304-310 optical signal data may be collected by multiple high-sensitivity detectors, such as PMTs. While FIG. 38 illustrates the pre-microscopy operation 302 and the post-microscopy operation 312 as being part of the microscopy method 300, in certain implementations these operations may be omitted such that the microscopy method 300 itself covers the operations 304-310 described above.

As described above, pairing a research tool with a matched topic, e.g. optical microscopy and biology, has driven life science discoveries. Thus, the hitherto limited progress in visualizing cellular oxidative stress may be attributed to a mismatch between labeled fluorescence microscopy and redox biology. To overcome this and other obstacles, the present disclosure presents label-free SOMI that can differentiate oxidative stress from metabolic oxidation in single cells under unperturbed physiology, with great potential to understand many intriguing phenomena relevant to embryogenesis, stem cell biology, aging, chronic diseases, drug discovery, neuroscience, photosynthesis, and evolution. The proof-of-concept study has quantitatively interpreted all accessible samples with high self-consistency, without discriminating against part of them (e.g. non-mammalian samples from plants, bacteria, and primitive animals) and cherry-picking the collected data that could lead to biased conclusions. With no constraint on samples from specific preparations and labeling procedures, the systems biology-inspired imaging modalities described herein herald a “free view” of living systems.

The present disclosure has described one or more preferred embodiments. However, the invention has been presented by way of illustration and is not intended to be limited to the disclosed embodiments. It should be appreciated that many equivalents, alternatives, variations, and modifications, aside from those expressly stated, are possible and within the scope of the invention.

What is claimed is:

1. A multiphoton microscopy system, comprising:
a laser light source configured to generate an excitation light having a first wavelength range including an excitation wavelength of a biological sample;
an optical system configured to direct the excitation light to the biological sample and configured to receive an emission light emitted by the biological sample in response to the excitation light; and
a detection module configured to receive the emission light from the optical system and configured to:
separate the emission light into at least a first detection light including a second wavelength range, a second detection light including a third wavelength range, a third detection light including a fourth wavelength range, a fourth detection light including a fifth wavelength range, and a fifth detection light including a sixth wavelength range, and
direct the first detection light to a first detector, the second detection light to a second detector, the third detection light to a third detector, the fourth detection light to a fourth detector, and the fifth detection light to a fifth detector.

2. The system of claim 1, wherein the first through fifth detectors are configured to simultaneously visualize the biological sample via first through fifth different imaging modalities, respectively.

3. The system of claim 2, wherein the first through fifth different imaging modalities are selected the group consisting of four-photon excited autofluorescence, three-photon excited autofluorescence, two-photon excited autofluorescence, third-harmonic generation, and second-harmonic generation.

4. The system of claim 1, wherein the detection module is further configured to separate the emission light into a sixth detection light including a seventh wavelength range corresponding to two-photon excited long-wavelength autofluorescence, and to direct the sixth detection light to a sixth detector.

5. The system of claim 1, wherein the laser light source comprises a near-infrared pulsed laser source configured to generate the excitation light and an optical fiber configured to deliver the excitation light to the optical system.

6. The system of claim 1, wherein the emission light is a supercontinuum light signal including wavelengths from 340 nm to 740 nm.

7. The system of claim 1, further comprising at least one electronic processor configured to co-register a first output image from the first detector, a second output image from the second detector, a third output image from the third detector, a fourth output image from the fourth detector, and a fifth output image from the fifth detector.

8. The system of claim 1, further comprising at least one electronic processor configured to apply a self-supervised denoising model to at least one of a first output image from the first detector, a second output image from the second detector, a third output image from the third detector, a fourth output image from the fourth detector, or a fifth output image from the fifth detector.

9. A detection module for a microscopy system, the detection module comprising:
an optical input configured to receive an emission light, wherein the emission light corresponds to illumination emitted by a biological sample in response to irradiation with an excitation light;
a beam separator configured to split the emission light into a first detection light, a second detection light, a third detection light, a fourth detection light, and a fifth detection light;
a first detector configured to receive the first detection light;
a second detector configured to receive the second detection light;
a third detector configured to receive the third detection light;
a fourth detector configured to receive the fourth detection light; and
a fifth detector configured to receive the fifth detection light.

10. The detection module of claim 9, wherein the first through fifth detectors are configured to simultaneously visualize the biological sample via first through fifth different imaging modalities, respectively.

11. The detection module of claim 10, wherein the first through fifth different imaging modalities are selected the group consisting of four-photon excited autofluorescence, three-photon excited autofluorescence, two-photon excited autofluorescence, third-harmonic generation, and second-harmonic generation.

12. The detection module of claim 9, wherein the beam separator is configured to separate a sixth detection light from the emission light corresponding to two-photon excited long-wavelength autofluorescence, and wherein the detection module further comprises a sixth detector configured to receive the sixth detection light.

13. The detection module of claim 9, wherein the emission light is a supercontinuum light signal including wavelengths from 340 nm to 740 nm.

14. The detection module of claim 9, wherein the first through fifth detectors are photomultiplier tubes.

15. A multiphoton microscopy method, comprising:
illuminating a biological sample with an excitation length having a first wavelength range including an excitation wavelength of the biological sample;
receiving an emission light emitted by the biological sample in response to the excitation light, wherein the emission light includes a supercontinuum;
separating the emission light into at least a second wavelength range, a third wavelength range, a fourth wavelength range, a fifth wavelength range, and a sixth wavelength range; and
simultaneously detecting the second wavelength range of the emission light by a first detector, the third wavelength range of the emission light by a second detector, the fourth wavelength range of the emission light by a third detector, the fifth wavelength range of the emission light by a fourth detector, and the sixth wavelength range of the emission light by a fifth detector.

16. The method of claim 15, wherein the first through fifth detectors respectively correspond to different imaging modalities.

17. The method of claim 16, where the different imaging modalities are selected the group consisting of four-photon excited autofluorescence, three-photon excited autofluorescence, two-photon excited autofluorescence, third-harmonic generation, and second-harmonic generation.

18. The method of claim 15, wherein
the operation of separating includes separating the emission light into a seventh wavelength range corresponding to two-photon excited long-wavelength autofluorescence; and
the operation of simultaneously detecting includes simultaneously detecting the seventh wavelength range by a sixth detector.

19. The method of claim 15, further comprising outputting a first image of the biological sample from the first detector, a second image of the biological sample from the second detector, a third image of the biological sample from the third detector, a fourth image of the biological sample from the fourth detector, and a fifth image of the biological sample from the fifth detector.

20. The method of claim 19, further comprising detecting a biomarker based on at least one of the first image, the second image, the third image, the fourth image, or the fifth image.
